(19) United States
(12) Patent Application Publication
(10) Pub. No.: US 2025/0038924 A1
(43) Pub. Date: Jan. 30, 2025

(54) METHOD AND DEVICE FOR ENHANCING PERFORMANCE OF CHANNEL STATE INFORMATION

(71) Applicant: Samsung Electronics Co., Ltd., Gyeonggi-do (KR)

(72) Inventors: Zhe CHEN, Beijing (CN); Jingxing FU, Beijing (CN); Sa ZHANG, Beijing (CN); Feifei SUN, Beijing (CN)

(21) Appl. No.: 18/776,737

(22) Filed: Jul. 18, 2024

(30) Foreign Application Priority Data
Jul. 21, 2023 (CN) 202310908225.6

(51) Int. Cl. H04L 5/00

(52) U.S. Cl. CPC H04L 5/0053

(57) ABSTRACT

The disclosure provides a method performed by a UE in a wireless communication system, including receiving a channel state information (CSI) reporting configuration comprising a plurality of first sub-configurations, and determining and reporting CSI based on a second sub-configuration comprising N out of the plurality of the first sub-configurations, where N is greater than or equal to 1, wherein the CSI comprises one or two CSI parts, wherein a number of the CSI parts included in the CSI is determined based on N, and wherein at least one of the one or two CSI parts included in the CSI is determined based on a first order including at least one of an order of the N first sub-configurations in the second sub-configuration, an order of CSI parameters in the CSI, and an order between zero-padding bits and the CSI parameters in the CSI.

### CROSS-REFERENCE TO RELATED APPLICATION

This application is based on and claims priority under 35 U.S.C. § 119 to Chinese Patent Application No. 202310908225.6, filed on Jul. 21, 2023 in the China National Intellectual Property Administration, the disclosure of which is incorporated herein by reference in its entirety.

### BACKGROUND

### 1. Field

The disclosure relates generally to wireless communication, and more particularly, to a method and device for enhancing the performance of channel state information (CSI) and improving the scheduling efficiency of a wireless communication system.

### 2. Description of Related Art

Fifth generation (5G) mobile communication technologies define broad frequency bands such that high transmission rates and new services are possible and can be implemented not only in sub 6 gigahertz (GHz) bands such as 3.5 GHz, but also in above 6 GHz bands referred to as millimeter wave (mmWave) bands including 28 GHz and 39 GHz. In addition, it has been considered to implement sixth generation (6G) mobile communication technologies referred to as beyond 5G systems in terahertz (THz) bands, 95 GHz to 3 THz bands, to realize transmission rates fifty times faster than 5G mobile communication technologies and ultra-low latencies one-tenth of 5G mobile communication technologies.

Since the outset of 5G mobile communication technology development, to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, operating multiple subcarrier spacings for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

There has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for simplifying random access procedures. There also has been ongoing standardization in system architecture/service regarding a 5G service-based architecture or service based interface for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks. Thus, it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of a UE operation capability by utilizing ultra-high-performance communication and computing resources.

In 5G systems, advanced coding modulation (ACM) schemes such as hybrid frequency shift keying (FSK) and quadrature amplitude momentum (QAM) and sliding window superposition coding (SWSC), as well as advanced access techniques such as filter bank multi-carrier (FBMC), non-orthogonal multiple access (NOMA), and sparse code multiple access (SCMA) have been developed.

To enhance the scheduling efficiency of 5G wireless communication systems, base stations need to obtain CSI to perform scheduling accordingly based on the CSI feedback by terminal devices. However, the manner to further enhance the performance of CSI reporting is a challenging problem that needs to be addressed.

### SUMMARY

The disclosure has been made to address at least the above-mentioned problems and/or disadvantages and to provide at least the advantages described below.

Accordingly, an aspect of the disclosure is to provide a method and apparatus for enhancing the performance of CSI, thereby improving the scheduling efficiency of communication systems.

In accordance with an aspect of the disclosure, a method performed by a UE in a wireless communication system includes receiving a channel state information (CSI) reporting configuration comprising a plurality of first sub-configurations, and determining and reporting CSI based on a second sub-configuration comprising N out of the plurality of the first sub-configurations, where N is greater than or equal to 1, wherein the CSI comprises one or two CSI parts, wherein a number of the CSI parts included in the CSI is determined based on N, and wherein at least one of the one or two CSI parts included in the CSI is determined based on a first order including at least one of an order of the N first sub-configurations in the second sub-configuration, an order of CSI parameters in the CSI, and an order between zero-padding bits and the CSI parameters in the CSI.

In accordance with an aspect of the disclosure, a method performed by a base station in a wireless communication system includes transmitting a channel state information (CSI) reporting configuration comprising a plurality of first sub-configurations; and receiving the CSI, the CSI being determined based on a second sub-configuration, the second sub-configuration comprising N out of the plurality of first sub-configurations, where N is greater than or equal to 1, wherein the CSI comprises one or two CSI parts, wherein the number of the CSI parts included in the CSI is determined based on N, wherein at least one of the one or two CSI parts included in the CSI is determined based on a first order, and wherein the first order comprises at least one of the order of the N first sub-configurations in the second sub-configuration, the order of CSI parameters in the CSI, and the order between zero-padding bits and the CSI parameters in the CSI.

In accordance with an aspect of the disclosure, a UE includes a transceiver, and a controller coupled to the transceiver and configured to receive a channel state information (CSI) reporting configuration comprising a plurality of first sub-configurations, and determine and report CSI based on a second sub-configuration, the second sub-configuration comprising N out of the plurality of first sub-configurations, where N is greater than or equal to 1, wherein the CSI comprises one or two CSI parts, wherein a number of the CSI parts included in the CSI is determined based on N, wherein at least one of the one or two CSI parts included in the CSI is determined based on a first order, and wherein the first order comprises at least one of an order of the N first sub-configurations in the second sub-configuration, an order of CSI parameters in the CSI, and an order between zero-padding bits and the CSI parameters in the CSI.

In accordance with an aspect of the disclosure, a base station includes a transceiver, and a controller coupled to the transceiver and configured to transmit a channel state information (CSI) reporting configuration comprising a plurality of first sub-configurations, and receive the CSI, the CSI being determined based on a second sub-configuration, the second sub-configuration comprising N out of the plurality of first sub-configurations, where N is greater than or equal to 1,wherein the CSI comprises one or two CSI parts, wherein the number of the CSI parts included in the CSI is determined based on N, wherein at least one of the one or two CSI parts included in the CSI is determined based on a first order, and wherein the first order comprises at least one of the order of the N first sub-configurations in the second sub-configuration, the order of CSI parameters in the CSI, and the order between zero-padding bits and the CSI parameters in the CSI.

### BRIEF DESCRIPTION OF THE DRAWINGS

The above and other aspects, features, and advantages of certain embodiments will be more apparent from the following description taken in conjunction with the accompanying drawings, in which:

FIG. 1 illustrates a structure of a wireless communication network according to an embodiment;

FIG. 2A illustrates a transmission path in a wireless communication network according to an embodiment;

FIG. 2B illustrates a reception path in a wireless communication network according to an embodiment;

FIG. 3A illustrates a structure of a UE in a wireless communication network according to an embodiment;

FIG. 3B illustrates a structure of a base station in a wireless communication network according to an embodiment;

FIG. 4 illustrates a method performed by user equipment (UE) according to an embodiment;

FIG. 5 illustrates a method performed by a base station according to an embodiment;

FIG. 6 illustrates a structure of a UE according to an embodiment; and

FIG. 7 illustrates a structure of a base station according to an embodiment.

### DETAILED DESCRIPTION

Hereinafter, embodiments of the disclosure will be described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Herein, certain elements may be enlarged, omitted, or schematically represented, and the size of each element does not necessarily reflect its actual size. In the drawings, the same or corresponding elements have the same reference numerals.

The disclosure is not limited to the embodiments described below and can be implemented in various forms. The following embodiments are provided solely for the purpose of fully explaining the scope of the disclosure. Throughout the specification, the same or similar reference numerals indicate the same or similar elements.

In the following description, the resources corresponding to the sub-configurations (e.g., CSI-RS resources, CSI-IM resources) can be understood as resources referred by the sub-configurations. The resources corresponding to the first sub-configuration (or a plurality of first sub-configurations) can be understood as resources referred by the first sub-configuration (or a plurality of first sub-configurations). The resources corresponding to the second sub-configuration can be understood as resources referred by the second sub-configuration.

A “reference signal” can be used interchangeably with “reference signal resource”, “if reported” can be used interchangeably with “if present” or “if applicable” or “if necessary”, and “configuration information for CSI reporting (e.g., csi-ReportConfig)” can be used interchangeably with “CSI reporting configuration” or “CSI reporting configuration information” or “CSI report setting”.

Furthermore, “at least one” as used herein includes any and/or all possible combinations of listed items, embodiments of the disclosure can be changed and combined in any suitable form, and the symbol “/” herein may indicate “or”.

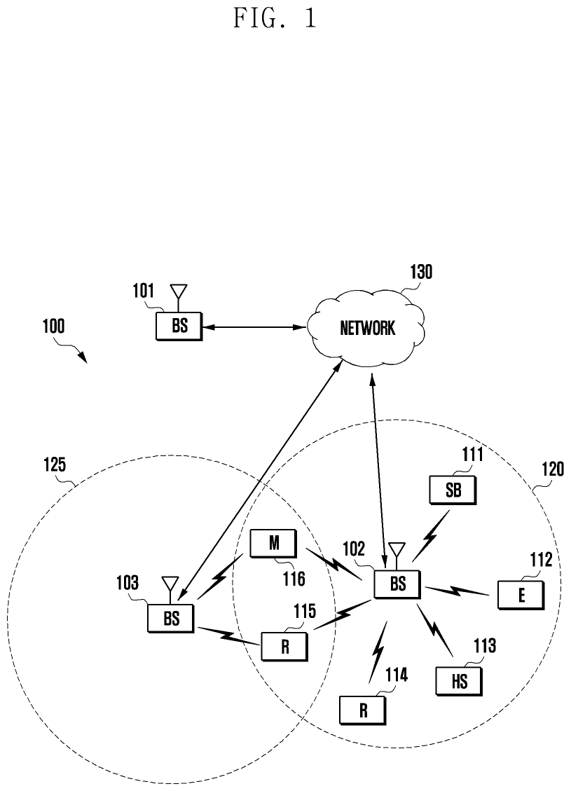

FIG. 1 illustrates an example wireless communication network 100 according to an embodiment.

Referring to FIG. 1, the wireless communication network 100 includes a base station (BS) or gNodeB (gNB) 101, a gNB 102 and a gNB 103. The gNB 101 communicates with the gNB 102 and the gNB 103. The gNB 101 also communicates with at least one Internet protocol (IP) network 130, such as the Internet, a proprietary IP network or other data networks.

Depending on the type of network, other well-known terms such as base station (BS) or access point (AP) can be used instead of gNodeB or gNB. For convenience, the terms gNodeB and gNB are used in this disclosure to refer to network infrastructure components that provide wireless access for remote terminals. In addition, depending on the type of network, other well-known terms such as mobile station, user station, remote terminal, wireless terminal or user device can be used instead of user equipment or UE. For convenience, the terms user equipment and UE are used in this disclosure to refer to remote wireless devices that wirelessly access the gNB, whether the UE is a mobile device (such as a mobile phone or smartphone) or a commonly recognized fixed device (such as a desktop computer or vending machine).

The gNB 102 provides wireless broadband access to a network 130 for a first plurality of pieces of a UE within a coverage area 120 of the gNB 102. The first plurality of pieces of a UE include a UE located in a small business (SB) 111, a UE located in an enterprise (E) 112, a UE located in a wireless fidelity (WiFi) hotspot (HS) 113, a UE located in a first residence (R) 114, a UE located in a second residence (R) 115, and a UE mobile device (M) 116 such as a cellular phone, a wireless laptop computer, and a wireless PDA. The gNB 103 provides wireless broadband access to the network 130 for a second plurality of pieces of a ULE within a coverage area 125 of the gNB 103. The second plurality of pieces of a UE include the UE at R 115 and ULE at M 116. One or more of the gNBs 101-103 can communicate with each other and with the UE at locations 111-116 using 5G, long term evolution (LTE), LTE-advanced (LTE-A), WiMAX or other advanced wireless communication technology.

The dashed lines show approximate ranges of the coverage areas 120 and 125, and the ranges are shown as approximate circles for illustration and explanation purposes only. It should be clearly understood that coverage areas associated with gNBs, such as the coverage areas 120 and 125, can have other shapes, including irregular shapes, depending on the configuration of gNBs and changes in the radio environment associated with natural obstacles and man-made obstacles.

As described in more detail below, one or more of the gNB 101, the gNB 102, and the gNB 103 include a two-dimensional (2D) antenna array. One or more of the gNB 101, the gNB 102 and the gNB 103 support a codebook design and structure for systems with 2D antenna arrays.

Although FIG. 1 shows an example of the wireless communication network 100, various changes can be made to FIG. 1. The wireless communication network 100 can include any number of gNBs and UE in any suitable arrangement. The gNB 101 can directly communicate with any number of pieces of a UE and provide the UE with wireless broadband access to the network 130. Similarly, each gNB 102-103 can communicate directly with the network 130 and provide the UE with direct wireless broadband access to the network 130. The gNB 101, the gNB 102 and/or the gNB 103 can provide access to other or additional external networks, such as external telephone networks or other types of data networks.

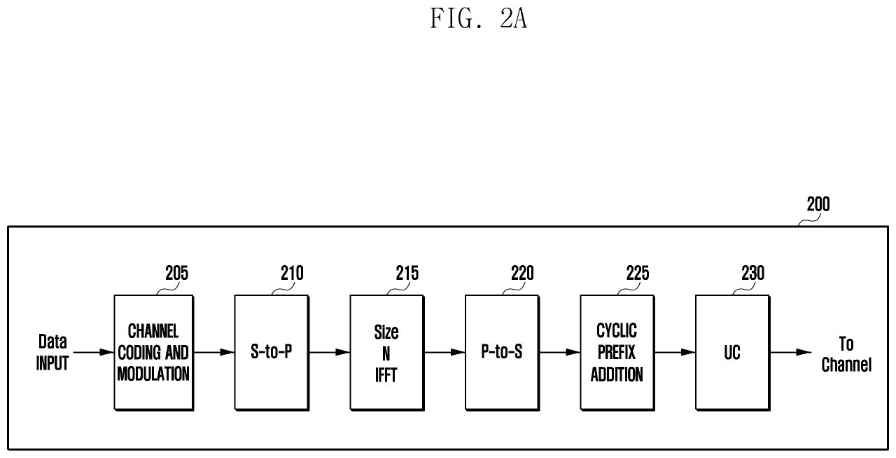

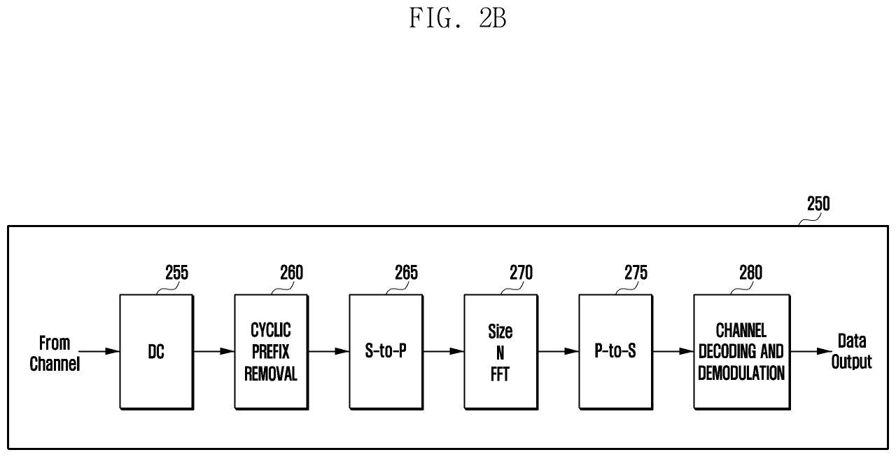

FIG. 2A illustrates a transmission path 200 and a reception path 250 in a wireless communication network according to an embodiment. FIG. 2B illustrates a reception path 250 in a wireless communication network according to an embodiment. In the following description, the transmission path 200 can be implemented in a gNB and the reception path 250 can be implemented in UE. However, the reception path 250 can be implemented in a gNB and the transmission path 200 can be implemented in UE. The reception path 250 is configured to support a codebook design and structure for a system having the 2D antenna array as described in the embodiments of the disclosure.

Referring to FIG. 2A, the transmission path 200 includes a channel coding and modulation block 205, a serial-to-parallel (S to P) block 210, an N-point inverse fast Fourier transform (IFFT) block 215, a parallel-to-serial (P to S) block 220, a cyclic prefix adding block 225, and an upconverter (UC) 230.

Referring to FIG. 2B, the reception path 250 includes a down converter (DC) 255, a cyclic prefix removal block 260, a serial-to-parallel (S to P) block 265, a size N-point fast Fourier transform (FFT) block 270, a parallel-to-serial (P to S) block 275, and a channel decoding and demodulation block 280.

In the transmission path 200, the channel coding and modulation block 205 receives a set of information bits, applies coding such as low-density parity-check (LDPC) coding, and modulates the input bits, such as using quadrature phase shift keying (QPSK) or quadrature amplitude modulation (QAM) to generate a sequence of frequency domain modulation symbols. The S to P block 210 demultiplexes serial modulation symbols into parallel data to generate N parallel symbol streams, where N is the number of IFFT/FFT points used in the gNB 102 and the UE 116. The N-point IFFT block 215 performs an IFFT operation on the N parallel symbol streams to generate a time domain output signal. The P to S block 220 multiplexes the parallel time domain output symbols from the N-point IFFT block 215 to generate a serial time domain signal. The cyclic prefix adding block 225 inserts a cyclic prefix into the time domain signal. The upconverter 230 upconverts an output of the cyclic prefix adding block 225 into an RF for transmission via a wireless channel. The signal can also be filtered at a baseband before frequency conversion to the RF.

An RF signal transmitted from the gNB 102 reaches the UE 116 after passing through the wireless channel, and an operation opposite to that at the gNB 102 is performed at the UE 116. The downconverter 255 downconverts a received signal to a baseband frequency, and the cyclic prefix removal block 260 removes the cyclic prefix to generate a serial time domain baseband signal. The S to P block 265 converts the time domain baseband signal into a parallel time domain signal. The N-point FFT block 270 performs an FFT algorithm to generate N parallel frequency domain signals. The P to S block 275 converts the parallel frequency domain signal into a sequence of modulation data symbols. The channel decoding and demodulation block 280 demodulates and decodes the modulation symbols to recover an original input data stream.

Each of the gNBs 101-103 may implement a transmission path 200 similar to transmitting to the UE 111-116 in a downlink and may implement a reception path 250 similar to receiving from the UE 111-116 in an uplink. Similarly, each of the UE 111-116 may implement a transmission path 200 for transmitting to the gNBs 101-103 in the uplink and may implement a reception path 250 for receiving from the gNBs 101-103 in the downlink.

Each of the components in FIGS. 2A and 2B can be implemented using only hardware or using a combination of hardware and software/firmware. For example, at least some of the components in FIGS. 2A and 2B may be implemented by software, while other components may be implemented by configurable hardware or a combination of software and configurable hardware. The FFT block 270 and the IFFT block 215 may be implemented as configurable software algorithms, and the value of the number of points N may be modified according to the specific implementation.

Although described as using FFT and IFFT, this is merely illustrative and other types of transforms can be used, such as discrete Fourier transform (DFT) and inverse discrete Fourier transform (IDFT) functions. For DFT and IDFT functions, the value of the variable N can be any integer (such as 1, 2, 3, 4, etc.), while for FFT and IFFT functions, the value of the variable N can be any integer which is a power of 2 (such as 1, 2, 4, 8, 16, etc.).

Although FIGS. 2A and 2B show examples of wireless transmission and reception paths, various changes can be made to FIGS. 2A and 2B. For example, various components can be combined, further subdivided or omitted, and additional components can be added according to specific needs. FIGS. 2A and 2B are intended to show examples of types of transmission and reception paths that can be used in a wireless network. Any other suitable architecture can be used to support wireless communication in a wireless network.

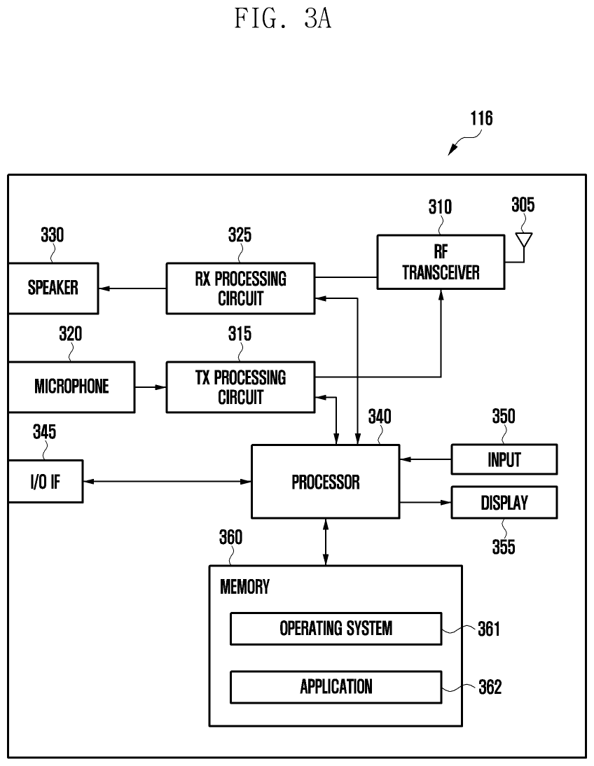

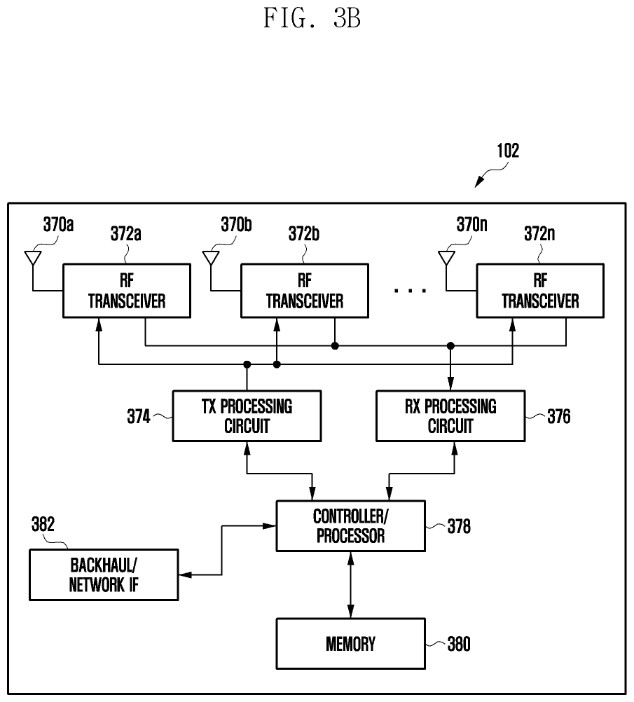

FIG. 3A illustrates a UE 116 according to an embodiment. The UE 116 shown in FIG. 3A is for illustration only, and the UE 111-115 of FIG. 1 can have the same or similar configurations. However, FIG. 3A does not limit the scope of the disclosure to any specific implementation of the UE.

Referring to FIG. 3A, the UE 116 includes an antenna 305, a radio frequency (RF) transceiver 310, a transmit (TX) processing circuit 315, a microphone 320 and a receive (RX) processing circuit 325. The UE 116 also includes a speaker 330, a processor/controller 340, an input/output (I/O) interface 345, input device (s) 350, a display 355, and a memory 360. The memory 360 includes an operating system (OS) 361 and one or more applications 362.

The RF transceiver 310 receives an incoming RF signal transmitted by the gNB of the wireless network 100 from the antenna 305. The RF transceiver 310 downconverts the incoming RF signal to generate an intermediate frequency (IF) or baseband signal. The IF or baseband signal is sent to the RX processing circuit 325, which generates a processed baseband signal by filtering, decoding and/or digitizing the baseband or IF signal. For further processing, the RX processing circuit 325 sends the processed baseband signal to the speaker 330 for voice data or to the processor/controller 340 for network browsing data.

The TX processing circuit 315 receives analog or digital voice data from the microphone 320 or other outgoing network data, e-mail or interactive video game data from the processor/controller 340. The TX processing circuit 315 encodes, multiplexes, and/or digitizes the outgoing baseband data to generate a processed baseband or IF signal. The RF transceiver 310 receives an outgoing processed baseband or IF signal from the TX processing circuit 315 and upconverts the baseband or IF signal into an RF signal transmitted via the antenna 305.

The processor/controller 340 can include one or more processors or other processing devices and execute the OS 361 stored in the memory 360 to control the overall operation of the UE 116. The processor/controller 340 can control the reception of a forward channel signal and the transmission of a reverse channel signal through the RF transceiver 310, the RX processing circuit 325 and the TX processing circuit 315 according to well-known principles. The processor/controller 340 includes at least one microprocessor or microcontroller.

The processor/controller 340 can also execute other processes and programs residing in the memory 360, such as operations for channel quality measurement and reporting of a system having the 2D antenna array as described herein. The processor/controller 340 can move data into or out of the memory 360 as required by the execution process. The processor/controller 340 is configured to execute the application 362 based on the OS 361 or in response to a signal received from the gNB or a carrier. The processor/controller 340 is further coupled to the I/O interface 345, which enables the UE 116 to connect to other devices, such as laptop deterministic machines and handheld deterministic machines. The I/O interface 345 is a communication path between these accessories and the processor/controller 340.

The processor/controller 340 is further coupled to the input device (s) 350 and the display 355. An operator of the UE 116 can input data into the UE 116 using the input device (s) 350. The display 355 may be a liquid crystal display or other displays capable of presenting texts and/or at least limited graphics (such as from a website). The memory 360 is coupled to the processor/controller 340. Apart of the memory 360 can include a random access memory (RAM), and another part of the memory 360 can include a flash memory or other read-only memories (ROM).

Although FIG. 3A shows an example of the UE 116, various changes can be made to FIG. 3A. For example, various components in FIG. 3A can be combined, further subdivided or omitted, and additional components can be added according to specific needs. For example, the processor/controller 340 can be divided into a plurality of processors, such as one or more central processing units (CPU) and one or more graphics processing units (GPU). Although FIG. 3A shows the UE 116 configured as a mobile phone or a smart phone, the UE can be configured to operate as other types of mobile or fixed devices.

FIG. 3B illustrates a gNB 102 according to an embodiment. The gNB 102 shown in FIG. 3B is for illustration only, and other gNBs of FIG. 1 can have the same or similar configurations. However, FIG. 3B does not limit the scope of the disclosure to any specific implementation of the gNB. The gNB 101 and the gNB 103 may include the same or similar structures as the gNB 102.

Referring to FIG. 3B, the gNB 102 includes a plurality of antennas 370a-370n, a plurality of RF transceivers 372a-372n, a TX processing circuit 374 and an RX processing circuit 376. One or more of the plurality of antennas 370a-370n include a 2D antenna array. The gNB 102 also includes a controller/processor 378, a memory 380 and a backhaul or network interface 382.

The RF transceivers 372a-372n receive incoming RF signals from the antennas 370a-370n, such as signals transmitted by the UE or other gNBs. The RF transceivers 372a-372n downconvert the incoming RF signals to generate IF or baseband signals. The IF or baseband signals are sent to the RX processing circuit 376, which generates processed baseband signals by filtering, decoding and/or digitizing the baseband or IF signals. The RX processing circuit 376 sends the processed baseband signals to the controller/processor 378 for further processing.

The TX processing circuit 374 receives analog or digital voice data, network data, e-mail or interactive video game data from the controller/processor 378. The TX processing circuit 374 encodes, multiplexes and/or digitizes outgoing baseband data to generate processed baseband or IF signals. The RF transceivers 372a-372n receive the processed baseband or IF signals from the TX processing circuit 374 and upconvert the baseband or IF signals into RF signals transmitted via the antennas 370a-370n.

The controller/processor 378 may include one or more processors or other processing devices that control the overall operation of the gNB 102. The controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as more advanced wireless communication functions. The controller/processor 378 can perform a blind interference sensing (BIS) process by a BIS algorithm, and decode received signals from which interference signals are subtracted. The controller/processor 378 may support any of a variety of other functions in the gNB 102. The controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with the 2D antenna array as described herein. The controller/processor 378 supports communication between entities such as web real time communications (RTCs). The controller/processor 378 can move data into or out of the memory 380 as required by the execution process.

The controller/processor 378 is further coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection (s). When the gNB 102 is implemented as part of a cellular communication system, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through wired or wireless connections, such as an Ethernet or RF transceiver.

The memory 380 is coupled to the controller/processor 378. A part of the memory 380 may include a random access memory (RAM), and another part of the memory 380 may include a flash memory or other read only memories (ROMs). A plurality of instructions, such as the BIS algorithm, are stored in the memory. The plurality of instructions is configured to cause the controller/processor 378 to perform a BIS process and decode a received signal after subtracting at least one interference signal determined by the BIS algorithm.

The transmission and reception paths of the gNB 102 (implemented using the RF transceivers 372a-372n, the TX processing circuit 374 and/or the RX processing circuit 376) support aggregated communication with FDD cells and TDD cells.

Although FIG. 3B shows an example of the gNB 102, various changes can be made to FIG. 3B. The gNB 102 may include any number of each component shown in FIG. 3B. The access point may include multiple backhaul or network interfaces 382, and the controller/processor 378 can support the routing function to route data between different network addresses. Although shown as including a single instance of the TX processing circuit 374 and a single instance of the RX processing circuit 376, the gNB 102 may include multiple instances of each (such as one for each RF transceiver).

In wireless communication systems, a UE can only obtain power parameter and/or spatial domain parameter changes for network device side in a semi-static manner, which cannot meet the flexible adjustment requirements for the base station side.

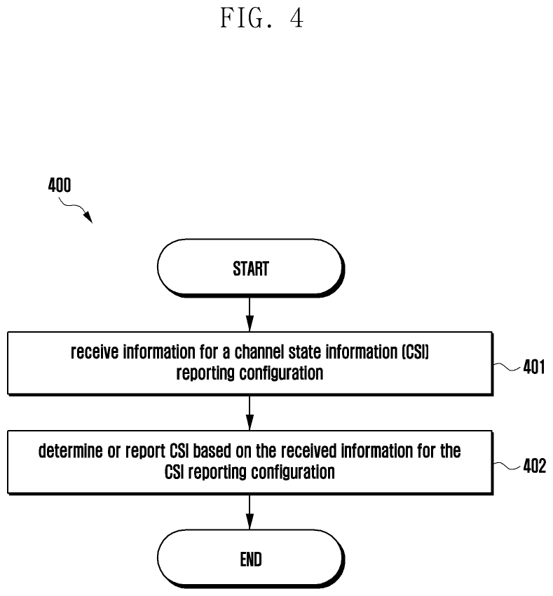

FIG. 4 illustrates a method 400 performed by UE according to an embodiment. Referring to FIG. 4, in step 401, UE receives information for a CSI reporting configuration. In step 402, the UE determines CSI and/or reports CSI based on the received information for the CSI reporting configuration. CSI reporting configuration information can be used interchangeably with information for CSI reporting configuration and information for configuring CSI reporting.

### Embodiment 1

The UE receives CSI reporting configuration information (for example, CSI-ReportConfig). The CSI reporting configuration information is associated with/corresponds to/includes one or more first sub-configurations, which may be referred to as sub-configuration information. The first sub-configuration may be sub-configuration information of a CSI report. The CSI reporting configuration information may correspond to a CSI report, or the CSI reporting configuration information may be used to refer to a CSI report.

A second sub-configuration may include one of the one or more first sub-configurations. The second sub-configuration is one or more sub-configurations among the plurality of first sub-configurations. When the CSI reporting configuration information corresponds to a periodic CSI report, the second sub-configuration is a sub-configuration among the one or more first sub-configurations. When the CSI reporting configuration information corresponds to a periodic CSI report, each report instance of the periodic CSI report targets all of the one or more first sub-configurations. The number of the one or more first sub-configurations can be L, where L>1 (or L>=1). The number of the one or more first sub-configurations can be L, where L>1 (or L>=1). For example, considering when the second sub-configuration is all sub-configurations in a subset of the one or more first sub-configurations, the number of the second sub-configuration(s) can be N, where N<=L and/or N>=1. When the CSI report is a periodic CSI report, N=L. The CSI report includes CSI parameters corresponding to all of the one or more first sub-configurations. The CSI reporting configuration information corresponding to a periodic CSI report refers to that a report type parameter (reportConfigType) in the CSI reporting configuration information (e.g., CSI-ReportConfig) is set to “periodic”.

The second sub-configuration may include a subset of the one or more first sub-configurations. The second sub-configuration is one or more first sub-configurations in the subset of the one or more first sub-configurations. When the CSI reporting configuration information corresponds to a semi-persistent CSI report or aperiodic CSI report, the second sub-configuration can be one or more first sub-configurations in the subset of the one or more first sub-configurations. The number of the one or more first sub-configurations can be L, where L>1 (or L>=1). For example, considering when the second sub-configuration is all sub-configurations in the subset of the one or more first sub-configurations, the number of the second sub-configuration(s) can be N, where N<=L and/or N>=1. The subset is indicated or provided by signaling for triggering/activating/scheduling/indicating CSI reports corresponding to the CSI reporting configuration information. The CSI reporting configuration information includes or is configured with L sub-configurations, signaling can trigger/activate/schedule/indicate CSI reports corresponding to the CSI reporting configuration information, and the signaling can indicate N sub-configurations out of the L sub-configurations for CSI reporting. For example, N<=L and/or N>=1. The UE generates/derives CSI parameters corresponding to the N sub-configurations out of the L sub-configurations and includes them in the CSI report. For example, if the CSI reporting configuration information corresponds to a semi-persistent CSI report on a physical uplink control channel (PUCCH) and includes (or is configured with) L sub-configurations, media access control-control element (MAC-CE) signaling can trigger the CSI report corresponding to the CSI reporting configuration information (e.g., carried by the PUCCH), and the MAC-CE signaling may include indication information used to indicate N sub-configurations out of the L sub-configurations for CSI reporting. For example, if the CSI reporting configuration information corresponds to a semi-persistent CSI report on a physical uplink shared channel (PUSCH), and the CSI reporting configuration information includes or is configured with L sub-configurations, downlink control information (DCI) or a DCI format can trigger the CSI report corresponding to the CSI reporting configuration information (e.g., carried by the PUSCH), and the DCI can indicate a triggering state. The triggering state is associated with N sub-configurations out of the L sub-configurations or can indicate N configurations for CSI reporting. The DCI format can be DCI format 0_1 or DCI format 0_2. For example, if the CSI reporting configuration information corresponds to a aperiodic CSI report, and the CSI reporting configuration information includes or is configured with L sub-configurations, DCI (or DCI format) can trigger the CSI report corresponding to the CSI reporting configuration information (e.g., carried by the PUSCH), and the DCI can indicate a triggering state. The triggering state is associated with N sub-configurations out of the L sub-configurations or indicates N configurations for CSI reporting. The DCI format can be DCI format 0_1 or DCI format 0_2. The CSI reporting configuration information corresponding to the semi-persistent CSI report on the PUCCH refers to the report type parameter (reportConfigType) in the CSI reporting configuration information (e.g., CSI-ReportConfig) being set to “semiPersistentOnPUCCH”. The CSI reporting configuration information corresponding to the semi-persistent CSI report on the PUSCH refers to the report type parameter (reportConfigType) in the CSI reporting configuration information (e.g., CSI-ReportConfig) being set to “semiPersistentOnPUSCH”. The CSI reporting configuration information corresponding to the aperiodic CSI report refers to the report type parameter (reportConfigType) in the CSI reporting configuration information (e.g., CSI-ReportConfig) being set to “aperiodic”.

The description of the second sub-configuration in this disclosure can be applied to one sub-configuration or each sub-configuration or any sub-configuration among the one or more first sub-configurations. The description of the second sub-configuration in this disclosure can be applied to one sub-configuration or each sub-configuration or any sub-configuration in the sub-configuration subset of the one or more first sub-configurations. The second sub-configuration may be equivalent to one or more first sub-configurations.

One of the plurality of first sub-configurations or one of the second sub-configuration(s) may be referred to as a sub-configuration. The sub-configuration may include/indicate/configure/be associated with at least one of the following.

Port Parameter. The port parameter is used to indicate a port subset (An antenna port subset). The port parameter may indicate port(s) of a channel state information reference signal (CSI-RS). The port parameter may be a bitmap. The length of the bitmap may be equal to the number of port(s) of a reference signal resource used for channel measurement (The number is indicated by a number of port(s) parameter nrofPort). The reference signal resource is a reference signal resource corresponding to CSI reporting configuration information. Bits of the bitmap are in one-to-one correspondence with ports (e.g., antenna ports) of the reference signal resource. A number of port(s) indicated by a sub-configuration is the number of bits “1” (or “0”) in the bitmap, where “0” represents/indicates that the corresponding port is disabled (or closed, or unused) in the corresponding sub-configuration and “1” represents/indicates that the corresponding port is enabled (or opened, or used) in the corresponding sub-configuration. The definitions of the bit values “0” and “1” are variable. When the port parameter is not configured, the corresponding port of the sub-configuration can be the port(s) of a CSI-RS resource associated with the CSI reporting configuration information used for channel measurement.

Codebook Parameter. The codebook parameter may include/indicate at least one of a first-dimension parameter (N1), a second-dimension parameter (N2), a parameter (Ng) for a panel/multi-panel (or for a panel/multi-panel codebook), and a codebook restriction (or a codebook subset restriction). The codebook subset restriction is used to indicate precoding matrix indicator (PMI) that is not allowed to be reported. For instance, when the CSI reporting configuration corresponds to/is associated with a (type I) single-panel codebook (A codebook type parameter codebookType is set to “typeI-SinglePanel”) or the sub-configuration corresponds to/is associated with a (type I) single-panel codebook, the sub-configuration can include/indicate the first-dimension parameter (N1) and the second-dimension parameter (N2). When the CSI reporting configuration corresponds to/is associated with a (type I) multi-panel codebook (a codebook type parameter codebookType is set to “typeI-MultiPanel”) or the sub-configuration corresponds to/is associated with a (type I) multi-panel codebook, the sub-configuration can include/indicate the first-dimension parameter (N1), the second-dimension parameter (N2) and the parameter (Ng) for a panel/multi-panel (or for a panel/multi-panel codebook). When Ng is configured, the sub-configuration corresponds to a multi-panel codebook. When Ng is not configured, the sub-configuration corresponds to a single-panel codebook. When Ng is configured with a value greater than 1, the sub-configuration corresponds to a multi-panel codebook. When Ng is configured with a value equal to 1, the sub-configuration corresponds to a single-panel codebook. The benefit of this approach is that the parameter Ng can implicitly indicate the codebook type of the sub-configuration, reducing signaling overhead and more precisely defining the behavior of a terminal device.

Codebook Type Parameter. The codebook type parameter is used to indicate whether the sub-configuration corresponds to a (type I) single-panel codebook or a (type I) multi-panel codebook. If this parameter is not configured, the sub-configuration determines the codebook type based on a parameter indicated/configured in the CSI reporting configuration information (e.g., codebookType). The codebook type parameter codebookType is set to “typeI-SinglePanel”, representing a (type I) single-panel codebook. The codebook type parameter codebookType is set to “typeI-MultiPanel”, representing a (type I) multi-panel codebook. The benefit of this approach is that the parameter can explicitly indicate the codebook type of the sub-configuration and more precisely define the behavior of a terminal device.

Codebook Mode Parameter. The codebook mode parameter is used to indicate whether the sub-configuration corresponds to mode 1 or mode 2. If this parameter is not configured, the sub-configuration determines the codebook mode based on a parameter indicated/configured in the CSI reporting configuration information (e.g., codebookMode). The codebook mode parameter codebookMode is set to “1”, representing codebook mode 1. The codebook mode parameter codebookMode is set to “2”, representing codebook mode 2. The benefit of this approach is that the parameter can explicitly indicate the codebook mode of the sub-configuration and more precisely define the behavior of a terminal device.

Rank Restriction Parameter. The rank restriction parameter is used to indicate the restriction of a RI of the sub-configuration. This parameter can indicate which rank values are allowed to be reported and which values are not allowed. If a sub-configuration does not indicate/configure/include or is not associated with a rank restriction parameter, ranks (or rank values) that are allowed to be reported for the sub-configuration are determined based on a rank restriction parameter in the CSI reporting configuration information. If a sub-configuration indicates/configures/includes or is associated with a rank restriction parameter, ranks that are allowed to be reported are determined based on the rank restriction parameter with which the (corresponding) sub-configuration indicates/configures/includes or is associated.

One or more resources. A sub-configuration indicates one or more resources (corresponding to the sub-configuration). A sub-configuration can indicate one or more resources (corresponding to the sub-configuration) via one or more list parameters. The one or more parameters indicate one or more resources (respectively). The list parameter can include one or more resource identifications (IDs) for indicating one or more resources. The one or more resources are from a resource set (e.g., a resource set used for channel measurement and/or interference measurement) corresponding to/associated with the CSI reporting configuration information. The resource set is, e.g., NZP-CSI-RS-ResourceSet. The resource can be used for channel measurement and/or interference measurement. The resource can be a reference signal resource. The resource can be a non-zero power (NZP) CSI-RS resource. The reference signal resource can be a channel state information interference measurement (CSI-IM) resource. CSI corresponding to the sub-configuration is calculated/determined based on the one or more resources.

Channel Quality Indicator (CQI) table parameter. The CQI table parameter is used to indicate a corresponding CQI table of the sub-configuration. For example, CSI (e.g., CQI) corresponding to the sub-configuration is calculated/determined based on the CQI table.

Power Parameter. The power parameter is used to indicate the power of one or more resources corresponding to the sub-configuration. The power of the one or more resources (used for channel measurement) is determined based on this power parameter and power parameters configured for the one or more resources (respectively). For example, if a resource is configured with a power parameter (e.g., powerControlOffset), CSI calculation/CSI determination for the resource is based on the sum of the power parameter indicated by the sub-configuration and the configured power parameter. The sub-configuration power parameter includes selection/indication parameters corresponding to the one or more resources. If a resource is configured with one or more power parameters (e.g., powerControlOffset), CSI calculation/CSI determination for the resource is based on a power parameter (e.g., powerControlOffset) indicated/selected by the corresponding selection/indication parameter.

The UE determines the CSI based on the plurality of first sub-configurations or the second sub-configuration. The CSI can be CSI parameters and/or zero-padding bits. Determining the CSI parameters may be calculating the CSI parameters, determining CSI feedback, or determining a report that carries the CSI parameters (that is, determining the CSI report). The CSI parameter may be CSI feedback or a report that carries the CSI parameter (that is, CSI report).

The CSI parameter can be referred to as CSI quantity. The CSI parameter can be at least one of CRI, RI, PMI, CQI and LI. The CSI parameter can be at least one of CRI, SS/PBCH block resource indicator (SSBRI), Layer 1-reference signal received power (L1-RSRP), L1-signal interference noise ratio (L1-SINR), and capability index. The different CSI parameters mentioned above can also be referred to as different CSI parameter types. For example, CQI and CRI correspond to different CSI parameter types.

The order of CSI is based on at least one of the order of the plurality of first sub-configurations or the order of the second sub-configuration, the order of CSI parameters and/or zero-padding fields corresponding to the CSI reporting configuration information, and the order between zero-padding bits corresponding to the CSI reporting configuration information and the CSI parameters corresponding to the CSI reporting configuration information.

The order of the one or more first sub-configurations can be the order of IDs of the one or more first sub-configurations, such as the increasing or decreasing order of the IDs of the first sub-configurations. A first sub-configuration can be configured with an ID. Each first sub-configuration can be configured with an ID (e.g., sub-configuration ID). The CSI reporting configuration information (or CSI report) includes/corresponds to L sub-configurations. For instance, sub-configuration #1, sub-configuration #2, . . . , sub-configuration #L correspond to L sub-configurations in the CSI reporting configuration information (or CSI report) is mapped in increasing or decreasing order based on IDs. The order/position of the first sub-configurations can be the order/position of the sub-configurations in configuration information, The order/position of the first sub-configurations in the CSI reporting configuration information. For example, sub-configuration #1, sub-configuration #2, . . . , sub-configuration #L correspond to L sub-configurations in the CSI reporting configuration information is mapped according to the order/position of the sub-configurations (in the configuration information). The order of the first sub-configurations can be the order of priorities of the first sub-configurations. The priority value of the sub-configuration is based on at least one of the following: the sub-configuration ID; the position of the sub-configuration in the configuration information; a resource number that the sub-configuration includes/indicates/corresponds to and a number of port(s) to which the sub-configuration includes/indicates/corresponds. The priority of the first sub-configuration or the second sub-configuration is determined firstly based on the number of ports that the sub-configuration includes/indicates/corresponds to or the number of resource(s) that the sub-configuration includes/indicates/corresponds to, and then based on the sub-configuration ID or the position of the sub-configuration in the configuration information. The order of the priorities of the sub-configurations may vary. For example, for one or more sub-configurations, a sub-configuration with a higher priority is the one with a higher/lower corresponding/indicated resource number or a higher/lower corresponding/indicated the number of port(s). For example, if a plurality of sub-configurations has the same corresponding/indicated resource number or the same corresponding/indicated number of port(s), a sub-configuration with a higher or lower ID has a higher priority (or a sub-configuration appearing earlier/later in configuration signaling has a higher priority). The priority of the sub-configuration is determined firstly based on the number of port(s) that the sub-configuration includes/indicates/corresponds to, then based on the number of resource(s) that the sub-configuration includes/indicates/corresponds to, and then based on the sub-configuration ID or the position of the sub-configuration in the configuration information. The priority of the sub-configuration is first determined based on the number of resource(s) to which the sub-configuration includes/indicates/corresponds, then based on the number of port(s) to which the sub-configuration includes/indicates/corresponds, and then based on the sub-configuration ID or the position of the sub-configuration in the configuration information. The priority P of the sub-configuration can be calculated using a formula. For example, P=x+x_max*y+x_max*y_max*z, where x corresponds to/indicates the value of the sub-configuration ID or the value of a position index of the sub-configuration in the configuration information, y corresponds to/indicates the value of the number of port(s) indicated by the sub-configuration or the value of the number of resource(s) indicated by the sub-configuration, z corresponds to/indicates the value of the number of resource(s) indicated by the sub-configuration or the value of the number of port(s) indicated by the sub-configuration, x_max corresponds to/indicates the maximum value of the sub-configuration ID or the maximum value of the position index of the sub-configuration in the configuration information, and y_max corresponds to/indicates a number of port(s) of a reference signal resource for channel measurement associated with CSI reporting configuration information associated with the sub-configuration. The number is indicated by the number parameter of the port parameter nrofPort), or y_max corresponds to/indicates a number of resource(s) of a reference signal resource set for channel measurement associated with CSI reporting configuration information associated with the sub-configuration. If the priority value of one sub-configuration is greater than or less than that of another sub-configuration, this indicates that the one sub-configuration has a higher priority.

The number of port(s) corresponding to the sub-configuration can be the number of port(s) indicated by the sub-configuration. The number of port(s) indicated by the sub-configuration can be a number of port(s) of a port subset indicated by the sub-configuration. The sub-configuration indicates a port parameter. The port subset can include (all) the port(s) indicated by “1” in the bitmap. The number of port(s) corresponding to the sub-configuration can be the number of port(s) of a reference signal resource for channel measurement associated with the CSI reporting configuration information (The number is indicated by the port number parameter nrofPort).

The number of port(s) indicated by the sub-configuration can be determined by a parameter related to a codebook indicated by the sub-configuration. When the CSI reporting configuration corresponds to/is associated with a (type I) single-panel codebook (e.g., the codebook type parameter codebookType is set to “typeI-SinglePanel”) or the sub-configuration corresponds to/is associated with a (type I) single-panel codebook, the sub-configuration indicates the first dimension parameter (N1) and the second dimension parameter (N2). The number of port(s) indicated by the sub-configuration is based on N1 and N2. For example, the number of port(s) indicated by the sub-configuration is equal to the product of 2, N1, and N2 (2*N1*N2). When both N1 and N2 are 1 and the number of subsets of ports indicated by the above bitmap is 1, the number of port(s) indicated by the sub-configuration is the product of N1 and N2 (N1*N2). When N1 and N2 are not both 1 and the number of subsets of ports indicated by the above bitmap is greater than 1, the number of port(s) indicated by the sub-configuration is the product of 2, N1, and N2 (2*N1*N2). When the CSI reporting configuration corresponds to/is associated with a (type I) multi-panel codebook (e.g., the codebook type parameter codebookType is set to “typeI-MultiPanel”), the sub-configuration indicates the first-dimension parameter (N1), the second-dimension parameter (N2), and the parameter (Ng) for a panel/multi-panel or for a panel/multi-panel codebook. The number of port(s) indicated by the sub-configuration is based on N1, N2, and Ng. The number of port(s) indicated by the sub-configuration is equal to the product of 2, N1, N2, and Ng (2*N1*N2*Ng). When both N1 and N2 are 1 (and the number of subsets of ports indicated by the above bitmap is 1), the number of port(s) indicated by the sub-configuration is the product of N1, N2, and Ng (N1*N2*Ng). When N1 and N2 are not both 1 and the number of subsets of ports indicated by the above bitmap is greater than 1, the number of port(s) indicated by the sub-configuration is the product of 2, N1, N2, and *Ng (2*N1*N2*Ng).

The number of resource(s) corresponding to/indicated by the sub-configuration can be the number of one or more resources indicated by the sub-configuration. The number of resource(s) corresponding to the sub-configuration can be a number of resource(s) in a reference signal resource set for channel measurement associated with CSI reporting configuration information (e.g., the total number of all resources in the resource set).

The order of the second sub-configuration(s) can be the order of IDs of the one or more second sub-configuration(s), for example, the increasing or decreasing order of the IDs of the second sub-configuration(s). A second sub-configuration can be configured with an ID. Each second sub-configuration can be configured with an ID (e.g., sub-configuration ID). The CSI reporting configuration information (or CSI report) includes/corresponds to L sub-configurations. The L sub-configurations include N second sub-configuration(s). For instance, sub-configuration #1, sub-configuration #2, . . . , sub-configuration #N correspond to N sub-configurations in the CSI reporting configuration information (or CSI report) are mapped in increasing or decreasing order based on ID. The order/position of the second sub-configuration(s) can be the order/position of the (one or more) second sub-configuration(s) in configuration information, for example, the order/position of the second sub-configuration(s) in the CSI reporting configuration information. For example, sub-configuration #1, sub-configuration #2, . . . , sub-configuration #N correspond to N sub-configurations in the CSI reporting configuration information (or CSI report) are mapped according to the order/position of the sub-configurations in the configuration information. The order of the second sub-configuration(s) can be the order of priorities of the second sub-configuration(s).

The above description for determining the order of the one or more first sub-configurations and/or determining the order of the second sub-configuration(s) can allow the terminal device and network device to have the same understanding of ordering CSI information bits based on the same ordering rules, thereby improving the reliability of the communication system. This predefined ordering method does not require additional indication signaling for ordering, which enhances the efficiency of the communication system.

The CSI includes/corresponds to/is associated with CSI parameters and/or zero-padding fields corresponding to the CSI reporting configuration information. One or more first sub-configurations or second sub-configurations correspond to CSI parameters. The CSI parameters of one or each of first sub-configuration or second sub-configuration are determined/calculated based on parameters configured for the corresponding first or second sub-configuration.

The number of the CSI parameters is based on the number of the plurality of first sub-configurations. The CSI parameters correspond to or include the CSI. The number of the CSI parameters is equal to the number of the plurality of first sub-configurations. Taking CRI as an example for the CSI parameters, each of the first sub-configurations (sub-configuration #1, sub-configuration #2, . . . , sub-configuration #L) corresponds to one CRI. The CSI includes/corresponds to L CRIs. The CSI parameters can also be at least one of RI, LI, PMI, and CQI. The CSI includes/corresponds to L RI(s)/LI(s)/PMI(s)/CQI(s). The number of the CSI parameters is based on the number of the second sub-configuration(s). The number of the CSI parameters is equal to the number of the second sub-configuration(s). The CRI is used as an example for the CSI parameters, and each of the second sub-configuration(s) (sub-configuration #1, sub-configuration #2, . . . , sub-configuration #N) corresponds to one CRI. The CSI includes/corresponds to N CRIs. The CSI parameters can also be at least one of RI, LI, PMI, and CQI. The CSI includes/corresponds to N RI(s)/LI(s)/PMI(s)/CQI(s).

To avoid changes in the total bit number in the CSI or a portion of the CSI, zero-padding bits can be added to the CSI to avoid multiple attempts by the base station during blind detection of CSI with variable total bit number. By the zero-padding bits, the base station is allowed to always decode CSI with a fixed total bit number, reducing base station complexity. The zero-padding bits can be located in one or more CSI fields. For example, the zero-padding bits can be in a zero-padding field or a zero-padding bit field. A zero-padding bit field or a zero-padding field can be a group of zero bits (or a group of consecutive information bits with a value of 0). The zero-padding bits can be in a CSI field that includes RI parameters. The zero-padding bits can be in a CSI field that includes LI parameters. The number of fields (e.g., CSI field) associated with the zero-padding bits or where the zero-padding bits are located is based on the number of the plurality of first sub-configurations. The zero-padding bits are zero-padding bits that the CSI includes/corresponds to. The CSI field including or associated with the zero-padding bits is one that the CSI includes/corresponds to. The number of CSI fields including or associated with the zero-padding bits is equal to the number of the plurality of first sub-configurations. Considering when the CSI fields including or associated with the zero-padding bits are zero-padding fields, for example, each of the first sub-configurations (sub-configuration #1, sub-configuration #2, . . . , sub-configuration #L) corresponds to a zero-padding field. The CSI includes/corresponds to L zero-padding fields. The number of fields associated with the zero-padding bits or where the zero-padding bits are located is based on the number of the second sub-configuration(s). The zero-padding field is one that the CSI includes/corresponds to. The number of the zero-padding fields is equal to the number of the second sub-configuration(s). For example, each of the second sub-configuration(s) (sub-configuration #1, sub-configuration #2, . . . , sub-configuration #N) corresponds to a zero-padding field. The CSI includes/corresponds to N zero-padding fields. The number of fields associated with the zero-padding bits or where the zero-padding bits are located is a specific value such as 1, 2, 3, or 4, for example. This specific value can be based on the capabilities of the terminal device indicated by capability signaling reported by the terminal. This specific value can be indicated by the base station in at least one of DCI, MAC-CE, or RRC signaling. The second sub-configuration(s) (sub-configuration #1, sub-configuration #2, . . . , sub-configuration #N) correspond to one zero-padding field. The CSI includes/corresponds to one zero-padding field.

The order of information bits of the CSI may be based on the order of the CSI parameters and/or zero-padding bits corresponding to the CSI reporting configuration information, and/or the order between the zero-padding bits corresponding to the CSI reporting configuration information and the CSI parameters corresponding to the CSI reporting configuration information. The CSI parameters corresponding to the CSI reporting configuration information can be at least one of CRI, RI, LI, PMI, and CQI. A CSI parameter of a report quantity parameter (e.g., reportQuantity) in the CSI reporting configuration information (e.g., CSI-ReportConfig) can be at least one of CRI, RI, LI, PMI, and CQI. When the parameter reportQuantity is set to “cri-RI-LI-PMI-CQI”, the corresponding CSI parameters are CRI, RI, LI, PMI, and CQI. When the parameter reportQuantity is set to “cri-RI-PMI-CQI”, the corresponding CSI parameters are CRI, RI, PMI, and CQI. When the parameter reportQuantity is set to “cri-RI-i1-CQI”, the corresponding CSI parameters are CRI, RI, PMI, and CQI. When the parameter reportQuantity is set to “cri-RI-i1”, the corresponding CSI parameters are CRI, RI, and PMI. When the parameter reportQuantity is set to “cri-RI-CQI”, the corresponding CSI parameters are CRI, RI, and CQI.

The order of the CSI parameters may include at least one of the following: the order of CSI parameter types, the order of frequency domain-related parameters corresponding to the CSI parameters, and/or the order of transmission blocks (TB) corresponding to the CSI parameters. The order of the CSI parameters is illustrated below by taking the order of CSI parameter types as an example. The order of the CSI parameters can be as follows: CRI, RI, LI, PMI, and CQI. The order of the CSI parameters can be as follows: CRI (if reported/exists), RI (if reported/exists), LI (if reported/exists), PMI (if reported/exists), and CQI (if reported/exists). In other words, if some CSI parameters are not reported, the order of the CSI parameters in CSI still follows the above order. The order of the CSI parameters and/or zero-padding bits can be as follows: CRI, RI, LI, zero padding bits, PMI, and CQI. The order of the CSI parameter and/or the zero-padding bits is as follows: CRI (if reported/exists), RI (if reported/exists), LI (if reported/exists), zero-padding bits (if reported/exists), PMI (if reported/exists), and CQI (if reported/exists). The zero-padding bits can be placed after the CSI parameters. The order of the CSI parameters and/or the zero-padding bits is CRI (if reported/exists), RI (if reported/exists), LI (if reported/exists), PMI (if reported/exists) and CQI (if reported/exists), and zero-padding bits (if reported/exists). This indicates that if some CSI parameters are not reported, the order of the CSI parameters in CSI still follows the aforementioned order. The benefit of placing the zero-padding bits at a specific position in the CSI as described above (e.g., after LI or after all the CSI parameters) is that since the calculation of the zero-padding bits is based on the quantity of CRI and RI, a situation where the zero-padding bits being in front of CRI and/or RI would cause inaccurate determination of CRI and/or RI is avoided, allowing the base station to correctly decode CSI and enhance the reliability of the communication system.

When the CSI includes one part (or when the CSI corresponds to a single CSI part, or when the number of CSI parts included in the CSI is 1), the order of the CSI parameters and/or the zero-padding bits is CRI (if reported/exists), RI (if reported/exists), LI (if reported/exists), zero-padding bits (if reported/exists), PMI (if reported/exists), and CQI (if reported/exists). When the CSI includes two parts, in a CSI part 1, the order of the CSI parameters is CRI (if reported/exists), RI (if reported/exists), and CQI (if reported/exists). When the CSI includes two parts, in wideband CSI of a CSI part 2, the order of the CSI parameters is CQI (if reported/exists), LI (if reported/exists), and PMI (if reported/exists). When the CSI includes two parts, in subband CSI of a CSI part 2, the order of the CSI parameters is CQI (if reported/exists), and PMI (if reported/exists).

PMI may include a PMI wideband information field X₁ and/or a PMI wideband information field X₂. X₁ may precede X₂ (in PMI). X₂ may precede X₁ (in PMI). CQI may include wideband CQI and/or subband CQI. CQI may include CQI for a first TB and/or CQI for a second TB. A (wideband/subband) CQI may include (wideband/subband) CQI for the first TB and/or (wideband/subband) CQI for the second TB. The (wideband/subband) CQI for the first TB precedes the (wideband/subband) CQI for the second TB.

The CSI may be firstly based on the order of the plurality of first sub-configurations or the second sub-configuration(s), and then based on the order of the CSI parameters and/or the zero-padding fields corresponding to the CSI reporting configuration information. Alternatively, the CSI may be firstly based on the order of the CSI parameters and/or the zero-padding fields corresponding to the CSI reporting configuration information, and then based on the order of the plurality of first sub-configurations or the second sub-configuration(s). The following takes the first sub-configurations as an example (the method for the second sub-configuration(s) is similar, replacing L with N). For example, each of the first sub-configurations (sub-configuration #1, sub-configuration #2, . . . , sub-configuration #L) corresponds to one CRI, one RI, one LI, one PMI, and one CQI. For example, sub-configuration #1 corresponds to CRI #1, RI #1, LI #1, PMI #1, and CQI #1, sub-configuration #2 corresponds to CRI #2, RI #2, LI #2, PMI #2, and CQI #2, and so on. For example, if the order is first based on the order of the CSI parameters and then based on the order of the sub-configurations, the order of the CSI parameters in the CSI is CRI #1, CRI #2, . . . , CRI #L, RI #1, RI #2, . . . , RI #L, . . . , CQI #1, CQI #2, . . . , CQI #L. If the order is first based on the order of the sub-configurations and then based on the order of the CSI parameters, the order of the CSI parameters in the CSI is CRI #1, RI #1, LI #1, PMI #1, CQI #1, CRI #2, RI #2, LI #2, PMI #2, CQI #2, . . . , CRI #L, RI #L, LI #L, PMI #L, CQI #L. If zero-padding bits are needed in CSI, and the order is first based on the order of the CSI parameters and then based on the order of the sub-configurations, the order of the CSI parameters in the CSI is CRI #1, CRI #2, . . . , CRI #L, RI #1, RI #2, . . . , RI #L, LI #1, LI #2, . . . , LI #L, zero-padding bits, PMI #1, PMI #2, . . . , PMI #L, CQI #1, CQI #2, . . . , CQI #L. If zero-padding bits are needed in CSI, and the order is first based on the order of the sub-configurations and then based on the order of the CSI parameters, the order of the CSI parameters in the CSI is CRI #1, RI #1, LI #1, zero-padding bits, PMI #1, CQI #1, CRI #2, RI #2, LI #2, zero-padding bits, PMI #2, CQI #2, . . . , CRI #L, RI #L, LI #L, zero-padding bits, PMI #L, CQI #L.

The zero-padding bits are determined based on associated/corresponding sub-configurations (or parameters of the sub-configurations), or based on the plurality of first sub-configurations (or parameters of the plurality of first sub-configurations) or the second sub-configuration(s) (or parameters of the second sub-configuration(s)). When the number of fields including the zero-padding bits is equal to the number of the plurality of first sub-configurations or the second sub-configuration(s), each zero-padding bit is determined based on CSI parameters of the corresponding sub-configuration. If zero-padding bits are needed in CSI, and the order is first based on the order of the sub-configurations and then based on the order of the CSI parameters, the order of the CSI parameters in the CSI is CRI #1, RI #1, LI #1, zero-padding bits #1, PMI #1, CQI #1, CRI #2, RI #2, LI #2, zero-padding bits #2, PMI #2, CQI #2, . . . , CRI #L, RI #L, LI #L, zero-padding bits #L, PMI #L, CQI #L. In this case, the number of CSI fields including the zero-padding bits in the CSI is L, and the zero-padding bits are determined based on each of the L first sub-configurations (or parameters that the L first sub-configurations include/indicate). That is, the zero-padding bit #1 is determined based on the parameters of the sub-configuration #1; the zero-padding bit #2 is determined based on the parameters of the sub-configuration #2; and so on. When the number of the zero-padding fields is 1, the corresponding zero-padding bits are determined based on CSI parameters of the plurality of first sub-configurations or the second sub-configuration(s). If zero-padding bits are needed in CSI, and the order is first based on the order of the CSI parameters and then based on the order of the sub-configurations, the order of the CSI parameters in the CSI is CRI #1, CRI #2, . . . , CRI #L, RI #1, RI #2, . . . , RI #L, LI #1, LI #2, . . . , LI #L, zero-padding bits, PMI #1, PMI #2, . . . , PMI #L, CQI #1, CQI #2, . . . , CQI #L. In this case, the number of CSI fields including the zero-padding bits in the CSI is 1, and the zero-padding bits are determined based on L first sub-configurations (or parameters that the L first sub-configurations include/indicate).

The zero-padding bits or the number of the zero-padding bits are based on the associated/corresponding sub-configuration or parameters corresponding to the sub-configuration. The zero-padding bits (or the number of the zero-padding bits) are based on at least one of the following of the associated/corresponding sub-configuration.

Rank and/or rank values that are allowed to be reported. The rank and/or rank values that are allowed to be reported can be based on the restriction of the rank of (corresponding to) the sub-configuration.

Reported rank. For example, reported RI corresponding to the sub-configuration in the CSI. The corresponding rank of the reported RI corresponding to the sub-configuration in the CSI.

Reported PMI. For example, reported PMI corresponding to the sub-configuration in the CSI.

Reported CQI. For example, reported CQI corresponding to the sub-configuration in the CSI.

Reported LI. For example, reported LI corresponding to the sub-configuration in the CSI.

PMI. The maximum bitwidth corresponding to PMI. For example, PMI calculated/determined based on the reported rank and/or PMI calculated/determined based on ranks that are allowed to be reported. The bitwidth corresponding to the PMI calculated/determined based on the reported rank and/or the maximum bitwidth of the PMI calculated/determined based on ranks that are allowed to be reported.

CQI. The maximum number of bits corresponding to CQI. For example, CQI calculated/determined based on the reported rank and/or CQI calculated/determined based on ranks that are allowed to be reported. The number of bits corresponding to the CQI calculated/determined based on the reported rank and/or the maximum number of bits of the CQI calculated/determined based on ranks that are allowed to be reported.

LI. The maximum number of bits corresponding to LI. For example, LI calculated/determined based on the reported rank and/or LI calculated/determined based on ranks that are allowed to be reported. The number of bits corresponding to the LI calculated/determined based on the reported rank and/or the maximum number of bits of the LI calculated/determined based on ranks that are allowed to be reported.

The (number of) zero-padding bits of the associated/corresponding sub-configuration is based on/equal to a difference between the maximum bitwidth calculated/determined based on ranks that are allowed to be reported for (corresponding to) the sub-configuration and the bitwidth calculated/determined based on the reported rank of the sub-configuration. For example, for a sub-configuration/for the corresponding sub-configuration, the number of the zero-padding bits equals the sum of the maximum bitwidth of the PMI (if reported) and/or the maximum bitwidth of CQI (if reported) and/or the maximum bitwidth of LI (if reported) calculated/determined based on ranks that are allowed to be reported, minus the sum of the bitwidth of PMI (if reported) and the bitwidth of CQI (if reported) and the bitwidth of LI (if reported) calculated/determined based on the reported rank.

The zero-padding bits or the number of the zero-padding bits are based on parameters of the plurality of first sub-configurations or (parameters corresponding to) the second sub-configuration(s). The zero-padding bits (or the number of the zero-padding bits) are based on at least one of the following parameters of the plurality of first sub-configurations or parameters corresponding to the second sub-configuration(s).

Rank and/or rank values that are allowed to be reported. The rank/rank values that are allowed to be reported can be based on the restriction of the rank of the sub-configuration. For example, common ranks that are allowed to be reported for the plurality of first sub-configurations. For example, ranks that are allowed to be reported for one of the plurality of first sub-configurations. For example, ranks that are allowed to be reported for each of the plurality of first sub-configurations. The rank/rank values that are allowed to be reported are based on a rank restriction parameter in the CSI reporting configuration information. The rank restriction parameter in the CSI reporting configuration information is shared by all the sub-configurations.

Reported Rank. For example, RI of the sub-configuration in the CSI. The reported rank of one of the plurality of first sub-configurations. The reported rank of each of the plurality of first sub-configurations.

Reported PMI. For example, reported PMI corresponding to the sub-configuration in the CSI. For example, reported PMI corresponding to one or each of the plurality of first sub-configurations.

Reported CQI. For example, reported CQI corresponding to the sub-configuration in the CSI. For example, reported CQI corresponding to one or each of the plurality of first sub-configurations.

Reported LI. For example, reported LI corresponding to the sub-configuration in the CSI. For example, reported LI corresponding to one or each of the plurality of first sub-configurations.

PMI. The maximum bitwidth corresponding to PMI. For example, PMI calculated/determined based on the reported rank and/or PMI calculated/determined based on ranks that are allowed to be reported. The bitwidth corresponding to the PMI calculated/determined based on the reported rank and/or the maximum bitwidth of the PMI calculated/determined based on ranks that are allowed to be reported. Reference may be made to Embodiment 2 below for the calculation method of the bitwidth of PMI.

CQI. The maximum number of bits corresponding to CQI. For example, CQI calculated/determined based on the reported rank and/or CQI calculated/determined based on ranks that are allowed to be reported. The number of bits corresponding to the CQI calculated/determined based on the reported rank and/or the maximum number of bits of the CQI calculated/determined based on ranks that are allowed to be reported. Reference may be made to Embodiment 2 below for the calculation method of the number of bits of CQI.

LI. The maximum number of bits corresponding to LI. For example, LI calculated/determined based on the reported rank and/or LI calculated/determined based on ranks that are allowed to be reported. The number of bits corresponding to the LI calculated/determined based on the reported rank and/or the maximum number of bits of the LI calculated/determined based on ranks that are allowed to be reported. Reference may be made to Embodiment 2 below for the calculation method of the number of bits of LI.

The number of zero-padding bits corresponding to parameters of the plurality of first sub-configurations or the second sub-configuration(s) (or, in the corresponding CSI) may be based on/equal to (difference between) the maximum bitwidth calculated/determined based on the ranks that are allowed to be reported corresponding to the parameters of the plurality of first sub-configurations or the second sub-configuration(s), and the bitwidth calculated/determined based on the reported ranks (respectively) corresponding to the parameters of the plurality of first sub-configurations or the second sub-configuration(s). For example, (for a sub-configuration or the corresponding sub-configuration), the number of zero-padding bits is equal to/based on the sum of the maximum bitwidth of PMI (if reported) and/or the maximum bitwidth of CQI (if reported) and/or the maximum bitwidth of LI (if reported) calculated/determined based on the ranks (of the corresponding sub-configuration) that are allowed to be reported, minus the sum of the bitwidth of PMI (if reported) and/or the bitwidth of CQI (if reported) and/or the bitwidth of LI (if reported) calculated/determined based on the reported ranks (of the corresponding sub-configuration). The number of zero-padding bits corresponding to parameters of the plurality of first sub-configurations or the second sub-configuration(s) can be the sum of the numbers of zero-padding bits calculated/determined for all the corresponding sub-configurations (respectively).

The rank(s) (or rank value(s)) that are allowed to be reported are determined based on a rank restriction parameter in the CSI reporting configuration information, or the rank(s) that are allowed to be reported are determined based on a rank restriction parameter that a corresponding sub-configuration indicates/configures/includes or is associated with. If a sub-configuration does not indicate/configure/include or is not associated with a rank restriction parameter, rank(s) (or rank value(s)) that are allowed to be reported for the sub-configuration are determined based on a rank restriction parameter in the CSI reporting configuration information. If a sub-configuration indicates/configures/includes or is associated with a rank restriction parameter, rank(s) that are allowed to be reported are determined based on the rank restriction parameter with which the (corresponding) sub-configuration indicates/configures/includes or is associated.

The order of the frequency domain-related parameters corresponding to the CSI parameters can be at least one of the order of odd subband number and even subband number, the order of subband number, the order of frequency domain granularities, and the order of X₁ and X₂. Taking CQI as an example for the CSI parameters (or the type of CSI parameter is CQI), the order of the CSI parameters (e.g., the order of the plurality of first sub-configurations or the second sub-configuration(s), and/or the order of the frequency domain-related parameters corresponding to the CSI parameters, and/or the order of TBs corresponding to the CSI parameters) is explained. The order of information bits related to the CQI in the CSI (e.g., wideband CQI and/or subband CQI) is based on at least one of the order of the plurality of first sub-configurations or the second sub-configuration(s), the order of subband number, the order of TBs, the order of frequency domain granularities, and the order of odd subband number and even subband number. Information bits of the CQI may be within one CSI field (the information bits of the CQI may be present in a plurality of CSI fields). When the CSI includes one CSI field and the CSI field includes (one or more) subband CQIs of the plurality of first sub-configurations or (one or more) subband CQIs of the second sub-configuration(s), the order of subband CQIs or information bits of the subband CQIs in the CSI field is based on the order of the plurality of first sub-configurations or the second sub-configuration(s) corresponding to the subband CQIs, and/or the order of subband number corresponding to the subband CQIs. The subband CQIs in the CSI field are first mapped based on the order of the plurality of first sub-configurations or the second sub-configuration(s) corresponding to the subband CQIs, and then based on the order of the subband number corresponding to the subband CQIs. The subband CQIs in the CSI field are first mapped based on the order of the subband number corresponding to the subband CQIs, and then based on the order of the plurality of first sub-configurations or the second sub-configuration(s) corresponding to the subband CQIs. The subband CQI may be subband CQI for the first TB. The subband CQI may be subband CQI for the second TB. When the CSI includes one CSI field and the CSI field includes wideband CQIs of the plurality of first sub-configurations such as the wideband CQI for the first TB and the wideband CQI for the second TB, or wideband CQIs of the second sub-configuration(s) such as the wideband CQI for the first TB and the wideband CQI for the second TB, the order of subband CQIs (or information bits of the subband CQIs) in the CSI field is based on the order of the plurality of first sub-configurations or the second sub-configuration(s) corresponding to the wideband CQIs, and/or the order of TBs corresponding to the wideband CQIs. The wideband CQIs in the CSI field are first mapped based on the order of the plurality of first sub-configurations or the second sub-configuration(s) corresponding to the wideband CQIs, and then based on the order of the two TBs corresponding to the wideband CQIs (e.g., the first TB preceding the second TB, or vice versa). The wideband CQIs in the CSI field are first mapped based on the order of the two TBs corresponding to the wideband CQIs (e.g., the first TB preceding the second TB, or vice versa), and then based on the order of the plurality of first sub-configurations or the second sub-configuration(s) corresponding to the wideband CQIs. The information bits of the CQI can be based on the order of the plurality of first sub-configurations or the second sub-configuration(s) and the order of frequency domain granularities, such as wideband CQIs first and then subband CQIs, or vice versa. The information bits of the CQI can be first based on the order of the plurality of first sub-configurations or the second sub-configuration(s), and then based on the order of frequency domain granularities. The information bits of the CQI can be first based on the order of frequency domain granularities, and then based on the order of the plurality of first sub-configurations or the second sub-configuration(s). The information bits of the CQI can be determined based on the order of odd subband number and even subband number, the order of subband number of corresponding to the CQI, the order of the plurality of first sub-configurations or the second sub-configuration(s), and the order of frequency domain granularities. The information bits of the CQI can be first based on the order of odd subband number and even subband number (for example, odd number first and then even numbers, or vice versa), then based on the order of odd subband number and the order of even subband number separately (e.g., in increasing or decreasing order), and finally based on the order of the plurality of first sub-configurations or the second sub-configuration(s). The information bits of the CQI can be first based on the order of odd subband number and even subband number (for example, odd numbers preceding even numbers, or vice versa), then based on the order of the plurality of first sub-configurations or the second sub-configuration(s), and finally based on the order of odd subband number and the order of even subband number separately (e.g., in increasing or decreasing order).

The order of information bits related to PMI (e.g., wideband PMI and/or subband PMI) in the CSI can be based on at least one of the order of the plurality of first sub-configurations or the second sub-configuration(s), the order of subband number, the order of X₁ and X₂, the order of frequency domain granularities, and the order of odd subband number and even subband number. PMI parameters can include two parts, namely X₁ and X₂. It is assumed that the information bits of PMI are in one or a plurality of CSI fields. When the CSI includes one CSI field and the CSI field includes (one or more) subband PMIs of the plurality of first sub-configurations or (one or more) subband CQIs of the second sub-configuration(s), the order of subband PMIs (or, information bits of the subband CQIs) in the CSI field is based on the order of the plurality of first sub-configurations or the second sub-configuration(s) corresponding to the subband PMIs, and/or the order of subband number corresponding to the subband PMIs. The subband PMIs in the CSI field are first mapped based on the order of the plurality of first sub-configurations or the second sub-configuration(s) corresponding to the subband PMIs, and then based on the order of the subband number corresponding to the subband PMIs. The subband PMIs in the CSI field are first mapped based on the order of the subband number corresponding to the subband PMIs, and then based on the order of the plurality of first sub-configurations or the second sub-configuration(s) corresponding to the subband PMIs. When the CSI includes one CSI field and the CSI field includes wideband PMIs of the plurality of first sub-configurations (for example, X₁ of the wideband PMI and X₂ of the wideband PMI) or wideband PMIs of the second sub-configuration(s) (for example, X₁ of the wideband PMI and X₂ of the wideband PMI), the order of subband PMIs (or information bits of the subband PMIs) in the CSI field is based on the order of the plurality of first sub-configurations or the second sub-configuration(s) corresponding to the wideband PMIs, and/or the order of X₁ and X₂ corresponding to the wideband PMIs. The wideband PMIs in the CSI field are first mapped based on the order of the plurality of first sub-configurations or the second sub-configuration(s) corresponding to the wideband PMIs, and then based on the order of X₁ and X₂ corresponding to the wideband PMIs (e.g., X₁ preceding X₂, or vice versa). The wideband PMIs in the CSI field are first mapped based on the order of X₁ and X₂ corresponding to the wideband PMIs (e.g., X₁ preceding X₂, or vice versa), and then based on the order of the plurality of first sub-configurations or the second sub-configuration(s) corresponding to the wideband PMIs. The information bits of the PMI can be based on the order of the plurality of first sub-configurations or the second sub-configuration(s) and the order of frequency domain granularities such as wideband PMIs preceding subband PMIs, or vice versa. The information bits of the PMI can be first based on the order of the plurality of first sub-configurations or the second sub-configuration(s), and then based on the order of frequency domain granularities. The information bits of the PMI can be first based on the order of frequency domain granularities, and then based on the order of the plurality of first sub-configurations or the second sub-configuration(s). The information bits of the PMI can be determined based on the order of odd subband number and even subband number, the order of subband number corresponding to the PMI, the order of the plurality of first or second sub-configuration(s), and the order of frequency domain granularities. The information bits of the PMI can be firstly based on the order of odd subband number and even subband number (for example, odd numbers preceding even numbers, or vice versa), then based on the order of odd subband number and the order of even subband number separately (e.g., in increasing or decreasing order), and finally based on the order of the plurality of first sub-configurations or the second sub-configuration(s). The information bits of the PMI can be first based on the order of odd subband number and even subband number (for example, odd numbers preceding even numbers, or vice versa), then based on the order of the plurality of first sub-configurations or the second sub-configuration(s), and finally based on the order of odd subband number and the order of even subband number separately (e.g., in increasing or decreasing order).

The CSI or the single part CSI or the wideband CSI of the CSI part 2 (or the order of information bits corresponding to the CSI, or the information bits corresponding to the CSI) can be determined based on at least one of the following orders/methods, considering when the plurality of first sub-configurations or the second sub-configuration(s) include N sub-configurations:
First, based on the order of the N sub-configurations, then, based on the order of types of the CSI parameters and/or the order between the zero-padding bits and the CSI parameters in the CSI, then, based on the order of TBs corresponding to the CSI parameters and/or the order of an information field X₁ and an information field X₂ corresponding to PMI and/or the order of frequency domain granularities. The order of TBs corresponding to the CSI parameters can be the order of TBs corresponding to CQI. Each of the N sub-configurations can have the same priority (e.g., for determining whether to drop the CSI or not), so a feasible manner is to group together CSI with the same priority (e.g., “group together” indicates their corresponding information bits are adjacent). Ordering in this manner can facilitate the keep or drop of CSI with the same priority as a whole, thus increasing the flexibility and/or performance of the communication system;
First, based on the order of types of the CSI parameters and/or the order between the zero-padding bits and the CSI parameters in the CSI, then, based on the order of the N sub-configurations, then, based on the order of TBs corresponding to the CSI parameters and/or the order of an information field X₁ and an information field X₂ corresponding to PMI and/or the order of frequency domain granularities. The order of TBs corresponding to the CSI parameters can be the order of TBs corresponding to CQI, CSI corresponding to CSI parameters of the same type (or, CSI corresponding to the zero-padded bits) can have the same priority (e.g., for determining whether to drop the CSI or not), so a feasible manner is to group together CSI with the same priority (e.g., “group together” indicates their corresponding information bits are adjacent). Ordering in this manner can facilitate the keep or drop of CSI with the same priority as a whole, thus increasing the flexibility and/or performance of the communication system;
First, based on the order of types of the CSI parameters and/or the order between the zero-padding bits and the CSI parameters in the CSI, then, based on the order of TBs corresponding to the CSI parameters and/or the order of an information field X₁ and an information field X₂ corresponding to PMI and/or the order of frequency domain granularities, then, based on the order of the N sub-configurations. The order of TBs corresponding to the CSI parameters can be the order of TBs corresponding to CQI, CSI corresponding to CSI parameters of the same type (or, CSI corresponding to the zero-padded bits) can have the same priority (e.g., for determining whether to keep or drop the CSI), so a feasible manner is to group together CSI with the same priority (e.g., “group together” indicates their corresponding information bits are adjacent). Ordering in this manner can facilitate the keep or drop of CSI with the same priority as a whole, thereby increasing the flexibility and/or performance of the communication system.

The CSI or the CSI part 1 (or the order of information bits corresponding to the CSI, or the information bits corresponding to the CSI) can be determined based on at least one of the following orders/methods, considering when the plurality of first sub-configurations or the second sub-configuration(s) include N sub-configurations:
First, based on the order of the N sub-configurations, then, based on the order of types of the CSI parameters and/or the order between the zero-padding bits and the CSI parameters in the CSI, then, based on the order of frequency domain granularities, then, based on the order of subband number. CSI corresponding to CSI parameters of the same type (or, CSI corresponding to the zero-padded bits) can have the same priority (e.g., for determining whether to keep or drop the CSI), so a feasible manner is to group together CSI with the same priority (e.g., “group together” indicates their corresponding information bits are adjacent). Ordering in this manner can facilitate the keep or drop of CSI with the same priority as a whole, thus increasing the flexibility and/or performance of the communication system;
First, based on the order of types of the CSI parameters and/or the order between the zero-padding bits and the CSI parameters in the CSI, then, based on the order of the N sub-configurations, then, based on the order of frequency domain granularities, then, based on the order of subband number. CSI corresponding to CSI parameters of the same type (or, CSI corresponding to the zero-padded bits) can have the same priority (e.g., for determining whether to keep or drop the CSI), so a feasible manner is to group together CSI with the same priority (e.g., “group together” indicates their corresponding information bits are adjacent), ordering in this manner can facilitate the keep or drop of CSI with the same priority as a whole, thus increasing the flexibility and/or performance of the communication system;
First, based on the order of types of the CSI parameters and/or the order between the zero-padding bits and the CSI parameters in the CSI, then, based on the order of frequency domain granularities, then, based on the order of the N sub-configurations, then, based on the order of subband number. CSI corresponding to CSI parameters of the same type (or, CSI corresponding to the zero-padded bits) can have the same priority (e.g., for determining whether to keep or drop the CSI), so a feasible manner is to group together CSI with the same priority (e.g., “group together” indicates their corresponding information bits are adjacent), ordering in this manner can facilitate the keep or drop of CSI with the same priority as a whole, thus increasing the flexibility and/or performance of the communication system;
First, based on the order of types of the CSI parameters and/or the order between the zero-padding bits and the CSI parameters in the CSI, then, based on the order of frequency domain granularities, then, based on the order of subband number, then, based on the order of the N sub-configurations. CSI corresponding to CSI parameters of the same type (or, CSI corresponding to the zero-padded bits) can have the same priority (e.g., for determining whether to keep or drop the CSI), so a feasible manner is to group together CSI with the same priority (e.g., “group together” indicates their corresponding information bits are adjacent), ordering in this manner can facilitate the keep or drop of CSI with the same priority as a whole, thus increasing the flexibility and/or performance of the communication system.

CSI corresponding to odd subband number can have the same priority (e.g., for determining whether to drop CSI or not), and CSI corresponding to even subband number can have the same priority, so a feasible manner is to group together CSI with the same priority (e.g., “group together” indicates their corresponding information bits are adjacent); this approach can facilitate the keep or drop of CSI with the same priority as a whole, thus increasing the flexibility and/or performance of the communication system. Therefore, CSI can be mapped using the following method (for example, firstly based on the order of odd subband number and even subband number). The CSI or subband CSI of the CSI part 2 (or the order of information bits corresponding to the CSI, or the information bits corresponding to the CSI) can be determined based on at least one of the following orders/methods, considering when the plurality of first sub-configurations or the second sub-configuration(s) include N sub-configurations:
First, based on the order of odd subband number and even subband number; then based on the order of the N sub-configurations, then, based on the order of types of the CSI parameters and/or the order between the zero-padding bits and the CSI parameters in the CSI; then, based on the order of subband number;
First, based on the order of odd subband number and even subband number, then, based on the order of types of the CSI parameters and/or the order between the zero-padding bits and the CSI parameters in the CSI, then, based on the order of the N sub-configurations; then, based on the order of subband number; and
First, based on the order of odd subband number and even subband number, then, based on the order of types of the CSI parameters and/or the order between the zero-padding bits and the CSI parameters in the CSI, then, based on the order of subband number, then, based on the order of the N sub-configurations.

The positions of the order of types of the CSI parameters and/or the order between the zero-padding bits and the CSI parameters in the CSI, and the positions of the order of subband number can be interchanged.

The positions of the order of types of the CSI parameters and/or the order between the zero-padding bits and the CSI parameters in the CSI, the positions of the order of TBs corresponding to the CSI parameters and/or the order of an information field X₁ and an information field X₂ corresponding to PMI and/or the order of frequency domain granularities can be interchanged.

The positions of the order of types of the CSI parameters and/or the order between the zero-padding bits and the CSI parameters in the CSI, the positions of the order of frequency domain granularities, and the positions of the order of subband number can be interchanged.

The positions of the order of odd subband number and even subband number, the positions of the order of types of the CSI parameters and/or the order between the zero-padding bits and the CSI parameters in the CSI and the positions of the order of subband number can be interchanged.

The mapping method based on multiple orders mentioned above is to indicate the order between different types of orders. The absence of a particular order (e.g., if the reported CSI does not have the CSI with a particular type) does not affect the order between other types of orders or the determination of CSI based on other types of orders (or sequence).

The terminal device can determine the CSI based on the number of the plurality of first sub-configurations or the number of the first sub-configurations in the second sub-configuration. The terminal device can determine the number of parts in the CSI based on the number of the plurality of first sub-configurations or the number of the first sub-configurations in the second sub-configuration. This number can be either 1 or 2. When the number of parts in the CSI is 1, the CSI corresponds to/includes single part CSI. When the number of parts in the CSI is 2, the CSI corresponds to/includes two parts: CSI part 1 and CSI part 2. The CSI part 2 can include at least one of wideband CSI and subband CSI.

The number of parts in the CSI is based on the number of the plurality of first sub-configurations (e.g., L) or the number of the first sub-configurations in the second sub-configuration (e.g., N). When N or L is less than or equal to a specific value, the number of parts in the CSI is 1 (or the CSI corresponds to single part CSI). When N or L is greater than or equal to a specific value, the number of parts in the CSI is 2 (or the CSI corresponds to two CSI parts). Optionally, L corresponds to a periodic CSI report. N corresponds to a semi-persistent (or aperiodic) CSI report. This method is applicable to when a CSI report is carried on a PUCCH. This method is applicable to when the CSI corresponds to wideband CSI (or only corresponds to wideband CSI and/or does not correspond to subband CSI). This method is applicable to a periodic or semi-persistent CSI report. The specific value can be predefined. The specific value can be at least one of 1, 2, 3, 4, 5, 6, 7, or 8. The specific value can be based on UE capabilities (e.g., indicated by capability signaling reported by the UE). The specific value can be indicated by the base station in at least one of DCI, MAC-CE, or RRC signaling. Determining the number of parts in the CSI based on N or L can prevent a channel or signal carrying the CSI from exceeding the upper limit of carrying capacity, ensuring the reliability of the communication system. When N or L is less than or equal to the specific value, using single part CSI can simplify the generation and detection of CSI due to a small CSI payload, reducing the complexity of the communication system. When N or L is greater than or equal to the specific value, due to a large CSI payload, using single part CSI may exceed an upper limit of the corresponding channel/signal carrying capacity in terms of bits. Thus, it is necessary to generate two CSI parts, where the CSI part 2 can be kept or drop according to the channel/signal carrying capacity (e.g., reporting only important information), thus improving the reliability of CSI transmission.

For the CSI determined by the terminal device, the CSI can include/be associated with/correspond to one or multiple parts. The one or more parts can be single part CSI. The one or more parts can be the CSI part 1 or the CSI part 2. The one or more parts can be the CSI part 1, subband CSI of the CSI part 2, and wideband CSI of the CSI part 2. The method for determining the order of CSI described in Embodiment 1 is applicable to one part (or each part) among the one or more parts that the CSI includes/corresponds to/is associated with.

Below are examples that further illustrate the order of the CSI parameters (or CSI fields, or CSI fields corresponding to the CSI parameters) and/or zero-padding bits in the CSI in different scenarios/conditions.

### Example 1

If condition A is satisfied, the CSI corresponds to a CSI part, and/or the CSI is based on the order of the plurality of first sub-configurations or the order of the second sub-configuration(s) and/or the order of the CSI parameters and/or the zero-padding bits corresponding to the CSI reporting configuration information. The condition A refers to at least one of CSI corresponding to wideband frequency domain granularity, CSI being configured on PUCCH or PUSCH, and the number of the plurality of first sub-configurations or the number of the second sub-configuration(s) being less than or equal to a specific value.

For a CSI report (e.g., corresponding to the CSI reporting configuration information), if condition A is satisfied, the CSI report corresponds to a CSI part, and/or the order of CSI in the CSI report (or the order of CSI fields) is based on the order of the plurality of first sub-configurations or the order of the second sub-configuration(s) and/or the order of the CSI parameters and/or the zero-padding bits corresponding to the CSI reporting configuration information. Condition A may refer to at least one of the following:

The CSI report has/is configured with one or more first sub-configurations. For example, one or more first sub-configurations with which the CSI reporting configuration information corresponding to the CSI report is included or is associated.

The CSI corresponds to wideband frequency domain granularity. The CSI report corresponds to the wideband frequency domain granularity. A PMI format indication parameter (pmi-FormatIndicator) in the CSI reporting configuration information is set to “widebandPMI” and/or a CQI format indication parameter (cqi-FormatIndicator) in the CSI reporting configuration information is set to “widebandCQI”. Alternatively, a report quantity parameter (reportQuantity) in the CSI reporting configuration information is set to “cri-RI-CQI” and/or the CQI format indication parameter (cqi-FormatIndicator) in the CSI reporting configuration information is set to “widebandCQI”.

The CSI corresponds to wideband frequency domain granularity. (At least one/each/all) sub-configurations in the one or more first sub-configurations or the second sub-configuration(s) all correspond to the wideband frequency domain granularity. A PMI format indication parameter (pmi-FormatIndicator) of the sub-configuration(s) is/are set to “widebandPMI” and/or a CQI format indication parameter (cqi-FormatIndicator) in the CSI reporting configuration information is set to “widebandCQI”. Alternatively, A report quantity parameter (reportQuantity) of the sub-configuration(s) is/are set to “cri-RI-CQI” and/or the CQI format indication parameter (cqi-FormatIndicator) in the CSI reporting configuration information is set to “widebandCQI”.

The number of the plurality of first sub-configurations or the number of the second sub-configuration(s) is less than or equal to a specific value. The specific value can be predefined, for example, one of 1, 2, 3, 4, 5, 6, 7, or 8. The specific value can be based on UE capabilities. The specific value is indicated by the reported UE capability signaling. The specific value can be indicated by the base station. The specific value is configured by radio resource control (RRC) signaling. The specific value is indicated by MAC-CE signaling. The specific value is indicated by DCI signaling. This approach can specify that when the number of the one or more first sub-configurations or the second sub-configuration(s) satisfies specific requirements, the CSI corresponds to one part. Using a single part CSI simplifies the generation and detection of CSI, reducing the complexity of the communication system.

The number of the plurality of first sub-configurations or the number of the second sub-configuration(s) is greater than or equal to a specific value. The specific value can be predefined, for example, one of 1, 2, 3, 4, 5, 6, 7, or 8. The specific value can be based on UE capabilities. The specific value is indicated by the reported UE capability signaling or by the base station. The specific value is configured by RRC signaling or is indicated by MAC-CE or DCI signaling.

The CSI corresponds to one CSI part. One (or at least one/each/all) sub-configuration from the one or more first sub-configurations or from the second sub-configuration(s) (all) corresponds to one CSI part.

The CSI is configured on PUCCH (for transmission). A reporting configuration type parameter (reportConfigType) in the CSI reporting configuration information corresponding to the CSI is set to “periodic” or “semiPersistentOnPUCCH”. The CSI can be transmitted on PUCCH. A format corresponding to PUCCH is PUCCH format 2, PUCCH format 3, or PUCCH format 4.

The CSI is configured on PUSCH (for transmission). A reporting configuration type parameter (reportConfigType) in the CSI reporting configuration information corresponding to the CSI is set to “aperiodic” or “semiPersistentOnPUSCH”. The CSI can be transmitted on a PUSCH.

The CSI report includes/corresponds to one CSI part. The number of CSI parts included in the CSI report is 1. The CSI can include at least one of CRI, RI, LI, zero-padding bits, PMI, or CQI. PMI can include wideband PMI and/or subband PMI. PMI can include X₁ and/or X₂ (X₁ and X₂ will be described below). CQI can include wideband CQI and/or subband CQI or (wideband) CQI for the first TB and/or (wideband) CQI for the second TB. TB can also be referred to as a codeword or correspond to a codeword.

The payload sizes corresponding to CSI are the same/fixed. Optionally, regardless of the RI (if reported) and/or CRI (if reported), the payload sizes corresponding to CSI are the same/fixed. For example, by the zero-padding bits, CSI payloads have the same size/bitwidth (total bit number) for different reported RIs and/or reported CRIs.

The order of the CSI (or CSI fields) of the CSI report can be based on at least one of the following methods.

### Method 1

Table 1 below shows the order of the CSI report (or fields of CSI parameters in the CSI report) or the mapping order of the CSI fields. The content of the CSI report may be configured to be transmitted on PUCCH. The order of the CSI fields in the CSI report can be from upper part to lower part (or from lower part to upper part) as indicated in Table 1. The PMI format indication parameter (pmi-FormatIndicator) in the CSI reporting configuration information corresponding to the CSI report is set to “widebandPMI” and/or the CQI format indication parameter (cqi-FormatIndicator) in the CSI reporting configuration information is set to “widebandCQI”. The report quantity parameter (reportQuantity) in the CSI reporting configuration information corresponding to the CSI report is set to “cri-RI-CQI” and/or the CQI format indication parameter (cqi-Formatlndicator) in the CSI reporting configuration information is set to “widebandCQI”.

TABLE 1

| | CSI field |
|---|---|
| CSI | CRI of sub-configuration #1 (if reported) |
| report | RI of sub-configuration #1 (if reported) |
| | LI of sub-configuration #1 (if reported) |
| | Zero-padding bits of sub-configuration #1 (if reported) |
| | PMI wideband information field (corresponding with) X₁ of sub- |
| | configuration #1 (if reported) |
| | PMI wideband information field (corresponding with) X₂ of sub- |
| | configuration #1 (if reported) |
| | Wideband CQI for first TB of sub-configuration #1 (if reported) |
| | Wideband CQI for second TB of sub-configuration #1 (if reported) |
| | CRI of sub-configuration #2 (if reported) |
| | RI of sub-configuration #2 (if reported) |
| | LI of sub-configuration #2 (if reported) |
| | Zero-padding bits of sub-configuration #2 (if reported) |
| | PMI wideband information field (corresponding with) X₁ of sub- |
| | configuration #2 (if reported) |
| | PMI wideband information field (corresponding with) X₂ of sub- |
| | configuration #2 (if reported) |
| | Wideband CQI for first TB of sub-configuration #2 (if reported) |
| | Wideband CQI for second TB of sub-configuration #2 (if reported) |
| | . . . |
| | CRI of sub-configuration #i (if reported) |
| | RI of sub-configuration #i (if reported) |
| | LI of sub-configuration #i (if reported) |
| | Zero-padding bits of sub-configuration #i (if reported) |
| | PMI wideband information field (corresponding with) X₁ of sub- |
| | configuration #i (if reported) |
| | PMI wideband information field (corresponding with) X₂ of sub- |
| | configuration #i (if reported) |
| | Wideband CQI for first TB of sub-configuration #i (if reported) |
| | Wideband CQI for second TB of sub-configuration #i (if reported) |

In Table 1, “if reported” indicates that a specific CSI field may be present (or be reported) or may not be present (or not be reported).

In Table 1, CRI/RI/LI/CQI is determined based on Tables 16 and/or 17. PMI is determined based on Tables 14 and/or 15 (from left to right). The PMI wideband information fields X₁ is determined based on Tables 14 and/or 15 (from left to right) or based on codebook index used for 2 antenna ports. The PMI wideband information fields X₂ is determined based on Tables 14 and/or 15 (from left to right) or based on codebook index used for 2 antenna ports.

In Table 1, sub-configuration #1, sub-configuration #2, . . . , sub-configuration #i of the CSI report correspond to the plurality of first sub-configurations (sub-configuration #1, sub-configuration #2, . . . , sub-configuration #L) of the CSI report (in order) or correspond to the second sub-configuration(s) (sub-configuration #1, sub-configuration #2, . . . , sub-configuration #N) of the CSI report (in order). The order of the plurality of first sub-configurations and the order of the second sub-configuration(s) can be referred to the previous description (e.g., the order of IDs, the position in the configuration information, the order of priorities).

The calculation method for zero-padding bits of a sub-configuration is as follows. Taking sub-configuration #i as an example, the zero-padding bits of the sub-configuration #i are calculated/determined based on ranks that are allowed to be reported and/or reported ranks for the sub-configuration #i. The ranks that are allowed to be reported (or rank values) are determined based on a rank restriction parameter in the CSI reporting configuration information (corresponding to the sub-configuration #i), or the ranks that are allowed to be reported are determined based on a rank restriction parameter that the sub-configuration #i indicates/configures/includes or is associated with.

Taking sub-configuration #i as an example, the zero-padding bits of the sub-configuration #i are determined based on the number of CSI-RS ports corresponding to the sub-configuration #i. The number of the CSI-RS ports can be determined based on a port parameter that the sub-configuration #i includes/is associated with/corresponds to, or the number of the CSI-RS ports can be determined based on ports of a CSI-RS resource (used for channel measurement)associated with the CSI reporting configuration information corresponding to the sub-configuration #i. When the port parameter is configured by the sub-configuration #i, the number of the CSI-RS ports for the sub-configuration #i is determined based on the port parameter. When the port parameter is not configured by the sub-configuration #i, the number of the CSI-RS ports for the sub-configuration #i is determined based on ports (e.g., all ports) of a CSI-RS resource (used for channel measurement) associated with the CSI reporting configuration information corresponding to the sub-configuration.

For example, for sub-configuration #j (where j is an integer and 1<j<i), the zero-padding bits of the sub-configuration #j can be determined as follows.

When the number of CSI-RS ports is 1, or when the number of CSI-RS ports corresponding to the sub-configuration #j is 1, the number of zero-padding bits of the sub-configuration #j is 0. When the number of CSI-RS ports is greater than 1, or when the number of CSI-RS ports corresponding to the sub-configuration #j is greater than 1, the number of zero-padding bits of the sub-configuration #j is

$${0}_{j} = {N}_{max , j} - {N}_{report , j} \cdot {N}_{max , j} = {max}_{{r}_{j} ϵ {S}_{Rank , j}} B ( {r}_{j} ) ,$$

where N_{max,j} represents the maximum bitwidth corresponding to PMI, CQI, LI for the sub-configuration #j, and S_{Rank,j} represents a set of rank value(s) for sub-configurations #j (rⱼ). The rank value (rⱼ) refers to rank value(s) that is allowed to be reported. For example, if the sub-configuration #j corresponds to, is associated with, or includes a rank restriction parameter, the rank value (rⱼ) corresponds to/is associated with one of the rank(s) that are allowed to be reported indicated by the rank restriction parameter. N_{report,j}=B(Rⱼ), where Rⱼ represents a reported rank (or rank included/reported in the CSI) corresponding to the sub-configuration #j. B(rⱼ) can be the bitwidth corresponding to the PMI parameter, the CQI parameter, the LI parameter for the sub-configuration #j when the rank is rⱼ. B(Rⱼ) can be the bitwidth corresponding to the PMI parameter, the CQI parameter, the LI parameter for the sub-configuration #j in a case that the rank is Rⱼ.

When the number of CSI-RS ports is 2, or when the number of CSI-RS ports corresponding to the sub-configuration #j is 2, B(rⱼ)=N_{PMI,j}(rⱼ)+N_{CQI,j}(rⱼ)+N_{LI,j}(rⱼ). N_{PMI,j}(rⱼ) can be the bitwidth corresponding to the PMI parameter for the sub-configuration #j in a case that the rank is rⱼ. N_{CQI,j}(rⱼ) can be the bitwidth corresponding to the CQI parameter for the sub-configuration #j in a case that the rank is rⱼ. N_{LI,j}(rⱼ) can be the bitwidth corresponding to the LI parameter for the sub-configuration #j in a case that the rank is rⱼ.

When the number of CSI-RS ports is greater than 2, or when the number of CSI-RS ports corresponding to the sub-configuration #j is greater than 2, B(rⱼ)=N_{PMI,i1,j}(rⱼ)+N_{PMI,i2,j}(rⱼ)+N_{CQI,j}(rⱼ)+N_{LI,j}(rⱼ). N_{PMI,i1,j}(rⱼ) can be the bitwidth corresponding to the i1 parameter (i1 corresponding to/associated with PMI) for the sub-configuration #j in a case that the rank is rⱼ. N_{PMI,i2,j}(rⱼ) can be the bitwidth corresponding to the i2 parameter (i2 corresponding to/associated with PMI) for the sub-configuration #j in a case that the rank is rⱼ.

If PMI is reported, or if PMI corresponding to the sub-configuration #j is reported, N_{PMI,j}(1)=2 and/or N_{PMI,j}(1)=2; otherwise, N_{PMI,j}(rⱼ)=0.

If i1 (or i1 corresponding to/associated with PMI) is reported, or if i1 corresponding to the sub-configuration #j (or i1 corresponding to/associated with PMI) is reported, N_{PMI,i1,j}(rⱼ) can be determined based on Tables 14 or 15; otherwise, N_{PMI,i1,j}(rⱼ)=0.

If i2 (or i2 corresponding to/associated with PMI) is reported, or if i2 corresponding to the sub-configuration #j (or i2 corresponding to/associated with PMI) is reported, N_{PMI,i2,j}(rⱼ) can be determined based on Table 14 or 15; otherwise, N_{PMI,i2,j}(rⱼ)=0.

If CQI is reported, or if CQI corresponding to the sub-configuration #j is reported, N_{CQI,j}(rⱼ) can be determined based on Table 16 or 17; otherwise, N_{CQI,j}(rⱼ)=0.

If LI is reported, or if LI corresponding to the sub-configuration #j is reported, N_{LI,j}(rⱼ) can be determined based on Table 16 or 17; otherwise, N_{LI,j}(rⱼ)=0.

### Method 2

Table 2 shows the order of the CSI report (or fields of CSI parameters in the CSI report) or the mapping order of the CSI fields. The content of the CSI report may be configured to be transmitted on PUCCH. The order of the CSI fields in the CSI report can be from upper part to lower part (or from lower part to upper part) as indicated in Table 2. The PMI format indication parameter (pmi-Formatundicator) in the CSI reporting configuration information corresponding to the CSI report is set to “widebandPMI” and/or the CQI format indication parameter (cqi-FormatIndicator) in the CSI reporting configuration information is set to “widebandCQI”. The report quantity parameter (reportQuantity) in the CSI reporting configuration information corresponding to the CSI report is set to “cri-RI-CQI” and/or the CQI format indication parameter (cqi-Formatlndicator) in the CSI reporting configuration information is set to “widebandCQI”.

TABLE 2

| | CSI field |
|---|---|
| CSI | CRI of sub-configuration #1, sub-configuration #2, . . . , sub- |
| report | configuration #i (if reported) |
| | RI of sub-configuration #1, sub-configuration #2, . . . , sub- |
| | configuration #i (if reported) |
| | LI of sub-configuration #1, sub-configuration #2, . . . , sub- |
| | configuration #i (if reported) |
| | Zero-padding bits (if reported), or zero-padding bits corresponding |
| | to sub-configuration #1, sub-configuration #2, . . . , sub- |
| | configuration #i (if reported) |
| | Wideband PMI of sub-configuration #1, sub-configuration |
| | #2, . . . , sub-configuration #i (if reported) |
| | Wideband CQI for first TBs of sub-configuration #1, sub- |
| | configuration #2, . . . , sub-configuration #i (if reported) |
| | Wideband CQI for second TBs of sub-configuration #1, sub- |
| | configuration #2, . . . , sub-configuration #i (if reported) |

In Table 2, “if reported” indicates that a specific CSI field may be present (or be reported) or may not be present (or not be reported). For a CSI field, “if reported” can indicate that CSI parameters (for example, CRI, RI, LI, CQI, PMI, X₁ corresponding to PMI, X₂ corresponding to PMI) or zero-padding bits corresponding to each sub-configuration may or may not be present (separately).

In Table 2, taking PMI as an example of the CSI parameters, the PMIs of sub-configuration #1, sub-configuration #2, . . . , sub-configuration #i can share one CSI field (as described in Table 2), or the PMIs of sub-configuration #1, sub-configuration #2, . . . , sub-configuration #i can correspond to separate CSI fields. The PMIs of sub-configuration #1, sub-configuration #2, . . . sub-configuration #i are in one-to-one correspondence with i CSI fields.

The ordering method of information bits in the corresponding CSI fields of sub-configuration #1, sub-configuration #2, . . . , sub-configuration #i will be illustrated by taking “CRIs of sub-configuration #1, sub-configuration #2, . . . , sub-configuration #i” as an example. The order of information bits in “CRIs of sub-configuration #1, sub-configuration #2, . . . , sub-configuration #i” is based on the (indexed) increasing or decreasing order of sub-configuration #1, sub-configuration #2, . . . , sub-configuration #i. The order may be (information bits corresponding to) CRI corresponding to sub-configuration #1, (information bits corresponding to) CRI corresponding to sub-configuration #2, . . . , (information bits corresponding to) CRI corresponding to sub-configuration #i.

PMI parameters can include X₁ and X₂.

As shown in Table 2, a PMI field (wideband PMIs of sub-configuration #1, sub-configuration #2, . . . , sub-configuration #i) occupies one CSI field, and the order of information bits in the CSI field can be based on the order of the sub-configurations (sub-configuration #1, sub-configuration #2, . . . , sub-configuration #i), and/or based on the order of X₁ and X₂. The order of information bits corresponding to PMI fields/PMIs can be first based on the order of the sub-configurations (sub-configuration #1, sub-configuration #2, . . . , sub-configuration #i), and then based on the order of X₁ and X₂. Or, the order of the PMI fields can be first based on the order of X₁ and X₂ (e.g., X₁ preceding X₂; or, X₂ preceding X₁), and then based on the order of the sub-configurations (sub-configuration #1, sub-configuration #2, . . . , sub-configuration #i).

In Table 2, the PMI field (wideband PMIs of sub-configuration #1, sub-configuration #2, . . . , sub-configuration #i) can be further divided into 2*i fields, and X₁ corresponding to the PMI of each sub-configuration and X₂ corresponding to the PMI of each sub-configuration each correspond to a CSI field. The order of the 2*i fields can be first based on the order of the sub-configurations (sub-configuration #1, sub-configuration #2, . . . , sub-configuration #i), and then based on the order of X₁ and X₂. Or, the order of the 2*i fields can be first based on the order of X₁ and X₂ (e.g., X₁ preceding X₂; or, X₂ preceding X₁), and then based on the order of the sub-configurations (sub-configuration #1, sub-configuration #2, . . . , sub-configuration #i).

In Table 2, PMI parameters share a CSI field (as described in Table 2) or may correspond to two fields. A first field is X₁ corresponding to PMIs of sub-configuration #1, sub-configuration #2, . . . , and sub-configuration #i. A second field is X₂ corresponding to PMIs of sub-configuration #1, sub-configuration #2, . . . , and sub-configuration #i. The first field precedes the second field, or the second field precedes the first field.

In Table 2, the CQI parameter is illustrated by taking two CSI fields as an example, where information bits of CQI are firstly based on the order of TBs and then based on the order of the sub-configurations. The order of the information bits of CQI can also be based on the order of the sub-configurations first, and then based on the order of TBs. In Table 2, the order of information bits of the CSI parameters (such as CRI, RI, LI, CQI, PMI, X₁ corresponding to PMI, X₂ corresponding to PMI) in one (or each) CSI field is based on the order of sub-configuration #1, sub-configuration #2, . . . , sub-configuration #i.

In Table 2, CRI/RI/LI/CQI is determined based on Tables 16 and/or 17. PMI is determined based on Tables 14 and/or 15 (from left to right). The PMI wideband information field X₁ is determined based on Tables 14 and/or 15 (from left to right) or based on codebook index used for 2 antenna ports. The PMI wideband information field X₂ is determined based on Tables 14 and/or 15 (from left to right) or based on codebook index used for 2 antenna ports.

In Table 2, sub-configuration #1, sub-configuration #2, . . . , sub-configuration #i of the CSI report correspond (in order) to either the plurality of first sub-configurations (sub-configuration #1, sub-configuration #2, . . . , sub-configuration #L) of the CSI report or to the second sub-configuration(s) (sub-configuration #1, sub-configuration #2, . . . , sub-configuration #N) of the CSI report. The order of the plurality of first sub-configurations and the order of the second sub-configuration(s) can be referred to the previous description (e.g., the order of IDs, the position in the configuration information, the order of priorities).

Here, the method for determining the number of zero-padding bits of sub-configuration #1, sub-configuration #2, . . . , and sub-configuration #i can be referred to Method 1.

The method for determining the (number of) zero-padding bits is as follows. The zero-padding bits can be determined based on the CSI parameters of sub-configuration #1, sub-configuration #2, . . . and sub-configuration #i. The CSI parameters can be at least one of PMI, LI, CQI and RI.

The number of the zero-padding bits can be Σⱼ₌₁ⁱOⱼ=Σⱼ₌₁ⁱ(N_{max,j}−N_{report,j}). The definition of each parameter in the formula is provided in Method 1.

### Example 2

If condition B is satisfied, the CSI corresponds to two CSI parts, and/or the CSI (CSI part 1 of the CSI) is at least based on the order of the plurality of first sub-configurations or the order of the second sub-configuration(s) and/or the order of the CSI parameters and/or the zero-padding bits corresponding to the CSI reporting configuration information; The condition B refers to at least one of CSI corresponding to subband frequency domain granularity, CSI being configured on PUCCH or PUSCH, and the number of the plurality of first sub-configurations or the number of the second sub-configuration(s) being greater than or equal to a specific value.

For a CSI report (e.g., corresponding to the CSI reporting configuration information), if the CSI report satisfies condition B, the CSI report corresponds to two CSI parts, and/or the order of CSI (e.g., the CSI part 1) in the CSI report (or the order of CSI fields of the CSI part 1) is based on the order of the plurality of first sub-configurations or the order of the second sub-configuration(s) and/or the order of the CSI parameters and/or the zero-padding bits corresponding to the CSI reporting configuration information. The condition B refers to at least one of the following:

The CSI report has/is configured with one or more first sub-configurations. For example, one or more first sub-configurations with which the CSI reporting configuration information corresponding to the CSI report is included or is associated.

The CSI corresponds to wideband frequency domain granularity. The CSI report corresponds to the wideband frequency domain granularity. A PMI format indication parameter (pmi-FormatIndicator) in the CSI reporting configuration information is set to “widebandPMI” and/or a CQI format indication parameter (cqi-FormatIndicator) in the CSI reporting configuration information is set to “widebandCQI”. Alternatively, a report quantity parameter (reportQuantity) in the CSI reporting configuration information is set to “cri-RI-CQI” and/or the CQI format indication parameter (cqi-FormatIndicator) in the CSI reporting configuration information is set to “widebandCQI”.

The CSI corresponds to wideband frequency domain granularity. One (or at least one/each/all) sub-configuration in the one or more first sub-configurations or the second sub-configuration(s) corresponds to the wideband frequency domain granularity. A PMI format indication parameter (pmi-FormatIndicator) of the sub-configuration(s) is/are set to “widebandPMI” and/or a CQI format indication parameter (cqi-FormatIndicator) in the CSI reporting configuration information is set to “widebandCQI”. Alternatively, a report quantity parameter (reportQuantity) of the sub-configuration(s) is/are set to “cri-RI-CQI” and/or the CQI format indication parameter (cqi-FormatIndicator) in the CSI reporting configuration information is set to “widebandCQI”.

The number of the plurality of first sub-configurations or the number of the second sub-configuration(s) is greater than or equal to a specific value. The specific value can be predefined, for example, one of 1, 2, 3, 4, 5, 6, 7, or 8. The specific value can be based on UE capabilities. The specific value is indicated by the reported UE capability signaling. The specific value can be indicated by the base station. The specific value is configured by RRC signaling. The specific value is indicated by MAC-CE signaling. The specific value is indicated by DCI signaling. This approach helps the terminal device determine when it can use CSI consisting of two parts. When the number of the plurality of first sub-configurations or the second sub-configuration(s) increases (or exceeds a specific value), the number of information bits corresponding to the CSI increases, resulting in higher code rates. However, transmitting all the CSI can lead to decreased reliability. In such cases, the CSI is divided into two parts, and the CSI part 2 can be dropped to reduce the number of transmitted information bits, lower the code rate, and improve transmission reliability. The number of the plurality of first sub-configurations or the number of the second sub-configuration(s) is less than or equal to a specific value. The specific value can be predefined, for example, one of 1, 2, 3, 4, 5, 6, 7, or 8. The specific value can be based on UE capabilities. The specific value is indicated by the reported UE capability signaling. The specific value can be indicated by the base station. The specific value is configured by RRC signaling or is indicated by MAC-CE or DCI signaling.

The CSI corresponds to two CSI parts. The two CSI parts are a CSI part 1 and a CSI part 2. One (or at least one/each/all) sub-configuration from the one or more first sub-configurations or from the second sub-configuration(s) (all) corresponds to two CSI parts.

The CSI corresponds to the CSI part 1. The ordering rules of CSI are applicable to the CSI part 1.

The CSI is configured on PUCCH (for transmission). A reporting configuration type parameter (reportConfigType) in the CSI reporting configuration information corresponding to the CSI is set to “periodic” or “semiPersistentOnPUCCH”. The CSI can be transmitted on PUCCH (such as PUCCH format 3 or PUCCH format 4).

The CSI is configured on PUSCH (for transmission). A reporting configuration type parameter (reportConfigType) in the CSI reporting configuration information corresponding to the CSI is set to “aperiodic” or “semiPersistentOnPUSCH”. The CSI can be transmitted on a PUSCH.

The CSI report includes/corresponds to two CSI parts. The CSI report includes a CSI part 1 and a CSI part 2. The CSI part 1 includes at least one of RI, CRI, CQI, and zero-padding bits. The CQI can include wideband CQI and/or subband CQI. The CQI can be the CQI for the first TB. The CSI part 2 includes at least one of CQI, RI, LI, and PMI. The CQI can be the CQI for the second TB. TB can also be referred to as codeword. PMI can include wideband PMI and/or subband PMI and can include X₁ and/or X₂ (refer below for the description of X₁ and X₂).

The payload sizes corresponding to the CSI part 1 are the same/fixed. Alternatively, regardless of the RI (if reported) and/or CRI (if reported), the payload sizes corresponding to CSI are the same/fixed. For example, by the zero-padding bits, CSI payloads have the same size/bitwidth (total bit number) for different reported RIs and/or reported CRIs. The CSI part 1 is used to determine the number of information bits of the CSI part 2. CSI part 1 may be transmitted in its entirety before CSI part 2.

The order of the CSI (or CSI fields) of the CSI report in the CSI part 1 can be based on at least one of the following methods.

### Method 3

Table 3 shows the order of the CSI part 1 of the CSI report (or fields of CSI parameters in the CSI part 1 of the CSI report) or the mapping order of the CSI fields. The content of the CSI report may be configured to be transmitted on PUCCH. The order of the CSI fields in the CSI part 1 of the CSI report can be from upper part to the lower part (or from lower part to upper part) as indicated in Table 3. The PMI format indication parameter (pmi-FormatIndicator) in the CSI reporting configuration information corresponding to the CSI report is set to “widebandPMI” and/or the CQI format indication parameter (cqi-FormatIndicator) in the CSI reporting configuration information is set to “widebandCQI”. The report quantity parameter (reportQuantity) in the CSI reporting configuration information corresponding to the CSI report is set to “cri-RI-CQI” and/or the CQI format indication parameter (cqi-FormatIndicator) in the CSI reporting configuration information is set to “widebandCQI”.

TABLE 3

| | CSI field |
|---|---|
| CSI | CRI of sub-configuration #1 (if reported) |
| part 1 | RI of sub-configuration #1 (if reported) |
| of CSI | Wideband CQI for first TB of sub-configuration #1 (if reported) |
| report | Subband CQI for first TB of sub-configuration #1 (if reported) |
| | CRI of sub-configuration #2 (if reported) |
| | RI of sub-configuration #2 (if reported) |
| | Wideband CQI for first TB of sub-configuration #2 (if reported) |
| | Subband CQI for first TB of sub-configuration #2 (if reported) |
| | . . . |
| | CRI of sub-configuration #i (if reported) |
| | RI of sub-configuration #i (if reported) |
| | Wideband CQI for first TB of sub-configuration #i (if reported) |
| | Subband CQI for first TB of sub-configuration #i (if reported) |

In Table 3, “if reported” indicates that a specific CSI field may or may not be present or reported.

CRI/RI/CQI may be determined based on Tables 16 and/or 17.

In Table 3, subband CQI can be subband differential CQI. This CQI is based on wideband CQI and represented via differential indicators. The subband CQI for the first TB of the sub-configuration #1 can include/correspond to/be associated with one or more subband CQIs. The one or more CQIs correspond to one or more subbands. In a field including the subband CQI for the first TB of the sub-configuration #1, the order of CQIs is based on the increasing/decreasing order of subband number corresponding to the CQIs. Similarly, in a field including the subband CQI for the first TB of the sub-configuration #2, the order of CQIs is based on the increasing/decreasing order of subband number corresponding to the CQIs, and so on.

In Table 3, subband(s) of the CSI report is indicated by a higher layer parameter csi-ReportingBand (in the corresponding CSI reporting configuration information). These subband(s) are numbered continuously in the increasing order with the lowest subband of csi-ReportingBand as subband 0.

In Table 3, sub-configuration #1, sub-configuration #2, . . . , sub-configuration #i of the CSI report correspond to the plurality of first sub-configurations (sub-configuration #1, sub-configuration #2, . . . , sub-configuration #L) of the CSI report (in order) or correspond to the second sub-configuration(s) (sub-configuration #1, sub-configuration #2, . . . , sub-configuration #N) of the CSI report (in order). The order of the plurality of first sub-configurations and the order of the second sub-configuration(s) can be referred to the previous description (e.g., the order of IDs, the position in the configuration information, the order of priorities).

### Method 4

Table 4 for the order of the CSI part 1 of the CSI report (or fields of CSI parameters in the CSI part 1 of the CSI report) or the mapping order of the CSI fields. The content of the CSI report may be configured to be transmitted on PUCCH. The order of the CSI fields in the CSI part 1 of the CSI report can be from upper part to lower part (or from lower part to upper part) as indicated in Table 4. The PMI format indication parameter (pmi-FormatIndicator) in the CSI reporting configuration information corresponding to the CSI report is set to “widebandPMI” and/or the CQI format indication parameter (cqi-FormatIndicator) in the CSI reporting configuration information is set to “widebandCQI”. The report quantity parameter (reportQuantity) in the CSI reporting configuration information corresponding to the CSI report is set to “cri-RI-CQI” and/or the CQI format indication parameter (cqi-FormatIndicator) in the CSI reporting configuration information is set to “widebandCQI”.

TABLE 4

| | CSI field |
|---|---|
| CSI | CRI of sub-configuration #1, sub-configuration #2, . . . , sub- |
| part 1 | configuration #i (if reported) |
| of CSI | RI of sub-configuration #1, sub-configuration #2, . . . , sub- |
| report | configuration #i (if reported) |
| | Wideband CQI for first TBs of sub-configuration #1, sub- |
| | configuration #2, . . . , sub-configuration #i (if reported) |
| | Subband CQI for first TBs of sub-configuration #1, sub- |
| | configuration #2, . . . , sub-configuration #i (if reported) |

In Table 4, “if reported” indicates that a specific CSI field may be present (or be reported) or may not be present (or not be reported). For a CSI field, “if reported” can indicate that CSI parameters (for example, CRI/RI/CQI) corresponding to each sub-configuration may or may not be present (separately).

In Table 4, taking CRI as an example of the CSI parameters, the CRIs of sub-configuration #1, sub-configuration #2, . . . , sub-configuration #i can share one CSI field as described in Table 2, or the CRIs of sub-configuration #1, sub-configuration #2, . . . , sub-configuration #i can correspond to separate CSI fields. The CRIs of sub-configuration #1, sub-configuration #2, . . . , sub-configuration #i are in one-to-one correspondence with the i CSI fields.

In Table 4, the order of information bits of CSI parameters (e.g., CRI/RI/CQI) in one (or each) CSI field can be based on the order of sub-configuration #1, sub-configuration #2, . . . , sub-configuration #i.

The ordering method of information bits in the corresponding CSI fields of sub-configuration #1, sub-configuration #2, . . . , sub-configuration #i will be illustrated by taking “CRIs of sub-configuration #1, sub-configuration #2, . . . , sub-configuration #i” as an example. The order of information bits in “CRIs of sub-configuration #1, sub-configuration #2, . . . , sub-configuration #i” is based on the (indexed) increasing or decreasing order of sub-configuration #1, sub-configuration #2, . . . , sub-configuration #i. The order is: (information bits corresponding to) CRI corresponding to sub-configuration #1, (information bits corresponding to) CRI corresponding to sub-configuration #2, . . . , (information bits corresponding to) CRI corresponding to sub-configuration #i.

In Table 4, for a CSI field including the subband CQI for the first TBs of sub-configuration #1, sub-configuration #2, . . . , sub-configuration #i, the order of information bits in this CSI field is based on the order of subband number corresponding to the subband CQI for the first TBs (e.g., increasing or decreasing order) and the order of sub-configurations corresponding to the subband CQI for the first TBs (e.g., increasing or decreasing order). The information bits in the CSI field (e.g., information bits of subband CQIs) are first mapped based on the order of subband number corresponding to the subband CQIs, and then based on the order of sub-configuration #1, sub-configuration #2, . . . , sub-configuration #i. For example, CQI {sub-configuration #1, subband #0}, CQI {sub-configuration #2, subband #0}, . . . , CQI {sub-configuration #i, subband #0}, CQI {sub-configuration #i, subband #1}, . . . , CQI {sub-configuration #i, subband #max}. The information bits in the CSI field (e.g., information bits of subband CQIs) are first mapped based on the order of sub-configuration #1, sub-configuration #2, . . . , sub-configuration #i, and then based on the order of subband number corresponding to the subband CQIs. For example, CQI {sub-configuration #1, subband #0}, CQI {sub-configuration #1, subband #1}, . . . , CQI {sub-configuration #1, subband #max}, CQI {sub-configuration #2, subband #0}, . . . , CQI {sub-configuration #i, subband #max}. Here, subband #max represents the maximum index number of subbands (or the maximum value of the index). The description of subbands and subband number is explained in Method 1.

The information bits corresponding to the CQIs can be based on the order of sub-configurations and the order of frequency domain granularities. For example, in Table 4, the information bits corresponding to the CQIs are first based on the order of frequency domain granularities, and then based on the order of sub-configurations. The information bits corresponding to the CQIs can also be first based on the order of sub-configurations, and then based on the order of frequency domain granularities.

CRI/RI/CQI may be determined based on Tables 16 and/or 17.

In Table 4, sub-configuration #1, sub-configuration #2, . . . , sub-configuration #i of the CSI report correspond (in order) to either the plurality of first sub-configurations (sub-configuration #1, sub-configuration #2, . . . , sub-configuration #L) of the CSI report or to the second sub-configuration(s) (sub-configuration #1, sub-configuration #2, . . . , sub-configuration #N) of the CSI report. The order of the plurality of first sub-configurations and the order of the second sub-configuration(s) can be referred to the previous description (e.g., the order of IDs, the position in the configuration information, the order of priorities).

### Method 5

Table 5 below shows the order of the CSI part 1 of the CSI report (or fields of CSI parameters in the CSI part 1 of the CSI report) or the mapping order of the CSI fields. The content of the CSI report may be configured to be transmitted on PUSCH. The order of the CSI fields in the CSI part 1 of the CSI report can be from upper part to lower part (or from lower part to upper part) as indicated in Table 5.

TABLE 5

| | CSI field |
|---|---|
| CSI | CRI of sub-configuration #1 (if reported) |
| part 1 | RI of sub-configuration #1 (if reported) |
| of CSI | Wideband CQI for first TB of sub-configuration #1 (if reported) |
| report | Subband CQI for first TB of sub-configuration #1 (if reported) |
| | CRI of sub-configuration #2 (if reported) |
| | RI of sub-configuration #2 (if reported) |
| | Wideband CQI for first TB of sub-configuration #2 (if reported) |
| | Subband CQI for first TB of sub-configuration #2 (if reported) |
| | . . . |
| | CRI of sub-configuration #i (if reported) |
| | RI of sub-configuration #i (if reported) |
| | Wideband CQI for first TB of sub-configuration #i (if reported) |
| | Subband CQI for first TB of sub-configuration #i (if reported) |

Reference may be made to the description ofTable 3 for the description of CSI fields in Table 5.

### Method 6

Table 6 below shows the order of the CS part 1 of the CS report (or fields of CS parameters in the CSI part 1 of the CSI report) or the mapping order of the CS fields. The content of the CS #report may be configured to be transmitted on PUSCH. The order of the CS fields in the CSI part 1 of the CSI report can be from upper part to lower part (or from lower part to upper part) as indicated in Table 6.

TABLE 6

| | CSI field |
|---|---|
| CSI | CRI of sub-configuration #1, sub-configuration #2, . . . , sub- |
| part 1 | configuration #i (if reported) |
| of CSI | RI of sub-configuration #1, sub-configuration #2, . . . , sub- |
| report | configuration #i (if reported) |
| | Wideband CQI for first TBs of sub-configuration #1, sub- |
| | configuration #2, . . . , sub-configuration #i (if reported) |
| | Subband CQI for first TBs of sub-configuration #1, sub- |
| | configuration #2, . . . , sub-configuration #i (if reported) |

Reference may be made to the description of Table 4 for the description of CSI fields in Table 6.

### Example 3

If condition C is satisfied, the CSI corresponds to two CSI parts, and/or the CSI (wideband CSI of CSI part 2 of the CSI) is at least based on the order of the plurality of first sub-configurations or the order of the second sub-configuration(s) and/or the order of the CSI parameters and/or the zero-padding bits corresponding to the CSI reporting configuration information. The condition C refers to at least one of CSI corresponding to subband frequency domain granularity, CSI being configured on PUCCH or PUSCH, and the number of the plurality of first sub-configurations or the number of the second sub-configuration(s) being greater than or equal to a specific value.

For a CSI report (e.g., corresponding to the CSI reporting configuration information), if the CSI report satisfies condition C, the CSI report corresponds to two CSI parts, and/or the order of CSI (e.g., wideband CSI in the CSI part 2) in the CSI report (or the order of CSI fields) is based on the order of the plurality of first sub-configurations or the order of the second sub-configuration(s) and/or the order of the CSI parameters and/or the zero-padding bits corresponding to the CSI reporting configuration information. The condition C refers to at least one of the following:

The CSI report has/is configured with one or more first sub-configurations. For example, one or more first sub-configurations with which the CSI reporting configuration information corresponding to the CSI report is included or is associated.

The CSI corresponds to subband frequency domain granularity. The CSI report corresponds to the subband frequency domain granularity. A PMI format indication parameter (pmi-FormatIndicator) in the CSI reporting configuration information is set to “subbandPMI” and/or a CQI format indication parameter (cqi-FormatIndicator) in the CSI reporting configuration information is set to “subbandCQI”. Alternatively, a report quantity parameter (reportQuantity) in the CSI reporting configuration information is set to “cri-RI-CQI” and/or the CQI format indication parameter (cqi-FormatIndicator) in the CSI reporting configuration information is set to “subbandCQI”.

The CSI corresponds to subband frequency domain granularity. One (or at least one/each/all) sub-configuration in the one or more first sub-configurations or the second sub-configuration(s) corresponds to the subband frequency domain granularity. A PMI format indication parameter (pmi-FormatIndicator) of the sub-configuration is set to “subbandPMI” and/or a CQI format indication parameter (cqi-FormatIndicator) in the CSI reporting configuration information is set to “subbandCQI”. Alternatively, a report quantity parameter (reportQuantity) of the sub-configuration is set to “cri-RI-CQI” and/or the CQI format indication parameter (cqi-FormatIndicator) in the CSI reporting configuration information is set to “subbandCQI”.

The number of the plurality of first sub-configurations or the number of the second sub-configuration(s) is greater than or equal to a specific value. The specific value can be predefined, for example, one of 1, 2, 3, 4, 5, 6, 7, or 8. The specific value can be based on UE capabilities. The specific value is indicated by the reported UE capability signaling. The specific value can be indicated by the base station. The specific value is configured by RRC signaling. The specific value is indicated by MAC-CE signaling. The specific value is indicated by DCI signaling. This approach helps the terminal device determine when it can use CSI consisting of two parts. When the number of the plurality of first sub-configurations or the second sub-configuration(s) increases (or exceeds a specific value), the number of information bits corresponding to the CSI increases, resulting in higher code rates. However, transmitting all the CSI can lead to decreased reliability. In such cases, the CSI is divided into two parts, and the CSI part 2 can be dropped to reduce the number of transmitted information bits, lower the code rate, and improve transmission reliability.

The number of the plurality of first sub-configurations or the number of the second sub-configuration(s) is less than or equal to a specific value. The specific value can be predefined, for example, one of 1, 2, 3, 4, 5, 6, 7, or 8. The specific value can be based on UE capabilities. The specific value is indicated by the reported UE capability signaling. The specific value can be indicated by the base station. The specific value is configured by RRC signaling. The specific value is indicated by MAC-CE or DCI signaling.

The CSI corresponds to two CSI parts. The two CSI parts are CSI part 1 and CSI part 2. One (or at least one/each/all) sub-configuration from the one or more first sub-configurations or from the second sub-configuration(s) (all) corresponds to two CSI parts.

The CSI corresponds to CSI part 2 wideband. The ordering rules for CSI are applicable to CSI part 2 wideband.

The CSI is configured on PUCCH (for transmission). A reporting configuration type parameter (reportConfigType) in the CSI reporting configuration information corresponding to the CSI is set to “periodic” or “semiPersistentOnPUCCH”. The CSI can be transmitted on PUCCH.

The CSI is configured on PUSCH (for transmission). A reporting configuration type parameter (reportConfigType) in the CSI reporting configuration information corresponding to the CSI is set to “aperiodic” or “semiPersistentOnPUSCH”. The CSI can be transmitted on PUSCH.

The CSI report includes/corresponds to two CSI parts. The CSI report includes CSI part 1 and CSI part 2. The CSI part 1 includes at least one of RI, CRI, CQI, and zero-padding bits. The CQI can include wideband CQI and/or subband CQI. The CQI can be the CQI for the first TB. The CSI part 2 can include wideband CSI of the CSI part 2 and subband CSI of the CSI part 2. Wideband CSI of the CSI part 2 includes at least one of CQI, LI and PMI. The CQI can be the CQI for the second TB. TB can also be referred to as codeword. PMI can include wideband PMI and/or subband PMI or X₁ and/or X₂ (refer below for the description of X₁ and X₂).

The payload sizes corresponding to the CSI part 1 are the same/fixed. Regardless of the RI (if reported) and/or CRI (if reported), the payload sizes corresponding to CSI are the same/fixed. For example, by the zero-padding bits, CSI payloads have the same size/bitwidth (total bit number) for different reported RIs and/or reported CRIs. CSI part 1 is used to determine the number of information bits of the CSI part 2 and may be transmitted in its entirety before CSI part 2.

The order of the CSI (or CSI fields) of the CSI report in the wideband CSI of the CSI part 2 can be based on at least one of the following methods.

### Method 7

Table 7 below shows the order of the wideband CSI of the CSI part 2 of the CSI report (or fields of CSI parameters in the wideband CSI of the CSI part 2 of the CSI report) or the mapping order of the CSI fields. The content of the CSI report may be configured to be transmitted on PUCCH. The order of the CSI fields in the wideband CSI of the CSI part 2 of the CSI report can be from upper part to lower part (or from lower part to upper part) as indicated in Table 7. The PMI format indication parameter (pmi-FormatIndicator) in the CSI reporting configuration information corresponding to the CSI report is set to “subbandPMI” and/or the CQI format indication parameter (cqi-Formatlndicator) in the CSI reporting configuration information is set to “subbandCQI”. The report quantity parameter (reportQuantity) in the CSI reporting configuration information corresponding to the CSI report is set to “cri-RI-CQI” and/or the CQI format indication parameter (cqi-FormatIndicator) in the CSI reporting configuration information is set to “subbandCQI”.

TABLE 7

| | CSI field |
|---|---|
| CSI | Wideband CQI for the second TB of sub-configuration #1 |
| part 2 | (if reported) |
| wide- | LI of sub-configuration #1 (if reported) |
| band | PMI wideband information field (corresponding with) X₁ of sub- |
| of CSI | configuration #1 (if reported) |
| report | PMI wideband information field (corresponding with) X₂ of sub- |
| | configuration #1 (if reported) |
| | Wideband CQI for second TB of sub-configuration #2 |
| | (if reported) |
| | LI of sub-configuration #2 (if reported) |
| | PMI wideband information field (corresponding with) X₁ of sub- |
| | configuration #2 (if reported) |
| | PMI wideband information field (corresponding with) X₂ of sub- |
| | configuration #2 (if reported) |
| | . . . |
| | Wideband CQI for second TB of sub-configuration #i |
| | (if reported) |
| | LI of sub-configuration #i (if reported) |
| | PMI wideband information field (corresponding with) X₁ of sub- |
| | configuration #i (if reported) |
| | PMI wideband information field (corresponding with) X₂ of sub- |
| | configuration #i (if reported) |

In Table 7, “if reported” indicates that a specific CSI field may or may not be present or reported.

In Table 7, CRI/RI/LI/CQI is determined based on Tables 16 and/or 17. PMI is determined based on Tables 14 and/or 15 (from left to right). The PMI wideband information field X₁ is determined based on Tables 14 and/or 15 (from left to right), or based on a codebook index used for 2 antenna ports. The PMI wideband information field X₂ is determined based on Tables 14 and/or 15 (from left to right), or based on a codebook index used for 2 antenna ports. When PMI corresponds to wideband PMI such as when the PMI format indication parameter (pmi-FormatIndicator) configured by the CSI reporting configuration information is set to/equal to “widebandPMI”. In Table 7, the PMI wideband information field X₂ is determined based on Tables 14 and/or 15 below (from left to right), or based on a codebook index used for 2 antenna ports.

In Table 7, sub-configuration #1, sub-configuration #2, . . . , sub-configuration #i of the CSI report correspond to the plurality of first sub-configurations (sub-configuration #1, sub-configuration #2, . . . , sub-configuration #L) of the CSI report (in order) or correspond to the second sub-configuration(s) (sub-configuration #1, sub-configuration #2, . . . , sub-configuration #N) of the CSI report (in order). The order of the plurality of first sub-configurations and the order of the second sub-configuration(s) can be referred to the previous description (e.g., the order of IDs, the position in the configuration information, the order of priorities).

### Method 8

Table 8 below shows the order of the wideband CSI of the CSI part 2 of the CSI report (or fields of CSI parameters in the wideband CSI of the CSI part 2 of the CSI report) or the mapping order of the CSI fields. The content of the CSI report may be configured to be transmitted on PUCCH. The order of the CSI fields in the wideband CSI of the CSI part 2 of the CSI report can be from upper part to lower part (or from lower part to upper part) as indicated in Table 8. The PMI format indication parameter (pmi-FormatIndicator) in the CSI reporting configuration information corresponding to the CSI report is set to “subbandPMI” and/or the CQI format indication parameter (cqi-FormatIndicator) in the CSI reporting configuration information is set to “subbandCQI”. The report quantity parameter (reportQuantity) in the CSI reporting configuration information corresponding to the CSI report is set to “cri-RI-CQI” and/or the CQI format indication parameter (cqi-FormatIndicator) in the CSI reporting configuration information is set to “subbandCQI”.

TABLE 8

| | CSI field |
|---|---|
| CSI | Wideband CQI for second TBs of sub-configuration #1, sub- |
| part 2 | configuration #2, . . . , sub-configuration #i (if reported) |
| wide- | LI of sub-configuration #1, sub-configuration #2, . . . , sub- |
| band | configuration #i (if reported) |
| of CSI | Wideband PMI of sub-configuration #1, sub-configuration |
| report | #2, . . . , sub-configuration #i (if reported) |

In Table 8, “if reported” indicates that a specific CSI field may be present (or be reported) or may not be present (or not be reported). For a CSI field, “if reported” can indicate that CSI parameters (for example, CQI, LI, PMI X₁, PMI X₂) or zero-padding bits corresponding to each sub-configuration may or may not be present (separately). In Table 8, taking LI as an example of the CSI parameters, the LIs of sub-configuration #1, sub-configuration #2, . . . , sub-configuration #i can share one CSI field (as described in Table 8), or the LIs of sub-configuration #1, sub-configuration #2, . . . , sub-configuration #i can correspond to separate CSI fields. The LIs of sub-configuration #1, sub-configuration #2, . . . , sub-configuration #i are in one-to-one correspondence with i CSI fields.

In Table 8, the order of information bits of CSI parameters (e.g., CQI, LI, PMI, X₁ corresponding to PMI, X₂ corresponding to PMI) in one (or each) CSI field is based on the order of sub-configuration #1, sub-configuration #2, . . . , sub-configuration #i.

The ordering method of information bits in the corresponding CSI fields of sub-configuration #1, sub-configuration #2, . . . , sub-configuration #i are illustrated by taking “LIs of sub-configuration #1, sub-configuration #2, . . . , sub-configuration #i” as an example. The order of information bits in “LIs of sub-configuration #1, sub-configuration #2, . . . , sub-configuration #i” is based on the (indexed) increasing or decreasing order of sub-configuration #1, sub-configuration #2, . . . , sub-configuration #i. The order is: (information bits corresponding to) LI corresponding to sub-configuration #1, (information bits corresponding to) LI corresponding to sub-configuration #2, . . . , (information bits corresponding to) LI corresponding to sub-configuration #i.

In Table 8, CQI/LI is determined based on Tables 16 and/or 17. PMI is determined based on Tables 14 and/or 15 (from left to right). The PMI wideband information field X₁ is determined based on Tables 14 and/or 15 (from left to right) or based on a codebook index used for 2 antenna ports. The PMI wideband information field X₂ is determined based on Tables 14 and/or 15 (from left to right) or based on a codebook index used for 2 antenna ports. When PMI corresponds to wideband PMI such as when the PMI format indication parameter (pmi-FormatIndicator) configured by the CSI reporting configuration information is set to/equal to “widebandPMI”, in Table 7, the PMI wideband information field X₂ is determined based on Tables 14 and/or 15 (from left to right), or based on a codebook index used for 2 antenna ports.

In Table 8, sub-configuration #1, sub-configuration #2, . . . , sub-configuration #i of the CSI report correspond to the plurality of first sub-configurations (sub-configuration #1, sub-configuration #2, . . . , sub-configuration #L) of the CSI report (in order) or correspond to the second sub-configuration(s) (sub-configuration #1, sub-configuration #2, . . . , sub-configuration #N) of the CSI report (in order). The order of the plurality of first sub-configurations and the order of the second sub-configuration(s) can be referred to the previous description (e.g., the order of IDs, the position in the configuration information, the order of priorities).

### Method 9

Table 9 below shows the order of the wideband CSI of the CSI part 2 of the CSI report (or fields of CSI parameters in the wideband CSI of the CSI part 2 of the CSI report) or the mapping order of the CSI fields. The content of the CSI report may be configured to be transmitted on PUSCH. The order of the CSI fields in the wideband CSI of the CSI part 2 of the CSI report can be from upper part to lower part (or from lower part to upper part) as indicated in Table 9.

TABLE 9

| | CSI field |
|---|---|
| CSI | Wideband CQI for second TB of sub-configuration #1 |
| part 2 | (if reported) |
| wide- | LI of sub-configuration #1 (if reported) |
| band | PMI wideband information field (corresponding with) X₁ of sub- |
| of CSI | configuration #1 (if reported) |
| report | PMI wideband information field (corresponding with) X₂ of sub- |
| | configuration #1 (if reported) |
| | Wideband CQI for second TB of sub-configuration #2 |
| | (if reported) |
| | LI of sub-configuration #2 (if reported) |
| | PMI wideband information field (corresponding with) X₁ of sub- |
| | configuration #2 (if reported) |
| | PMI wideband information field (corresponding with) X₂ of sub- |
| | configuration #2 (if reported) |
| | . . . |
| | Wideband CQI for second TB of sub-configuration #i |
| | (if reported) |
| | LI of sub-configuration #i (if reported) |
| | PMI wideband information field (corresponding with) X₁ of sub- |
| | configuration #i (if reported) |
| | PMI wideband information field (corresponding with) X₂ of sub- |
| | configuration #i (if reported) |

Reference may be made to the description of Table 7 for the description of CSI fields in Table 9.

### Method 10

See Table 10 for the order of the wideband CSI of the CSI part 2 of the CSI report (or fields of CSI parameters in the wideband CSI of the CSI part 2 of the CSI report) or the mapping order of the CSI fields. The content of the CSI report may be configured to be transmitted on PUSCH. The order of the CSI fields in the wideband CSI of the CSI part 2 of the CSI report can be from upper part to lower part (or from lower part to upper part) as indicated in Table 10.

TABLE 10

| | CSI field |
|---|---|
| CSI | Wideband CQI for second TB of sub-configuration #1, sub- |
| part 2 | configuration #2, . . . , sub-configuration #i (if reported) |
| wide- | LI of sub-configuration #1, sub-configuration #2, . . . , sub- |
| band | configuration #i (if reported) |
| of CSI | Wideband PMI of sub-configuration #1, sub-configuration |
| report | #2, . . . , sub-configuration #i (if reported) |

Reference may be made to the description of Table 8 for the description of CSI fields in Table 10.

### Example 4

If condition D is satisfied, the CSI corresponds to two CSI parts, and/or the CSI (subband CSI of CSI part 2 of the CSI) is at least based on the order of the plurality of first sub-configurations or the order of the second sub-configuration(s) and/or the order of the CSI parameters and/or the zero-padding bits corresponding to the CSI reporting configuration information; The condition D refers to at least one of the following: CSI corresponding to subband frequency domain granularity, CSI being configured on PUCCH or PUSCH, and the number of the plurality of first sub-configurations or the number of the second sub-configuration(s) being greater than or equal to a specific value.

For a CSI report (e.g., corresponding to the CSI reporting configuration information), if the CSI report satisfies condition D, the CSI report corresponds to two CSI parts, and/or the order of CSI (e.g., subband CSI in the CSI part 2) in the CSI report (or the order of CSI fields) is based on the order of the plurality of first sub-configurations or the order of the second sub-configuration(s) and/or the order of the CSI parameters and/or the zero-padding bits corresponding to the CSI reporting configuration information. The condition D refers to at least one of the following:

The CSI report has/is configured with one or more first sub-configurations. For example, one or more first sub-configurations with which the CSI reporting configuration information corresponding to the CSI report is included or is associated.

The CSI corresponds to subband frequency domain granularity. The CSI report corresponds to the subband frequency domain granularity. A PMI format indication parameter (pmi-FormatIndicator) in the CSI reporting configuration information is set to “subbandPMI” and/or a CQI format indication parameter (cqi-FormatIndicator) in the CSI reporting configuration information is set to “subbandCQI”. Alternatively, a report quantity parameter (reportQuantity) in the CSI reporting configuration information is set to “cri-RI-CQI” and/or the CQI format indication parameter (cqi-FormatIndicator) in the CSI reporting configuration information is set to “subbandCQI”.

The CSI corresponds to subband frequency domain granularity. One (or at least one/each/all) sub-configuration in the one or more first sub-configurations or the second sub-configuration(s) corresponds to the subband frequency domain granularity. A PMI format indication parameter (pmi-FormatIndicator) of the sub-configuration is set to “subbandPMI” and/or a CQI format indication parameter (cqi-FormatIndicator) in the CSI reporting configuration information is set to “subbandCQI”. Alternatively, a report quantity parameter (reportQuantity) of the sub-configuration is set to “cri-RI-CQI” and/or the CQI format indication parameter (cqi-FormatIndicator) in the CSI reporting configuration information is set to “subbandCQI”.

The number of the plurality of first sub-configurations or the number of the second sub-configuration(s) is greater than or equal to a specific value. The specific value can be predefined, for example, one of 1, 2, 3, 4, 5, 6, 7, or 8. The specific value can be based on UE capabilities. The specific value is indicated by the reported UE capability signaling. The specific value can be indicated by the base station. The specific value is configured by RRC signaling. The specific value is indicated by MAC-CE signaling. The specific value is indicated by DCI signaling. This approach helps the terminal device determine when CSI consisting of two parts can be used. When the number of the plurality of first sub-configurations or the second sub-configuration(s) increases (or exceeds a specific value), the number of information bits corresponding to the CSI increases, resulting in higher code rates. However, transmitting all the CSI can lead to decreased reliability. In such cases, the CSI is divided into two parts, and the CSI part 2 can be dropped to reduce the number of transmitted information bits, lower the code rate, and improve transmission reliability.

The number of the plurality of first sub-configurations or the number of the second sub-configuration(s) is less than or equal to a specific value. The specific value can be predefined, for example, one of 1, 2, 3, 4, 5, 6, 7, or 8. The specific value can be based on UE capabilities. The specific value is indicated by the reported UE capability signaling. The specific value can be indicated by the base station. The specific value is configured by RRC signaling. The specific value is indicated by MAC-CE signaling or DCI signaling.

The CSI corresponds to two CSI parts. The two CSI parts are CSI part 1 and CSI part 2. One (or at least one/each/all) sub-configuration from the one or more first sub-configurations or from the second sub-configuration(s) (all) corresponds to two CSI parts.

The CSI corresponds to CSI part 2 wideband. The ordering rules for CSI are applicable to CSI part 2 wideband.

The CSI is configured on PUCCH (for transmission). A reporting configuration type parameter (reportConfigType) in the CSI reporting configuration information corresponding to the CSI is set to “periodic” or “semiPersistentOnPUCCH”. The CSI can be transmitted on PUCCH.

The CSI is configured on PUSCH (for transmission). A reporting configuration type parameter (reportConfigType) in the CSI reporting configuration information corresponding to the CSI is set to “aperiodic” or “semiPersistentOnPUSCH”. The CSI can be transmitted on PUSCH.

The CSI report includes/corresponds to two CSI parts. The CSI report includes a CSI part 1 and a CSI part 2. The CSI part 2 can include wideband CSI of the CSI part 2 and subband CSI of the CSI part 2. The CSI part 1 includes at least one of RI, CRI, CQI, and zero-padding bits. The CQI can include wideband CQI and/or subband CQI. The CQI can be the CQI for the first TB. The CSI part 2 can include wideband CSI of the CSI part 2 and subband CSI of the CSI part 2. Subband CSI of the CSI part 2 may include at least one of CQI and PMI. The CQI can be the CQI for the second TB. The CQI for the second TB includes CQI for all odd subband number of the second TB and/or CQI for all even subband number of the second TB. The TB can also be referred to as codeword. PMI can include wideband PMI and/or subband PMI. The subband PMI can include PMIs of all odd subband numbers and/or PMIs of all even subband numbers. The PMI can include X₁ and/or X₂ (refer below for the description of X₁ and X₂).

The payload sizes corresponding to the CSI part 1 are the same/fixed. Optionally, regardless of the RI (if reported) and/or CRI (if reported), the payload sizes corresponding to CSI are the same/fixed. For example, by the zero-padding bits, CSI payloads have the same size/bitwidth (total bit number) for different reported RIs and/or reported CRIs. The CSI part 1 is used to determine the number of information bits of the CSI part 2 and may be transmitted in its entirety before CSI part 2.

The order of the CSI (or CSI fields) of the CSI report in the subband CSI of the CSI part 2 can be based on at least one of the following methods.

### Method 11

Table 11 below shows the order of the subband CSI of the CSI part 2 of the CSI report (or fields of CSI parameters in the subband CSI of the CSI part 2 of the CSI report) or the mapping order of the CSI fields. The content of the CSI report may be configured to be transmitted on PUCCH or PUSCH. The order of the CSI fields in the subband CSI of the CSI part 2 of the CSI report can be from upper part to lower part (or from lower part to upper part) as indicated in Table 11. The PMI format indication parameter (pmi-FormatIndicator) in the CSI reporting configuration information corresponding to the CSI report is set to “subbandPMI” and/or the CQI format indication parameter (cqi-FormatIndicator) in the CSI reporting configuration information is set to “subbandCQI”. The report quantity parameter (reportQuantity) in the CSI reporting configuration information corresponding to the CSI report is set to “cri-RI-CQI” and/or the CQI format indication parameter (cqi-FormatIndicator) in the CSI reporting configuration information is set to “subbandCQI”.

TABLE 11

| | CSI field |
|---|---|
| CSI | Subband CQI of sub-configuration #1 for the second TB of (all) |
| part 2 | even subbands |
| sub- | Subband PMI (corresponding with) X₂ of sub-configuration #1 |
| band | of (all) even subbands (if reported) |
| of CSI | Subband CQI of sub-configuration #1 for the second TB of (all) |
| report | odd subbands |
| | Subband PMI (corresponding with) X₂ of sub-configuration #1 |
| | of (all) odd subbands (if reported) |
| | Subband CQI of sub-configuration #2 for the second TB of (all) |
| | even subbands |
| | Subband PMI (corresponding with) X₂ of sub-configuration #2 |
| | of (all) even subbands (if reported) |
| | Subband CQI of sub-configuration #2 for the second TB of (all) |
| | odd subbands |
| | Subband PMI (corresponding with) X₂ of sub-configuration #2 |
| | of (all) odd subbands |
| | . . . |
| | Subband CQI of sub-configuration #i for the second TB of (all) |
| | even subbands |
| | Subband PMI (corresponding with) X₂ of sub-configuration #i |
| | of (all) even subbands (if reported) |
| | Subband CQI of sub-configuration #i for the second TB of (all) |
| | odd subbands |
| | Subband PMI (corresponding with) X₂ of sub-configuration #i |
| | of (all) odd subbands (if reported) |

In Table 11, “if reported” indicates that a specific CSI field may or may not be present or reported.

CQI may be determined based on Tables 16 and/or 17. When CQI corresponds to subband CQI (When the CQI format indication parameter (cqi-FormatIndicator) configured by the CSI reporting configuration information is set to/equal to “subbandCQI”), CQI is determined based on Tables 16 and/or 17.

The PMI information field (corresponding with) X₂ is determined based on Tables 14 and/or 15 below (from left to right) or based on a codebook index used for 2 antenna ports. When PMI corresponds to subband PMI (When the PMI format indication parameter (pmi-FormatIndicator) configured by the CSI reporting configuration information is set to/equal to “subbandPMI”), in Table 11, the PMI information field (corresponding with) X₂ is determined based on Tables 14 and/or 15 (from left to right), or based on codebook index used for 2 antenna ports.

In Table 11, subband CQI can be subband differential CQI. This CQI is based on wideband CQI and represented via differential indicators. The subband CQI for the second TB of the sub-configuration #1 can include/correspond to/be associated with one or more subband CQIs which correspond to one or more (even/odd) subbands. In a field including the subband CQIs of the sub-configuration #1 for the second TB (of even subbands), the order of CQIs is based on the increasing/decreasing order of even subband number corresponding to the CQIs. Similarly, in a field including the subband CQI of the sub-configuration #2 for the second TB, the order of CQIs is based on the increasing/decreasing order of (even) subband number corresponding to the CQIs, and so on. In a field including the subband CQIs of the sub-configuration #1 for the second TB (of odd subbands), the order of CQIs is based on the increasing/decreasing order of odd subband number corresponding to the CQIs. Similarly, in a field including the subband CQI of the sub-configuration #2 of the second TB, the order of CQIs is based on the increasing/decreasing order of (odd) subband number corresponding to the CQIs, and so on.

In Table 11, the description or ordering method of subband PMIs (of even subband number/odd subband number) is similar to those of subband CQIs, so the description of CQI can be used as a reference and can replace CQI in the description of PMI.

In Table 11, a subband of the CSI report is indicated by a higher layer parameter csi-ReportingBand (in the corresponding CSI reporting configuration information). These subbands are numbered continuously in increasing order with the lowest subband of csi-ReportingBand as subband 0.

In Table 11, sub-configuration #1, sub-configuration #2, . . . , sub-configuration #i of the CSI report correspond to the plurality of first sub-configurations (sub-configuration #1, sub-configuration #2, . . . , sub-configuration #L) of the CSI report (in order) or correspond to the second sub-configuration(s) (sub-configuration #1, sub-configuration #2, . . . , sub-configuration #N) of the CSI report (in order). The order of the plurality of first sub-configurations and the order of the second sub-configuration(s) is described in the previous description (e.g., the order of IDs, the position in the configuration information, the order of priorities).

### Method 12

Table 12 below shows the order of the subband CSI of the CSI part 2 of the CSI report (or fields of CSI parameters in the subband CSI of the CSI part 2 of the CSI report) or the mapping order of the CSI fields. The content of the CSI report may be configured to be transmitted on PUCCH or PUSCH. The order of the CSI fields in the subband CSI of the CSI part 2 of the CSI report can be from upper part to lower part (or from lower part to upper part) as indicated in Table 12. The PMI format indication parameter (pmi-FormatIndicator) in the CSI reporting configuration information corresponding to the CSI report is set to “subbandPMI” and/or the CQI format indication parameter (cqi-FormatIndicator) in the CSI reporting configuration information is set to “subbandCQI”. The report quantity parameter (reportQuantity) in the CSI reporting configuration information corresponding to the CSI report is set to “cri-RI-CQI” and/or the CQI format indication parameter (cqi-FormatIndicator) in the CSI reporting configuration information is set to “subbandCQI”.

TABLE 12

| | CSI field |
|---|---|
| CSI | Subband CQI of sub-configuration #1 for the second TB of (all) |
| part 2 | even subbands |
| sub- | Subband PMI (corresponding with) X₂ of sub-configuration #1 |
| band | of (all) even subbands (if reported) |
| of CSI | Subband CQI of sub-configuration #2 for the second TB of (all) |
| report | even subbands |
| | Subband PMI (corresponding with) X₂ of sub-configuration #2 |
| | of (all) even subbands (if reported) |
| | . . . |
| | Subband CQI of sub-configuration #i for the second TB of (all) |
| | even subbands |
| | Subband PMI (corresponding with) X₂ of sub-configuration #i |
| | of (all) even subbands (if reported) |
| | Subband CQI of sub-configuration #1 for the second TB of (all) |
| | odd subbands |
| | Subband PMI (corresponding with) X₂ of sub-configuration #1 |
| | of (all) odd subbands (if reported) |
| | Subband CQI of sub-configuration #2 for the second TB of (all) |
| | odd subbands |
| | Subband PMI (corresponding with) X₂ of sub-configuration #2 |
| | of (all) odd subbands (if reported) |
| | . . . |
| | Subband CQI of sub-configuration #i for the second TB of (all) |
| | odd subbands |
| | Subband PMI (corresponding with) X₂ of sub-configuration #i |
| | of (all) odd subbands (if reported) |

In Table 12, “if reported” indicates that a specific CSI field may or may not be present or reported.

CQI may be determined based on Tables 16 and/or 17 below. When CQI corresponds to subband CQI such as when the CQI format indication parameter (cqi-FormatIndicator) configured by the CSI reporting configuration information is set to/equal to “subbandCQI”), CQI is determined based on Tables 16 and/or 17.

The PMI information field (corresponding with) X_{z} is determined based on Tables 14 and/or 15 (from left to right) or based on codebook index used for 2 antenna ports. When PMI corresponds to subband PMI such as when the PMI format indication parameter (pmi-FormatIndicator) configured by the CSI reporting configuration information is set to/equal to “subbandPMI”), in Table 12, the PMI information field (corresponding with) X₂ is determined based on Tables 14 and/or 15 (from left to right), or based on codebook index used for 2 antenna ports.

In Table 12, refer to Table 11 for the description of each CSI field. Table 12 is different in that the CSI fields/CSI information bits are first based on the odd-even order (e.g., the order of CSI corresponding to odd subbands and CSI corresponding to even subbands), then based on the order of sub-configurations, and finally based on the order of CSI parameters. The order of CSI parameters can be CQI parameter first, followed by PMI parameter.

The advantage of this approach is that CSI corresponding to odd subbands and CSI corresponding to even subbands can be grouped together respectively, making it convenient to drop or partially drop one or both of these parts, thereby improving the flexibility of the communication system. This approach can drop or prioritize the dropping of the CSI corresponding to odd subbands.

### Method 13

Table 13 below shows the order of the subband CSI of the CSI part 2 of the CSI report (or fields of CSI parameters in the subband CSI of the CSI part 2 of the CSI report) or the mapping order of the CSI fields. The content of the CSI report may be configured to be transmitted on PUCCH or PUSCH. The order of the CSI fields in the subband CSI of the CSI part 2 of the CSI report can be from upper part to lower part (or from lower part to upper part) as indicated in Table 12. The PMI format indication parameter (pmi-FormatIndicator) in the CSI reporting configuration information corresponding to the CSI report is set to “subbandPMI” and/or the CQI format indication parameter (cqi-FormatIndicator) in the CSI reporting configuration information is set to “subbandCQI”. The report quantity parameter (reportQuantity) in the CSI reporting configuration information corresponding to the CSI report is set to “cri-RI-CQI” and/or the CQI format indication parameter (cqi-FormatIndicator) in the CSI reporting configuration information is set to “subbandCQI”.

TABLE 13

| | CSI field |
|---|---|
| CSI | Subband CQI of sub-configuration #1, sub-configuration |
| part 2 | #2, . . . , sub-configuration #i for the second TB of (all) |
| sub- | even subbands |
| band | Subband PMI (corresponding with) X₂ of sub-configuration |
| of CSI | #1, sub-configuration #2, . . . , sub-configuration #i of (all) |
| report | even subbands (if reported) |
| | Subband CQI of sub-configuration #1, sub-configuration |
| | #2, . . . , sub-configuration #i for the second TB of (all) |
| | odd subbands |
| | Subband PMI (corresponding with) X₂ of sub-configuration |
| | #1, sub-configuration #2, . . . , sub-configuration #i of (all) |
| | odd subbands (if reported) |

In Table 13, “if reported” indicates that a specific CSI field may be present (or be reported) or may not be present (or not be reported). For a CSI field, “if reported” can separately indicate that CSI parameters such as CQI or PMI corresponding to each sub-configuration may or may not be present.

In Table 13, taking CQI as an example of the CSI parameters, the CQIs of sub-configuration #1, sub-configuration #2, . . . , sub-configuration #i can share one CSI field (as described in Table 2), or the CQIs of sub-configuration #1, sub-configuration #2, . . . , sub-configuration #i can correspond to separate CSI fields. The CQIs of sub-configuration #1, sub-configuration #2, . . . sub-configuration #i are in one-to-one correspondence with i CSI fields.

In Table 13, the order of information bits of CSI parameters (e.g., CQI/PMI) in one (or each) CSI field can be based on the order of sub-configuration #1, sub-configuration #2, . . . , sub-configuration #i.

In Table 13, the CSI fields/CSI information bits are first based on the odd-even order (e.g., the order of CSI corresponding to odd subband number and CSI corresponding to even subband number), then based on the order of CSI parameter types, then based on the order of subband number, and finally based on the order of sub-configurations. The order of CSI parameters can be CQI parameter first, followed by PMI parameter. In Table 13, the CSI fields/CSI information bits are firstly based on the odd-even order (e.g., the order of CSI corresponding to odd subband number and CSI corresponding to even subband number), then based on the order of CSI parameter types, then based on the order of sub-configurations, and finally based on the order of subband number. The order of CSI parameters can be a CQI parameter first, followed by a PMI parameter.

In Table 13, for a CSI field including the subband CQI for (all) even subband number of second TBs of sub-configuration #1, sub-configuration #2, . . . , sub-configuration #i, the order of information bits in this CSI field is based on the order of subband number corresponding to the subband CQI for the second TBs (e.g., increasing or decreasing order) and the order of sub-configurations (e.g., increasing or decreasing order). The information bits of subband CQIs in the CSI field are first mapped based on the order of subband number corresponding to the subband CQIs, and then based on the order of sub-configuration #1, sub-configuration #2, . . . , sub-configuration #i. For example, CQI {sub-configuration #1, subband #0}, CQI {sub-configuration #2, subband #0}, . . . , CQI {sub-configuration #i, subband #0}, CQI {sub-configuration #i, subband #1}, . . . , CQI {sub-configuration #i, subband #max}. The information bits in the CSI field (e.g., information bits of subband CQIs) are first mapped based on the order of sub-configuration #1, sub-configuration #2, . . . , sub-configuration #i, and then are mapped based on the order of subband number corresponding to the subband CQIs. For example, CQI {sub-configuration #1, subband #0}, CQI {sub-configuration #1, subband #2}, . . . , CQI {sub-configuration #1, subband #max}, CQI {sub-configuration #2, subband #0}, CQI {sub-configuration #2, subband #2}, . . . , CQI {sub-configuration #i, subband #max}. The subband #max represents the maximum even index number of subbands (or the maximum value of the even index).

In Table 13, reference may be made to the subband CQI field corresponding to the even subband number for the description/ordering of a CSI field including the subband CQI for all odd subband numbers of second TBs of sub-configuration #1, sub-configuration #2, . . . , sub-configuration #i (for example, replace “even” in the description with “odd”).

In Table 13, the description or ordering method of subband PMIs (of even subband number/odd subband number) is similar to those of subband CQIs, so the description of CQI can be used as a reference (e.g., replace CQI in the description with PMI).

CQI may be determined based on Tables 16 and/or 17. When CQI corresponds to subband CQI (When the CQI format indication parameter (cqi-FormatIndicator) configured by the CSI reporting configuration information is set to/equal to “subbandCQI”), CQI is determined based on Tables 16 and/or 17.

The PMI wideband information field corresponding with X₂ is determined based on Tables 14 and/or 15 (from left to right) or based on a codebook index used for 2 antenna ports. When PMI corresponds to subband PMI (When the PMI format indication parameter (pmi-FormatIndicator) configured by the CSI reporting configuration information is set to/equal to “subbandPMI”), in Table 13, the PMI wideband information field corresponding with X₂ is determined based on Tables 14 and/or 15 (from left to right), or based on codebook index used for 2 antenna ports.

In Table 13, sub-configuration #1, sub-configuration #2, . . . , sub-configuration #i of the CSI report correspond to the plurality of first sub-configurations (sub-configuration #1, sub-configuration #2, . . . , sub-configuration #L) of the CSI report (in order) or correspond to the second sub-configuration(s) (sub-configuration #1, sub-configuration #2, . . . , sub-configuration #N) of the CSI report (in order). The order of the plurality of first sub-configurations and the order of the second sub-configuration(s) is described in the previous description (e.g., the order of IDs, the position in the configuration information, the order of priorities).

The advantage of this approach is that CSI corresponding to odd subband number and CSI corresponding to even subband number can be grouped together respectively, making it convenient to drop or partially drop one or both of these parts, thereby improving the flexibility of the communication system. This approach can (as a priority) drop the CSI corresponding to odd subband number.

The advantage of Embodiment 1 is that, when configuring one or more sub-configurations for CSI reporting, the number of parts of CSI corresponding to the sub-configurations and/or the order of different types of CSI information bits is clarified, ensuring both terminal devices and network devices to have a common understanding of CSI, thereby enhancing the reliability of the communication system.

### Embodiment 2

The UE receives CSI reporting configuration information (for example, CSI-ReportConfig). The CSI reporting configuration information is associated with/corresponds to/includes one or more first sub-configurations, which may be referred to as sub-configuration information. The first sub-configuration may be sub-configuration information of a CSI report. The CSI reporting configuration information may correspond to a CSI report or may be used to refer to a CSI report.

A second sub-configuration includes one of the one or more first sub-configurations. The second sub-configuration includes at least one of sub-configurations in (corresponding to) a subset of the one or more first sub-configurations. The description of the first sub-configurations, the second sub-configuration, and the subset is provided in Embodiment 1.

One of the plurality of first sub-configurations or one of the second sub-configuration(s) may be referred to as a sub-configuration. The sub-configuration may include/indicate/configure/be associated with at least one of the following.

Port Parameter. When a first condition is satisfied, the sub-configuration can include/indicate/configure/be associated with the port parameter. Refer to Embodiment 1 for the description of the port parameter.

Codebook Parameter. When a first condition is satisfied, the sub-configuration can include/indicate/configure/be associated with the codebook parameter. Refer to Embodiment 1 for the description of the codebook parameter.

Codebook Type Parameter. When a first condition is satisfied, the sub-configuration can include/indicate/configure/be associated with the codebook type parameter. Refer to Embodiment 1 for the description of the codebook type parameter.

Rank Restriction Parameter. When a first condition is satisfied, the sub-configuration can include/indicate/configure/be associated with the rank restriction parameter. Refer to Embodiment 1 for the description of the rank restriction parameter.

One or More Resources. When a second condition (or first condition) is satisfied, the sub-configuration can include/indicate/configure/be associated with one or more resources. Refer to Embodiment 1 for the description of the one or more resources.

CQI Table Parameter. When a second condition (or first condition) is satisfied, the sub-configuration can include/indicate/configure/be associated with the CQI table parameter. Refer to Embodiment 1 for the description of the CQI table parameter.

Power Parameter. When a second condition (or first condition) is satisfied, the sub-configuration can include/indicate/configure/be associated with the power parameter. Refer to Embodiment 1 for the description of the power parameter.

The UE determines second CSI based on the parameters indicated by the plurality of first sub-configurations or the second sub-configuration and/or first CSI. The CSI can be CSI parameters. Determining the CSI parameters may be calculating the CSI parameters, determining CSI feedback, or determining a report that carries the CSI parameters (that is, determining the CSI report). The CSI parameter may be CSI feedback or a CSI report that carries the CSI parameter.

The CSI parameter can be referred to as CSI quantity. The CSI parameter can be at least one of CRI, RI, PMI, CQI, or LI. The CSI parameter can be at least one of CRI, SS/PBCH block resource indicator (SSBRI), L1-reference signal received power (L1-RSRP), or L1-signal interference noise ratio (L1-SINR), and capability index.

CSI parameters (or a first CSI parameter and/or a second CSI parameter) can be determined based on a report quantity corresponding to the CSI reporting configuration information. CSI parameters of (one of/each of) the plurality of first sub-configurations or the second sub-configuration can be determined based on a report quantity corresponding to the CSI reporting configuration information. The CSI parameters or the report quantity corresponding to the CSI reporting configuration information can be at least one of CRI, RI, LI, PMI, and CQI. A CSI parameter of a report quantity parameter (e.g., reportQuantity) in the CSI reporting configuration information (e.g., CSI-ReportConfig) can be at least one of CRI, RI, LI, PMI, and CQI. When the parameter reportQuantity is set to “cri-RI-LI-PMI-CQI”, CSI parameters (corresponding to one/each of the plurality of first sub-configurations or the second sub-configuration) are CRI, RI, LI, PMI and CQI. When the parameter reportQuantity is set to “cri-RI-PMI-CQI”, CSI parameters (corresponding to one/each of the plurality of first sub-configurations or the second sub-configuration) are CRI, RI, PMI and CQI. When the parameter reportQuantity is set to “cri-RI-i1-CQI”, CSI parameters (corresponding to one/each of the plurality of first sub-configurations or the second sub-configuration) are CRI, RI, PMI and CQI. When the parameter reportQuantity is set to “cri-RI-i1”, CSI parameters (corresponding to one/each of the plurality of first sub-configurations or the second sub-configuration) are CRI, RI, and PMI. When the parameter reportQuantity is set to “cri-RI-CQI”, CSI parameters corresponding to one/each of the plurality of first sub-configurations or the second sub-configuration are CRI, RI, and CQI.

The UE determines the second CSI parameter and/or zero-padding bits based on the parameters indicated by the plurality of first sub-configurations or the second sub-configuration, and/or the first CSI parameter. When the first condition or the second condition is satisfied, the ULE determines the second CSI parameter and/or zero-padding bits based on the parameters indicated by the plurality of first sub-configurations or the second sub-configuration, and/or the first CSI parameter.

The first condition includes at least one of the following.

The second condition is unsatisfied. That is, when the second condition is not met, the UE determines the second CSI parameter of the second sub-configuration based on the first CSI parameter indicated by the second sub-configuration. The second condition is described below.

The second sub-configuration is configured with a type 1 parameter. The type 1 parameter is used to indicate type 1 adaptation.

(One or all) of the one or more first sub-configurations are configured with type 1 parameters. The type 1 parameter is used to indicate type 1 adaptation.

The one or more first sub-configurations have different CSI-RS ports (or CSI-RS port subset). The CSI-RS port refers to a CSI-RS port (or port subset) indicated by the second sub-configuration. The CSI-RS port can be used for channel measurement. CSI ports can be CSI-RS antenna ports. The CSI-RS port corresponds to resources (e.g., reference signal resources) used for channel measurement.

The second sub-configuration includes/corresponds to/is associated with/indicates a port subset. The port subset refers to a CSI-RS port subset or CSI-RS antenna port subset for channel measurement for the second sub-configuration.

One or all of the one or more first sub-configurations include/correspond to/are associated with/indicate port subset. One or all of the one or more first sub-configurations include/correspond to/are associated with/indicate different port subsets (e.g., CSI-RS antenna port subsets). CSI-RS resources corresponding to the port subset are used for channel measurement and/or interference measurement.

The number of resources used for channel measurement for the second sub-configuration is greater than 1. The number of reference signal resources used for channel measurement in the second sub-configuration is greater than 1.

The number of resources used for channel measurement corresponding to the CSI configuration information is greater than 1. The number of reference signal resources used for channel measurement in the second sub-configuration is greater than 1. The number of reference signal resources in a resource set (e.g., NZP-CSI-RS-ResourceSet) used for channel measurement corresponding to the CSI configuration information is greater than 1.

The CSI configuration information corresponds to one of an aperiodic CSI report, a semi-persistent CSI report, and an aperiodic CSI report.

The resources used for channel measurement and/or interference measurement in the second sub-configuration are aperiodic. A resource type parameter (e.g., resourceType) of a CSI resource setting (CSI-ResourceConfig) used for channel measurement and/or interference measurement corresponding to the CSI reporting configuration information of the second sub-configuration is set to “aperiodic”.

Resources used for channel measurement and/or interference measurement that (one or all) of the one or more first sub-configurations include/correspond to/are associated with/indicate are aperiodic. A resource type parameter (e.g., resourceType) of a CSI resource setting (CSI-ResourceConfig) used for channel measurement and/or interference measurement corresponding to the CSI reporting configuration information of the one or more first sub-configuration is set to “aperiodic”.

The second condition includes at least one of the following.

The first condition is unsatisfied. That is, when the first condition is not met, the UE determines the second CSI parameter of the second sub-configuration based on the first CSI parameter of the second sub-configuration. The first condition is described above.

The second sub-configuration is configured with a type 2 parameter. The type 2 parameter is used to indicate type 2 adaptation.

One or all of the one or more first sub-configurations are configured with type 2 parameters. The type 2 parameter is used to indicate type 2 adaptation.

The one or more first sub-configurations have the same CSI-RS port. The CSI-RS port refers to a CSI-RS port corresponding to a port number parameter (e.g., nrofPorts). The CSI-RS port can be used for channel measurement. CSI ports can be CSI-RS antenna ports. The CSI-RS port corresponds to reference signal resources used for channel measurement.

The second sub-configuration includes/corresponds to/is associated with/indicates one or more resources. The one or more resources are used for channel measurement and/or interference measurement. The one or more resources are reference signal resources used for channel measurement or interference measurement. The second sub-configuration includes/corresponds to/is associated with one or more lists that (respectively) indicate the one or more resources, which include reference signal resources in a resource set (e.g., NZP-CSI-RS-ResourceSet). The one or more resources include resources in a resource set (e.g., csi-IM-ResourceSet). The resource set corresponds to the CSI reporting configuration information and is in a CSI resource setting corresponding to the CSI reporting configuration information. The CSI resource setting can be, for example, CSI-ResourceConfig.

One or all of the one or more first sub-configurations include/correspond to/are associated with/indicate one or more resources. The one or more resources are used for channel measurement and/or interference measurement. The second sub-configuration includes/corresponds to/is associated with one or more lists that indicate the one or more resources. The one or more resources include reference signal resources in a resource set (e.g., NZP-CSI-RS-ResourceSet) and resources in a resource set (e.g., csi-IM-ResourceSet). The resource set corresponds to the CSI reporting configuration information and is in a CSI resource setting corresponding to the CSI reporting configuration information. The CSI resource setting can be, for example, CSI-ResourceConfig.

The number of resources used for channel measurement in the second sub-configuration is greater than 1. The number of reference signal resources used for channel measurement in the second sub-configuration is greater than 1.

The CSI configuration information corresponds to one of an aperiodic CSI report, a semi-persistent CSI report, and an aperiodic CSI report.

The resources used for channel measurement and/or interference measurement in the second sub-configuration are aperiodic. A resource type parameter (e.g., resourceType) of a CSI resource setting (CSI-ResourceConfig) used for channel measurement and/or interference measurement corresponding to the CSI reporting configuration information of the second sub-configuration is set to “aperiodic”.

Resources used for channel measurement and/or interference measurement that one or all of the one or more first sub-configurations include/correspond to/are associated with/indicate are aperiodic. A resource type parameter (e.g., resourceType) of a CSI resource setting (CSI-ResourceConfig) used for channel measurement and/or interference measurement corresponding to the CSI reporting configuration information of the one or more first sub-configuration is set to “aperiodic”.

The UE determines CRI based on the parameters indicated by the plurality of first sub-configurations or the second sub-configuration. The parameters indicated by the one or more first sub-configurations or the second sub-configuration include/are one or more resources indicated by the one or more first sub-configurations or the second sub-configuration. When the second condition (and/or the first condition) is satisfied, the UE determines CRI based on the one or more resources indicated by the plurality of first sub-configurations or the second sub-configuration. When the first condition or the second condition is satisfied, for a sub-configuration (e.g., one or each of the plurality of first sub-configurations or the second sub-configuration), the CRI of the sub-configuration is determined based on one or more resources indicated by the sub-configuration. The one or more resources are used for channel measurement. The number of information bits corresponding to the CRI or the bitwidth in a CSI field corresponding to the CRI is based on the one or more resources. For example, for sub-configuration #j, the bitwidth is equal to log₂ Kⱼ, where Kⱼ represents the number of resources (used for channel measurement) indicated by the sub-configuration #j. A codepoint of the CRI is associated with/corresponds to the one or more resources. For example, for the sub-configuration #j, the value of the CRI is kⱼ, where kⱼ is an integer greater than or equal to 0 (kⱼ≥0). A lowest codepoint of kⱼ (e.g., codepoint 0) corresponds to a first resource among the one or more resources indicated by the sub-configuration #j; a second lowest codepoint of kⱼ (e.g., codepoint 1) corresponds to a second resource among the one or more resources indicated by the sub-configuration #j, and so on. The order of the one or more resources is based on at least one of the following.

The order of the one or more resources in the resource set. that is, the order of the one or more resources in a resource set used for channel measurement associated with/corresponding to the CSI reporting configuration information corresponding to this sub-configuration.

The order of (configured) IDs of the one or more resources. Each of the one or more resources corresponds to or is configured with a resource ID. The order of the one or more resources is determined based on the increasing or decreasing order of the IDs corresponding to the one or more resources.

The order of the one or more resources in a parameter used to indicate the one or more resources in the sub-configuration. The one or more resources are indicated by a parameter that the sub-configuration corresponds to/includes. The order of the one or more resources is determined based on the order of the one or more resources in the parameter.

When the first condition (and/or the second condition) is satisfied, the UE determines CRI based on one or more resources corresponding to the CSI reporting configuration information. The one or more resources can be (all) resources in a resource set. The resource set corresponds to the CSI reporting configuration information. The resource set is in a CSI resource setting corresponding to the CSI reporting configuration information. The CSI resource setting is used for channel measurement. The CSI resource setting can be associated with/correspond to a channel measurement resource parameter (e.g., resourcesForChannelMeasurement) in the CSI reporting configuration information. The CSI resource setting is, A CSI-ResourceConfig parameter. The resources can be reference signal resources. The reference signal resources can be reference signals (e.g., CSI-RS). Optionally, CSI-RS can be NZP CSI-RS. The methods for determining the bitwidth for CRI and/or the mapping relationship between CRI and resources based on one or more resources are described in the above embodiments.

Table 16 and Table 17 below show methods for determining the bitwidth for CRI and/or mapping between CRI and resources are shown. Reference to the above descriptions may be made for the description of the one or more resources.

The UE determines RI based on the parameters indicated by the plurality of first sub-configurations or the second sub-configuration and/or the first CSI parameter (e.g., CRI). The parameters indicated by the plurality of first sub-configurations or the second sub-configuration include a rank restriction parameter and/or a port parameter. The number of layers (or total layers) corresponding to the RI is less than or equal to 4 (or 8). When the first condition (and/or the second condition) is satisfied, the UE determines RI based on the rank restriction parameter and/or port parameter indicated by the plurality of first sub-configurations or the second sub-configuration and/or CRI (e.g., reported CRI). When the first condition or the second condition is satisfied and the sub-configuration corresponds to a single-antenna panel or the sub-configuration corresponds to a multi-antenna panel, for a sub-configuration (e.g., one or each of the plurality of first sub-configurations or the second sub-configuration), the RI of the sub-configuration is determined based on a rank restriction parameter and/or port parameter indicated by the sub-configuration and/or CRI (e.g., reported CRI). The reported CRI can be understood as a channel measurement and/or interference measurement resource corresponding to the reported CRI. The rank restriction parameter indicates/corresponds to an allowed rank (or, an allowed RI value) (of the corresponding sub-configuration). The port parameter can correspond to a number of port(s) (e.g., the number of CSI-RS antenna ports). The number of port(s) (or the number of antenna ports) is the number of antenna ports in a port subset indicated by the port parameter.

When the first condition is satisfied and the sub-configuration #j corresponds to a single-antenna panel, for the sub-configuration #j, the number of the allowed RI values is n_{RI}. The bitwidth for the RI corresponding to the sub-configuration #j is based on the number of antenna ports indicated by a port parameter and/or the reported CRI. The number of antenna ports can be a number of port(s) indicated by a port parameter of the sub-configuration #j. Corresponding to a single-antenna panel refers to when an antenna panel type of a codebook corresponding to the sub-configuration or the CSI reporting configuration information is (Type I) single panel (e.g., codebookType=typeI-SinglePanel), or a report quantity parameter (e.g., reportQuantity) corresponding to the sub-configuration or the CSI reporting configuration information is “cri-RI-CQI”. When the first condition is satisfied and the sub-configuration #j corresponds to a single-antenna panel, for the sub-configuration #j, the bitwidth corresponding to RI is determined based on a number of port(s) corresponding to the port parameter indicated by the sub-configuration #j and/or the value of allowed rank corresponding to the rank restriction parameter and/or the reported CRI. When the first condition is satisfied (and the sub-configuration #j corresponds to a multi-antenna panel), for the sub-configuration #j, the bitwidth corresponding to RI is determined based on the (value of) allowed rank corresponding to the rank restriction parameter indicated by the sub-configuration #j and/or the reported CRI. Corresponding to a multi-antenna panel refers to when an antenna panel type of a codebook corresponding to the sub-configuration or the CSI reporting configuration information is (Type I) multi-panel (e.g., codebookType=typeI-MultiPanel).

When the second condition is satisfied (and the sub-configuration #j corresponds to a single-antenna panel), for the sub-configuration #j, the bitwidth corresponding to RI is determined based on a number of port(s) indicated by a nrofPorts parameter of a CSI-RS resource used for channel measurement and/or the value of allowed rank corresponding to the rank restriction parameter indicated by the CSI reporting configuration information and/or the reported CRI. When the second condition is satisfied and the sub-configuration #j corresponds to a single-antenna panel, for the sub-configuration #j, the bitwidth corresponding to RI is determined based on the value of the allowed rank corresponding to the rank restriction parameter indicated by the CSI reporting configuration information and/or the reported CRI.

The methods for determining the bitwidth for RI and/or mapping between RI and the rank are described in Table 16 and Table 17.

The UE determines the second CSI parameter (e.g., PMI) based on the parameters indicated by the plurality of first sub-configurations or the second sub-configuration and/or the first CSI parameter (e.g., CRI and RI). The parameters indicated by the plurality of first sub-configurations or the second sub-configuration include codebook type parameter, codebook mode parameter, codebook parameter, and port parameter. When the first condition and/or the second condition is satisfied, the UE determines PMI based on the codebook type parameter, the codebook mode parameter, the codebook parameter, and the port parameter indicated by the plurality of first sub-configurations or the second sub-configuration, and/or reported CRI and/or reported RI. When the first condition or second condition is satisfied and the sub-configuration corresponds to a single-antenna panel or the sub-configuration corresponds to a multi-antenna panel, for a sub-configuration (e.g., one or each of the plurality of first sub-configurations or the second sub-configurations), the PMI of the sub-configuration is determined based on the codebook type parameter, the codebook mode parameter, the codebook parameter, and the port parameter indicated by the sub-configuration, and/or reported CRI and/or reported RI. Reference may be made to the above descriptions for the description of CRI and RI.

When the first condition is satisfied and the sub-configuration #j corresponds to a single-antenna panel, for the sub-configuration #j, the bitwidth for the PMI corresponding to the sub-configuration #j is based on at least one of the number of port(s), the codebook mode, the codebook type, N1, N2, the reported CRI and the reported RI. The number of antenna ports can be a number of port(s) indicated by the port parameter of the sub-configuration #j. The codebook mode can be indicated by the codebook mode parameter of the sub-configuration #j. The codebook type can be indicated by the codebook type parameter of the sub-configuration #j. N1 can be indicated by the codebook parameter of the sub-configuration #j. N2 can be indicated by the codebook parameter of the sub-configuration #j. When the first condition is satisfied (and the sub-configuration #j corresponds to a multi-antenna panel), for the sub-configuration #j, the bitwidth for the PMI corresponding to the sub-configuration #j is based on at least one of the codebook mode, the codebook type, N1, N2, Ng, the reported CRI and the reported RI. The codebook mode can be indicated by the codebook mode parameter of the sub-configuration #j. The codebook type can be indicated by the codebook type parameter of the sub-configuration #j. N1 can be indicated by the codebook parameter of the sub-configuration #j. N2 can be indicated by the codebook parameter of the sub-configuration #j. Ng can be indicated by the codebook parameter of the sub-configuration #j.

When the second condition is satisfied and the sub-configuration #j corresponds to a single-antenna panel, the bitwidth for the PMI corresponding to the sub-configuration #j is based on at least one of the number of port(s), the codebook mode, the codebook type, N1, N2, the reported CRI and the reported RI. When the second condition is satisfied (and the sub-configuration #j corresponds to a multi-antenna panel), the bitwidth for the PMI corresponding to the sub-configuration #j is based on at least one of the number of port(s), the codebook mode, the codebook type, N1, N2, Ng, the reported CRI and the reported RI. The number of antenna ports can be indicated by the nrofPorts parameter of the CSI-RS resource in the resource set used for channel measurement and corresponding to the CSI reporting configuration information (corresponding to the sub-configuration #j). The codebook mode can be indicated by the codebook mode parameter associated with/corresponding to the CSI reporting configuration information (corresponding to the sub-configuration #j). The codebook type can be indicated by the codebook type parameter associated with/corresponding to the CSI reporting configuration information (corresponding to the sub-configuration #j). N1 can be indicated by the codebook parameter associated with/corresponding to the CSI reporting configuration information (corresponding to the sub-configuration #j). N2 can be indicated by the codebook parameter associated with/corresponding to the CSI reporting configuration information (corresponding to the sub-configuration #j).

Table 14 and Table 15 below show methods for determining the bitwidth for PMI.

The UE determines the second CSI parameter (e.g., CQI) based on the parameters indicated by the plurality of first sub-configurations or the second sub-configuration and/or the first CSI parameter (e.g., CRI, RI, and PMI). The parameters indicated by the plurality of first sub-configurations or the second sub-configuration include a port parameter and/or a CQI table parameter. When the second condition (and/or the first condition) is satisfied, the UE determines CQI based on the port parameter and/or the CQI table parameter indicated by the plurality of first sub-configurations or the second sub-configuration and/or reported CRI and/or reported RI and/or reported PMI. When the first condition or the second condition is satisfied (and the sub-configuration corresponds to a single-antenna panel or the sub-configuration corresponds to a multi-antenna panel), for one or each of the plurality of first sub-configurations or the second sub-configuration, the CQI of the sub-configuration is determined based on a port parameter indicated by the sub-configuration and/or a CQI table parameter and/or reported CRI and/or reported RI and/or reported PMI.

When the first condition is satisfied and the sub-configuration #j corresponds to a single-antenna panel, for the sub-configuration #j, the bitwidth for CQI corresponding to the sub-configuration #j is based on at least one of the number of antenna ports, reported CRI, reported RI, and/or reported PMI. The number of antenna ports can be a number of port(s) indicated by the port parameter of the sub-configuration #j. When the first condition is satisfied (and the sub-configuration #j corresponds to a multi-antenna panel), for the sub-configuration #j, the bitwidth for the CQI corresponding to the sub-configuration #j is based on at least one of reported CRI, reported RI, and/or reported PMI. When the first condition is satisfied and the sub-configuration #j corresponds to a multi-antenna panel, for the sub-configuration #j, the bitwidth for the CQI corresponding to the sub-configuration #j is predefined as at least one of 1, 2, 4, and 8.

When the second condition is satisfied and the sub-configuration #j corresponds to a single-antenna panel, for the sub-configuration #j, the bitwidth for the CQI corresponding to sub-configuration #j is based on at least one of the number of antenna ports, the CQI table, reported CRI, reported RI, and/or reported PMI. When the second condition is satisfied and the sub-configuration #j corresponds to a multi-antenna panel, for sub-configuration #j, the bitwidth for CQI corresponding to sub-configuration #j is based on at least one of the number of antenna ports, the CQI table, reported CRI, reported RI, and/or reported PMI. The number of antenna ports can be indicated by the nrofPorts parameter of the CSI-RS resource in the resource set used for channel measurement corresponding to the CSI reporting configuration information corresponding to sub-configuration #j. The CQI table can be indicated by the CQI table parameter associated with/corresponding to the CSI reporting configuration information (corresponding to the sub-configuration #j).

Table 16 and Table 17 below show methods for determining the bitwidth for CQI.

The UE determines the second CSI parameter (e.g., LI) based on the parameters indicated by the plurality of first sub-configurations or the second sub-configuration and/or the first CSI parameter (e.g., CRI, RI, PMI, and CQI). The parameters indicated by the plurality of first sub-configurations or the second sub-configuration include a port parameter. When the second condition (and/or the first condition) is satisfied, the UE determines LI based on the port parameter indicated by the plurality of first sub-configurations or the second sub-configuration, and/or reported CRI and/or reported RI and/or reported PMI and/or reported CQI. When the first condition or second condition is satisfied (and the sub-configuration corresponds to a single-antenna panel or the sub-configuration corresponds to a multi-antenna panel), for a sub-configuration (e.g., one or each of the plurality of first sub-configurations or the second sub-configuration), the CQI of the sub-configuration is determined based on the port parameter indicated by the sub-configuration, and/or reported CRI and/or reported RI and/or reported PMI and/or reported CQI.

When the first condition is satisfied (and the sub-configuration #j corresponds to a single-antenna panel), for sub-configuration #j, the bitwidth for LI corresponding to sub-configuration #j is based on at least one of the number of antenna ports, reported CRI, reported RI, and/or reported PMI and/or reported CQI. The number of antenna ports can be a number of port(s) indicated by the port parameter of the sub-configuration #j. When the first condition is satisfied, for sub-configuration #j, the bitwidth for the LI corresponding to the sub-configuration #j is based on at least one of reported CRI, reported RI, and/or reported PMI and/or reported CQI.

When the second condition is satisfied (and the sub-configuration #j corresponds to a single-antenna panel), for e sub-configuration #j, the bitwidth for LI corresponding to sub-configuration #j is based on at least one of the number of antenna ports, reported CRI, reported RI, and/or reported PMI and/or reported CQI. When the second condition is satisfied (and the sub-configuration #j corresponds to a multi-antenna panel), for sub-configuration #j, the bitwidth for LI corresponding to the sub-configuration #j is based on at least one of the number of antenna ports, reported CRI, reported RI, and/or reported PMI and/or reported CQI. The number of antenna ports can be indicated by the nrofPorts parameter of the CSI-RS resource in the resource set used for channel measurement corresponding to the CSI reporting configuration information (corresponding to the sub-configuration #j).

The UE determines the number of zero-padding bits based on the parameters indicated by the plurality of first sub-configurations or the second sub-configuration and/or the first CSI parameter (e.g., CRI, RI, PMI, CQI, and LI). The parameters indicated by the plurality of first sub-configurations or the second sub-configuration include at least one of a port parameter, rank restriction parameter, CQI table parameter, codebook mode parameter and codebook type parameter. When the first condition (and/or the second condition) is satisfied, the UE determines zero-padding bits based on at least one of the port parameter, the rank restriction parameter, the CQI table parameter, the codebook mode parameter and the codebook type parameter indicated by the plurality of first sub-configurations or the second sub-configuration, and/or reported CRI and/or reported RI and/or reported PMI and/or reported CQI and/or reported LI. When the first condition and/or the second condition is satisfied, the UE determines zero-padding bits based on at least one of the port parameter, the rank restriction parameter, the CQI table parameter, the codebook mode parameter and the codebook type parameter corresponding to the CSI reporting configuration information, and/or reported CRI and/or reported RI and/or reported PMI and/or reported CQI and/or reported LI.

TABLE 14

| | | | | Information field X₂ for | |
|---|---|---|---|---|---|
| | Information field X₁ for wideband PMI | | | wideband PMI or per subband PMI | |
| | (i_{1,1},i_{1,2}) | | | i₂ | |
| | codebookMode = 1 | codebookMode = 2 | i_{1,3} | codebookMode = 1 | codebookMode = 2 |
| Rank = 1, more than 2 | (┌log₂N₁O₁┐, ┌log₂N₂O₂┐) | $( ⌈ {log}_{2} \frac{{N}_{1} {O}_{1}}{2} ⌉ , ⌈ {log}_{2} \frac{{N}_{2} {O}_{2}}{2} ⌉ )$ | N/A | 2 | 4 |
| CSI-RS | | | | | |
| ports, | | | | | |
| N₂ > 1 | | | | | |
| Rank = 1, more than 2 | (┌log₂N₁O₁┐, ┌log₂N₂O₂┐) | $( ⌈ {log}_{2} ( \frac{{N}_{1} {O}_{1}}{2} ) ⌉ , 0 )$ | N/A | 2 | 4 |
| CSI-RS | | | | | |
| ports, | | | | | |
| N₂ = 1 | | | | | |
| Rank = 2, 4 CSI-RS ports, N₂ = 1 | (┌log₂N₁O₁┐, ┌log₂N₂O₂┐) | $( ⌈ {log}_{2} ( \frac{{N}_{1} {O}_{1}}{2} ) ⌉ , 0 )$ | 1 | 1 | 3 |
| Rank = 2, more than 4 | (┌log₂N₁O₁┐, ┌log₂N₂O₂┐) | $( ⌈ {log}_{2} \frac{{N}_{1} {O}_{1}}{2} ⌉ , ⌈ {log}_{2} \frac{{N}_{2} {O}_{2}}{2} ⌉ ) ,$ | 2 | 1 | 3 |
| CSI-RS | | | | | |
| ports, | | | | | |
| N₂ = 1 | | | | | |
| Rank = 2, more than 4 | (┌log₂N₁O₁┐, ┌log₂N₂O₂┐) | $( ⌈ {log}_{2} ( \frac{{N}_{1} {O}_{1}}{2} ) ⌉ , 0 )$ | 2 | 1 | 3 |
| CSI-RS | | | | | |
| ports, | | | | | |
| N₂ = 1 | | | | | |
| Rank = 3 | (┌log₂N₁O₁┐, ┌log₂N₂O₂┐) | | 0 | 1 | |
| or 4, 4 | | | | | |
| CSI-RS | | | | | |
| ports | | | | | |
| Rank = 3 | (┌log₂N₁O₁┐, ┌log₂N₂O₂┐) | | 2 | 1 | |
| or 4, 8 or | | | | | |
| 12 CSI-RS | | | | | |
| ports | | | | | |
| Rank = 3 or 4, more than or | $( ⌈ {log}_{2} \frac{{N}_{1} {O}_{1}}{2} ⌉ , ⌈ {log}_{2} {N}_{2} {O}_{2} ⌉ )$ | | 2 | 1 | |
| equal to | | | | | |
| 16 CSI-RS | | | | | |
| ports | | | | | |
| Rank = | (┌log₂N₁O₁┐, ┌log₂N₂O₂┐) | | N/A | 1 | |
| 5 or 6 | | | | | |
| Rank = 7 or 8, | $( ⌈ {log}_{2} \frac{{N}_{1} {O}_{1}}{2} ⌉ , ⌈ {log}_{2} {N}_{2} {O}_{2} ⌉ )$ | | N/A | 1 | |
| N₁ = 4, | | | | | |
| N₂ = 1 | | | | | |
| Rank = 7 or 8, N₁ > 2, | $( ⌈ {log}_{2} {N}_{1} {O}_{1} ⌉ , ⌈ {log}_{2} \frac{{N}_{2} {O}_{2}}{2} ⌉ )$ | | N/A | 1 | |
| N₂ = 2 | | | | | |
| Rank = | (┌log₂N₁O₁┐, ┌log₂N₂O₂┐) | | N/A | 1 | |
| 7 or 8, | | | | | |
| N₁ > 4, | | | | | |
| N₂ = 1 or | | | | | |

N₁ = 2,
N₂ = 2 or
N₁ > 2,
N₂ > 2

When the number of port(s) (the number of CSI-RS ports) is equal to 1, the bitwidth of PMI is 0.

When the number of port(s) (the number of CSI-RS ports) is equal to 2, the rank is 1, and codebookType=typeI-SinglePanel, the bitwidth of PMI is 2. The rank refers to a rank that the CSI includes/reports.

When the number of port(s) (the number of CSI-RS ports) is equal to 2, the rank is 2, and codebookType=typeI-SinglePanel, the bitwidth of PMI is 1. The rank refers to a rank that the CSI includes/reports.

When the number of port(s) (the number of CSI-RS ports) is greater than 2, and codebookType=typeI-SinglePanel, the bitwidth of PMI is provided/represented in Table 14.

When the first condition is satisfied (and the sub-configuration #j corresponds to a single-antenna panel), for sub-configuration #j, the number of port(s) (e.g., the number of antenna ports or CSI-RS ports) is based on/equal to the number of antenna ports corresponding to the port parameter indicated by the sub-configuration #j. When the second condition is satisfied (and the sub-configuration #j corresponds to a single-antenna panel), for sub-configuration #j, the number of port(s) (e.g., the number of antenna ports or CSI-RS ports) is based on/equal to a number of port(s) of reference signals in a reference signal set used for channel measurement corresponding to/associated with the CSI reporting configuration information.

When the first condition is satisfied, N1 and N2 are indicated by the corresponding sub-configuration (e.g., by the port parameter). When the second condition is satisfied, N1 and N2 are indicated by the codebook parameter corresponding to/associated with the CSI reporting configuration information (e.g., CodebookConfig).

When the first condition is satisfied, N1 and N2 are indicated by the corresponding sub-configuration (e.g., by the port parameter). When the second condition is satisfied, N1 and N2 are indicated by the codebook parameter corresponding to/associated with the CSI reporting configuration information (e.g., CodebookConfig).

The codebookType=typeI-SinglePanel can be indicated by the sub-configuration #j or configured by the codebook type parameter in the CSI reporting configuration information corresponding to sub-configuration #j.

The codebookMode=1 or codebookMode=2 can be indicated by the sub-configuration #j or configured by the codebook mode parameter in the CSI reporting configuration information corresponding to sub-configuration #j.

TABLE 15

| | | | | | | Information fields X₂ for | | | |
|---|---|---|---|---|---|---|---|---|---|
| | Information fields X₁for wideband | | | | | wideband or per subband | | | |
| | (i_{1, 1}, i_{1, 2}) | i_{1, 3} | i_{1, 4, 1} | i_{1, 4, 2} | i_{1, 4, 3} | i₂ | i_{2, 0} | i_{2, 1} | i_{2, 2} |
| Rank = 1, | (┌log₂ N₁ O₁┐, | N/A | 2 | N/A | N/A | 2 | N/A | N/A | N/A |
| N_{g} = 2 | ┌log₂ N₂ O₂┐) | | | | | | | | |
| codebookMode = | | | | | | | | | |
| 1 | | | | | | | | | |
| Rank = 1, | (┌log₂ N₁ O₁┐, | N/A | 2 | 2 | 2 | 2 | N/A | N/A | N/A |
| N_{g} = 4 | ┌log₂ N₂ O₂┐) | | | | | | | | |
| codebookMode = | | | | | | | | | |
| 1 | | | | | | | | | |
| Rank = 2, N_{g} = | (┌log₂ N₁ O₁┐, | 1 | 2 | N/A | N/A | 1 | N/A | N/A | N/A |
| 2, N₁N₂ = 2 | ┌log₂ N₂ O₂┐) | | | | | | | | |
| codebookMode = | | | | | | | | | |
| 1 | | | | | | | | | |
| Rank = 3 or 4, | (┌log₂ N₁ O₁┐, | 0 | 2 | N/A | N/A | 1 | N/A | N/A | N/A |
| N_{g} =2, | ┌log₂ N₂ O₂┐) | | | | | | | | |
| N₁N₂ = 2 | | | | | | | | | |
| codebookMode = | | | | | | | | | |
| 1 | | | | | | | | | |
| Rank = 2 or 3 or | (┌log₂ N₁ O₁┐, | 2 | 2 | N/A | N/A | 1 | N/A | N/A | N/A |
| 4, N_{g} = 2, | ┌log₂ N₂ O₂┐) | | | | | | | | |
| N₁N₂ > 2 | | | | | | | | | |
| codebookMode = | | | | | | | | | |
| 1 | | | | | | | | | |
| Rank = 2, N_{g} = | (┌log₂ N₁ O₁┐, | 1 | 2 | 2 | 2 | 1 | N/A | N/A | N/A |
| 4, N₁N₂ = 2 | ┌log₂ N₂ O₂┐) | | | | | | | | |
| codebookMode = | | | | | | | | | |
| 1 | | | | | | | | | |
| Rank = 3 or 4, | (┌log₂ N₁ O₁┐, | 0 | 2 | 2 | 2 | 1 | N/A | N/A | N/A |
| N_{g} = 4, | ┌log₂ N₂ O₂┐) | | | | | | | | |
| N₁N₂ = 2 | | | | | | | | | |
| codebookMode = | | | | | | | | | |
| 1 | | | | | | | | | |
| Rank = 2 or 3 or | (┌log₂ N₁ O₁┐, | 2 | 2 | 2 | 2 | 1 | N/A | N/A | N/A |
| 4, N_{g} = 4, | ┌log₂ N₂ O₂┐) | | | | | | | | |
| N₁N₂ > 2 | | | | | | | | | |
| codebookMode = | | | | | | | | | |
| 1 | | | | | | | | | |
| Rank = 1, N_{g} = | (┌log₂ N₁ O₁┐, | N/A | 2 | 2 | N/A | N/A | 2 | 1 | 1 |
| 2 | ┌log₂ N₂ O₂┐) | | | | | | | | |
| codebookMode = | | | | | | | | | |
| 2 | | | | | | | | | |
| Rank = 2, N_{g} = | (┌log₂ N₁ O₁┐, | 1 | 2 | 2 | N/A | N/A | 1 | 1 | 1 |
| 2, N₁N₂ = 2 | ┌log₂ N₂ O₂┐) | | | | | | | | |
| codebookMode = | | | | | | | | | |
| 2 | | | | | | | | | |
| Rank = 3 or 4, | (┌log₂ N₁ O₁┐, | 0 | 2 | 2 | N/A | N/A | 1 | 1 | 1 |
| N_{g} = 2, | ┌log₂ N₂ O₂┐) | | | | | | | | |
| N₁N₂ = 2 | | | | | | | | | |
| codebookMode = | | | | | | | | | |
| 2 | | | | | | | | | |
| Rank = 2 or 3 or | (┌log₂ N₁ O₁┐, | 2 | 2 | 2 | N/A | N/A | 1 | 1 | 1 |
| 4, N_{g} = 2, | ┌log₂ N₂ O₂┐) | | | | | | | | |
| N₁N₂ > 2 | | | | | | | | | |
| codebookMode = | | | | | | | | | |
| 2 | | | | | | | | | |

When the number of port(s) (the number of CSI-RS ports) is equal to 1, the bitwidth of PMI is 0.

When codebookType=typeI-MultiPanel, the bitwidth of PMI is provided/represented in Table 15.

When the first condition is satisfied (and the sub-configuration #j corresponds to a multi-antenna panel), for sub-configuration #j, the number of port(s) (e.g., the number of antenna ports or CSI-RS ports) is based on/equal to the number of antenna ports corresponding to the port parameter indicated by sub-configuration #j. When the second condition is satisfied (and the sub-configuration #j corresponds to a multi-antenna panel), for sub-configuration #j, the number of port(s) (e.g., the number of antenna ports or CSI-RS ports) is based on/equal to a number of port(s) of reference signals in a reference signal set used for channel measurement corresponding to/associated with the CSI reporting configuration information.

When the first condition is satisfied, N1 and N2 are indicated by the corresponding sub-configuration (e.g., by the port parameter). When the second condition is satisfied, N1 and N2 are indicated by the codebook parameter corresponding to/associated with the CSI reporting configuration information (e.g., CodebookConfig).

When the first condition is satisfied, N1, N2, and Ng are indicated by the corresponding sub-configuration (e.g., by the port parameter). When the second condition is satisfied, N1, N2, and Ng are indicated by the codebook parameter corresponding to/associated with the CSI reporting configuration information (e.g., CodebookConfig).

The codebookType=typeI-MultiPanel can be indicated by the sub-configuration #j or configured by the codebook type parameter in the CSI reporting configuration information corresponding to sub-configuration #j.

The codebookMode=1 or codebookMode=2 can be indicated by the sub-configuration #j or configured by the codebook mode parameter in the CSI reporting configuration information corresponding to sub-configuration #j.

The rank refers to a rank that the CSI includes/reports.

TABLE 16

| | Bitwidth | | | | |
|---|---|---|---|---|---|
| | One | Two | Four | | |
| | antenna | antenna | antenna | >four antenna ports | |
| Field | port | ports | ports | Ranks 1-4 | Ranks 5-8 |
| RI when | 0 | min(1, ┌log₂ n_{RI}┐) | min(2, ┌log₂ n_{RI}┐) | ┌log₂ n_{RI}┐ | ┌log₂ n_{RI}┐ |
| codebookType = | | | | | |
| typeI- | | | | | |
| SinglePanel | | | | | |
| RI when | 0 | 1 | 2 | 3 | 3 |
| reportQuantity | | | | | |
| set to “cri-RI- | | | | | |
| CQI” | | | | | |
| LI | 0 | ┌log₂ v┐ | min(2, ┌log₂ v┐) | min (2, ┌log₂ v┐) | min (2, ┌log₂ v┐) |
| Wideband CQI | 4 | 4 | 4 | 4 | 4 |
| for first TB | | | | | |
| Wideband CQI | 0 | 0 | 0 | 0 | 4 |
| for second TB | | | | | |
| Subband | 2 | 2 | 2 | 2 | 2 |
| differential | | | | | |
| CQI for | | | | | |
| first TB | | | | | |
| Subband | 0 | 0 | 0 | 0 | 2 |
| differential | | | | | |
| CQI for | | | | | |
| second TB | | | | | |
| CRI | ┌log₂(Kⱼ)┐ | ┌log₂(Kⱼ)┐ | ┌log₂(Kⱼ)┐ | ┌log₂(Kⱼ)┐ | ┌log₂(Kⱼ)┐ |

When codebookType=typeI-SinglePanel, or the report quantity parameter reportQuantity is set to “cri-RI-CQI”, the bitwidth of RI/LI/CQI/CRI are provided/represented in Table 16.

In Table 16, Kⱼ represents the number of one or more resources. The one or more resources can be one or more CSI-RS resources. The method for determining one or more resources is described earlier. In Table 16, n_{RI} represents the number of allowed RI values. v refers to the rank value. The values of the rank indicator field are mapped to allowed rank indicator values with increasing order, where “0” is mapped to the smallest allowed rank indicator value. When the higher layer parameter reportQuantity is set to “cri-RI-CQI”, the values of the rank indicator field are mapped to rank indicator values with increasing order, where “0” is mapped to rank-1.

In Table 16, when the first condition is satisfied (and the sub-configuration #j corresponds to a single-antenna panel), for sub-configuration #j, the number of port(s) (e.g., the number of antenna ports or CSI-RS ports) is based on/equal to the number of antenna ports corresponding to the port parameter indicated by sub-configuration #j. When the second condition is satisfied (and the sub-configuration #j corresponds to a single-antenna panel), for sub-configuration #j, the number of port(s) (e.g., the number of antenna ports or CSI-RS ports) is based on/equal to a number of port(s) of reference signals in a reference signal set used for channel measurement corresponding to/associated with the CSI reporting configuration information.

The codebookType=typeI-SinglePanel can be indicated by sub-configuration #j or configured by the codebook type parameter in the CSI reporting configuration information corresponding to sub-configuration #j.

TABLE 17

| Field | Bitwidth |
|---|---|
| RI | min(2, ┌log₂ n_{RI}┐) |
| LI | min(2, ┌log₂ v┐) |
| Wideband CQI | 4 |
| Subband differential CQI | 2 |
| CRI | ┌log₂(Kⱼ)┐ |

When codebookType=typeI-MultiPanel, the bitwidth of RI/LI/CQI/CRI are provided/represented in Table 17.

In Table 17, Kⱼ represents the number of one or more resources. The one or more resources can be one or more CSI-RS resources which are determined as described above herein. In Table 17, n_{RI} represents the number of allowed RI values. v refers to the rank value. The values of the rank indicator field are mapped to allowed rank indicator values with increasing order, where “0” is mapped to the lowest allowed rank indicator value.

When the first condition is satisfied (and the sub-configuration #j corresponds to a multi-antenna panel), for sub-configuration #j, the number of antenna ports is equal to the number of antenna ports corresponding to the port parameter indicated by sub-configuration #j. When the second condition is satisfied (and the sub-configuration #j corresponds to a multi-antenna panel), for sub-configuration #j, the number of antenna ports is equal to a number of port(s) of reference signals in a reference signal set used for channel measurement corresponding to/associated with the CSI reporting configuration information.

The codebookType=typeI-MultiPanel can be indicated by sub-configuration #j or configured by the codebook type parameter in the CSI reporting configuration information corresponding to sub-configuration #j.

The advantage of Embodiment 2 is that, when configuring one or more sub-configurations for CSI reporting, the method for determining the information/parameters of the different types of CSI corresponding to the sub-configurations, or the correlation between information/parameters of different types of CSI, may be made. This enables the terminal device to determine and/or report CSI based on correct parameters, thereby improving the reliability of the communication system.

### Embodiment 3

The UE receives CSI reporting configuration information (for example, CSI-ReportConfig). The CSI reporting configuration information is associated with/corresponds to/includes one or more first sub-configurations, which may be referred to as sub-configuration information. The first sub-configuration may be sub-configuration information of a CSI report. For the description of the first sub-configurations and/or the second sub-configuration, refer to Embodiment 1.

The UE determines/feedback/reports a CSI report/CSI parameters/CSI corresponding to/associated with the CSI reporting configuration information. The UE can determine a CSI report/CSI parameters/CSI of the second sub-configuration in the CSI reporting configuration information.

The CSI report can be semi-persistent or periodic and can be associated with/include CSI/CSI parameters. The CSI parameters can be type 1 CSI parameters. The CSI parameter can be a specific frequency domain granularity, such as wideband frequency domain granularity and/or subband frequency domain granularity. The CSI parameter can be at least one of CRI, RI, PMI, CQI and LI. The CSI parameter can be at least one of CRI, SS/PBCH block resource indicator (SSBRI), L1-reference signal received power (L1-RSRP), L1-signal interference noise ratio (L1-SINR), and capability index.

The CSI report can be carried on at least one of PUCCH format 2, PUCCH format 3, or PUCCH format 4.

A periodic CSI report on the PUCCH format 2, PUCCH format 3, or PUCCH format 4 can support (type 1) CSI of wideband frequency domain granularity. This allows CSI reports of a plurality of sub-configurations to contain CSI from one or more sub-configurations, increasing the amount of information. The PUCCH format 2, PUCCH format 3, and PUCCH format 4 can carry more CSI information, avoid information loss and enhance the reliability of CSI reporting.

A periodic CSI report on the PUCCH format 3 or PUCCH format 4 can support (type 1) CSI of wideband frequency domain granularity. This allows CSI reports of a plurality of sub-configurations to contain CSI from one or more sub-configurations, increasing the amount of information. The PUCCH format 3 and PUCCH format 4 can carry more CSI information and have better robustness such as a lower peak to average power ratio (PAPR), thus enhancing the reliability of CSI reporting.

A periodic CSI report on the PUCCH format 2 or PUCCH format 3 can support (type 1) CSI of wideband frequency domain granularity. This allows CSI reports of a plurality of sub-configurations to contain CSI from one or more sub-configurations, increasing the amount of information. The PUCCH format 2 and PUCCH format 3 can carry more CSI information and have a lower PAPR, thus enhancing the reliability of CSI reporting.

A semi-persistent CSI report on the PUCCH format 2, PUCCH format 3, or PUCCH format 4 can support (type 1) CSI of wideband frequency domain granularity and the amount of CSI information corresponding to the semi-persistent CSI reports of a plurality of sub-configurations changes based on the signaling that activates/triggers the CSI reports. The PUCCH format 2, PUCCH format 3, and PUCCH format 4 can carry more CSI information, avoid information loss and enhance the reliability of CSI reporting.

A semi-persistent CSI report on the PUCCH format 2 or PUCCH format 3 can support (type 1) CSI of wideband frequency domain granularity. The benefit of this is that the amount of CSI information corresponding to the semi-persistent CSI reports of a plurality of sub-configurations will change based on the signaling that activates/triggers the CSI reports. The PUCCH format 2 and PUCCH format 3 can increase or decrease the occupied frequency domain resources in the frequency domain in accordance with the number of information bits of the CSI report, thereby enhancing the efficiency of the communication system.

A semi-persistent CSI report on the PUCCH format 3 or PUCCH format 4 can support (type 1) CSI of wideband frequency domain granularity. The benefit of this is that the amount of CSI information corresponding to the semi-persistent CSI reports of a plurality of sub-configurations will change based on the signaling that activates/triggers the CSI reports. The PUCCH format 3 and PUCCH format 4 can carry more CSI information and have a lower PAPR, thus enhancing the reliability of CSI reporting.

A semi-persistent (aforementioned) CSI report on the PUCCH format 3 can support (type 1) CSI of wideband frequency domain granularity. The benefit of this is that the amount of CSI information corresponding to the semi-persistent CSI reports of a plurality of sub-configurations will change based on the signaling that activates/triggers the CSI reports. The PUCCH format 3 can increase or decrease the occupied frequency domain resources in the frequency domain in accordance with the number of information bits of the CSI report, thereby enhancing the efficiency of the communication system.

A semi-persistent CSI report on the PUCCH format 3 can support (type 1) CSI of subband and/or wideband frequency domain granularity. The benefit of this is that the amount of CSI information corresponding to the semi-persistent CSI reports of a plurality of sub-configurations will change based on the signaling that activates/triggers the CSI reports. The PUCCH format 3 can increase or decrease the occupied frequency domain resources in the frequency domain in accordance with the number of information bits of the CSI report, thereby enhancing the efficiency of the communication system.

A semi-persistent CSI report on the PUCCH format 3 or PUCCH format 4 can support (type 1) CSI of subband and/or wideband frequency domain granularity. The benefit of this is that the amount of CSI information corresponding to the semi-persistent CSI reports of a plurality of sub-configurations will change based on the signaling that activates/triggers the CSI reports. The PUCCH format 3 and PUCCH format 4 can carry more CSI information and have better robustness (for example, lower PAPR), thus enhancing the reliability of CSI reporting.

The advantage of Embodiment 3 is that, in the case of configuring one or more sub-configurations for CSI reporting, it ensures that terminal devices and network devices have a common understanding of the container carrying the corresponding CSI, thereby improving the reliability of the communication system. This method further specifies which PUCCH formats can be used to carry specific CSI reports based on a plurality of sub-configurations, avoiding the use of incorrect PUCCH formats that may result in incorrect or degraded CSI reporting, thereby enhancing the reliability of the communication system.

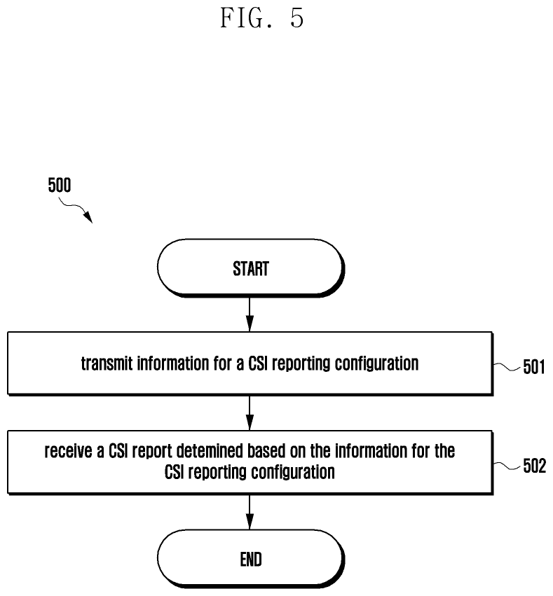

FIG. 5 illustrates a method 500 performed by a base station according to an embodiment. Referring to FIG. 5, in step 501, a base station transmits information for a CSI reporting configuration to UE. In step 502, the base station receives a CSI report determined based on the information for the CSI reporting configuration from the UE.

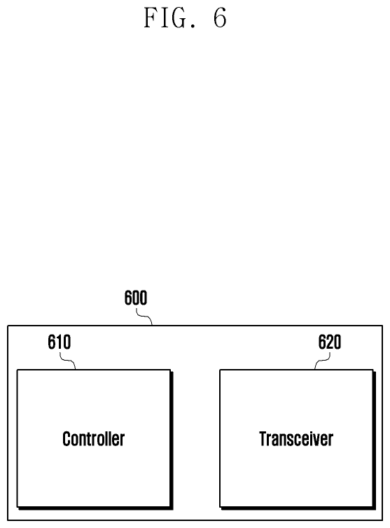

FIG. 6 illustrates a structure 600 of a UE according to an embodiment. Referring to FIG. 6, the UE 600 includes a controller 610 and a transceiver 620, wherein the controller 610 is configured to implement various methods disclosed herein and performed by the UE, and the transceiver 620 is configured to transceive channels or signals.

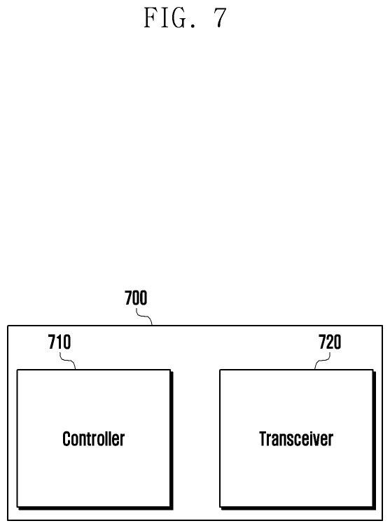

FIG. 7 illustrates a structure 700 of a base station according to an embodiment. Referring to FIG. 7, the network device 700 includes a controller 710 and a transceiver 720, wherein the controller 710 is configured to implement various methods disclosed herein and performed by the network device, and the transceiver 720 is configured to transceive channels or signals.

The illustrative logical blocks, modules, and circuits described in this disclosure may be implemented or executed using a general-purpose processor, a digital signal processor (DSP), an application specific integrated circuit (ASIC), a field programmable gate array (FPGA) or other programmable logic devices, discrete gate or transistor logic, discrete hardware components, or any combination thereof designed to perform the functions described herein. The general-purpose processor may be a microprocessor, but in alternative schemes, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this disclosure may be embodied directly in hardware, in a software module executed by a processor, or in a combination of the two. Software modules may reside in a RAM, a flash memory, an ROM, an erasable programmable read only memory (EPROM), an electronically erasable PROM (EEPROM), a register, a hard disk, a removable disk, or any other form of storage media known in the art. A storage medium is coupled to a processor to enable the processor to read and write information from/to the storage medium. Alternatively, the storage medium may be integrated into the processor. The processor and the storage medium may reside in an ASIC. The ASIC may reside in a user terminal. Alternatively, the processor and the storage medium may reside as separate components in the user terminal.

Herein, the described functions may be implemented using hardware, software, firmware, or any combination thereof. If implemented in software, each function can be stored on or transmitted by a computer-readable medium as one or more instructions or codes. Computer-readable media include computer storage media and communication media, and the latter include any medium that facilitates the transfer of computer programs from one place to another. The storage medium can be any available medium that can be accessed by a general-purpose or special-purpose computer.

In conjunction with the accompanying drawings, the disclosure describes exemplary configurations, methods, and apparatuses, and is not intended to be limited to the particular examples that can be implemented or encompassed within the claims. As used herein, the term “example” indicates “serving as an example, instance or illustration” rather than “preferred” or “superior to other examples”. The detailed description includes specific details to provide an understanding of the described technology. However, the technology may be practiced without these specific details. In some cases, well-known structures and devices are shown in block diagram form to avoid obscuring the concepts of the described examples.

Although this specification contains many specific implementation details, these should not be interpreted as limitations on any invention or the scope of the claimed protection, but as descriptions of specific features of specific embodiments of specific inventions. Some features described in this specification in the context of separate embodiments can also be combined in a single embodiment. On the contrary, various features described in the context of a single embodiment can also be implemented separately in multiple embodiments or in any suitable sub-combination. Furthermore, although features may be described above as functioning in certain combinations, and even initially claimed as such, in some cases, one or more features from the claimed combination may be deleted from the combination, and the claimed combination may be directed to a subcombination or a variation of a subcombination.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) in a wireless communication system, the method comprising:
receiving a channel state information (CSI) reporting configuration comprising a plurality of first sub-configurations; and
determining and reporting CSI based on a second sub-configuration comprising N out of the plurality of the first sub-configurations, where N is greater than or equal to 1,
wherein the CSI comprises one or two CSI parts,
wherein a number of the CSI parts included in the CSI is determined based on N, and
wherein at least one of the one or two CSI parts included in the CSI is determined based on a first order including at least one of an order of the N first sub-configurations in the second sub-configuration, an order of CSI parameters in the CSI, and an order between zero-padding bits and the CSI parameters in the CSI.

2. The method of claim 1,
wherein in case that N is less than or equal to a value indicated by higher layer signaling, a number of the CSI parts included in the CSI is 1.

3. The method of claim 1,
wherein in case that N is greater than or equal to a value indicated by higher layer signaling, a number of the CSI parts included in the CSI is 2.

4. The method of claim 1, wherein the order of the N first sub-configurations in the second sub-configuration comprises one of:
an order of identifications (IDs) of the N first sub-configurations in the second sub-configuration;
an order of the N first sub-configurations in the second sub-configuration in the CSI reporting configuration; and
an order of priorities of the N first sub-configurations in the second sub-configuration.

5. The method of claim 4, wherein the priorities are determined based on at least one of:
IDs of the first sub-configurations in the second sub-configuration,
positions of the first sub-configurations in the second sub-configuration in the CSI reporting configuration,
resource numbers corresponding to the first sub-configurations in the second sub-configuration, and
a number of ports corresponding to the first sub-configurations in the second sub-configuration.

6. The method of claim 1, wherein a single part CSI in the CSI or a wideband CSI of a CSI part 2 in the CSI is determined based on the first order and comprises:
first, based on the order of the N first sub-configurations, then, based on the order of types of the CSI parameters and/or the order between the zero-padding bits and the CSI parameters in the CSI, then, based on the order of transmission blocks (TBs) corresponding to the CSI parameters and/or the order of an information field X₁ and an information field X₂ corresponding to a precoding matrix indicator (PMI) and/or the order of frequency domain granularities; or,
first, based on the order of types of the CSI parameters and/or the order between the zero-padding bits and the CSI parameters in the CSI, then, based on the order of the N first sub-configurations, then, based on the order of the TBs corresponding to the CSI parameters and/or the order of an information field X₁ and an information field X₂ corresponding to the PMI and/or the order of frequency domain granularities, or,
first, based on the order of types of the CSI parameters and/or the order between the zero-padding bits and the CSI parameters in the CSI, then, based on the order of the TBs corresponding to the CSI parameters and/or the order of an information field X₁ and an information field X₂ corresponding to the PMI and/or the order of frequency domain granularities, then, based on the order of the N first sub-configurations.

7. The method of claim 1, wherein a CSI part 1 in the CSI is determined based on the first order and comprises:
first, based on the order of the N first sub-configurations, then, based on the order of types of the CSI parameters and/or the order between the zero-padding bits and the CSI parameters in the CSI, then, based on the order of frequency domain granularities; then, based on the order of subband number; or,
first, based on the order of types of the CSI parameters and/or the order between the zero-padding bits and the CSI parameters in the CSI, then, based on the order of the N first sub-configurations, then, based on the order of frequency domain granularities; then, based on the order of subband number; or,
first, based on the order of types of the CSI parameters and/or the order between the zero-padding bits and the CSI parameters in the CSI, then, based on the order of frequency domain granularities, then, based on the order of the N first sub-configurations; then, based on the order of subband number; or,
first, based on the order of types of the CSI parameters and/or the order between the zero-padding bits and the CSI parameters in the CSI, then, based on the order of frequency domain granularities; then, based on the order of subband number, then, based on the order of the N first sub-configurations.

8. The method of claim 1, wherein a subband CSI of a CSI part 2 in the CSI being determined based on the first order comprises:
first, based on the order of odd subband number and even subband number; then based on the order of the N first sub-configurations, then, based on the order of types of the CSI parameters and/or the order between the zero-padding bits and the CSI parameters in the CSI, then, based on the order of subband number; or,
first, based on the order of odd subband number and even subband number, then, based on the order of types of the CSI parameters and/or the order between the zero-padding bits and the CSI parameters in the CSI, then, based on the order of the N first sub-configurations; then, based on the order of subband number; or,
first, based on the order of odd subband number and even subband number, then, based on the order of types of the CSI parameters and/or the order between the zero-padding bits and the CSI parameters in the CSI, then, based on the order of subband number; then, based on the order of the N first sub-configurations.

9. The method of claim 1, wherein the number of each type of CSI parameters among the CSI parameters is determined based on N.

10. The method of claim 1, wherein a channel state information reference signal resource indicator (CRI) in a CSI parameter corresponding to one first sub-configuration in the second sub-configuration is determined based on at least one of:
a resource set for channel measurement corresponding to the CSI reporting configuration; and
one or more resources corresponding to one first sub-configuration in the second sub-configuration.

11. The method of claim 10, wherein a rank indicator (RI) in a CSI parameter corresponding to one first sub-configuration in the second sub-configuration is determined based on at least one of:
at least one of an indicated allowed rank and a number of ports of one first sub-configuration in the second sub-configuration;
at least one of an allowed rank and a number of ports corresponding to information for the CSI reporting configuration; and
CRI in the CSI parameter corresponding to one first sub-configuration in the second sub-configuration.

12. The method of claim 11, wherein a precoding matrix indicator (PMI) in a CSI parameter corresponding to one first sub-configuration in the second sub-configuration is determined based on at least one of:
at least one of an indicated number of ports, a codebook mode, a codebook type, a first-dimension parameter N1, a second-dimension parameter N2, and a parameter Ng for a multi-panel of one first sub-configuration in the second sub-configuration;
at least one of a number of ports, a codebook mode, a codebook type, N1, N2, and Ng corresponding to the CSI reporting configuration; and
the CRI or the RI in the CSI parameter corresponding to one first sub-configuration in the second sub-configuration.

13. The method of claim 12, wherein a channel quality indicator (CQI) in a CSI parameter corresponding to one first sub-configuration in the second sub-configuration is determined based on at least one of:
an indicated number of ports of one first sub-configuration in the second sub-configuration and a CQI table corresponding to the CSI reporting configuration;
a number of ports corresponding to the CSI reporting configuration and a CQI table indicated by the second sub-configuration; and
at least one of CRI, RI, and PMI in the CSI parameter corresponding to one first sub-configuration in the second sub-configuration.

14. The method of claim 13, wherein a layer indicator (LI) in a CSI parameter corresponding to one first sub-configuration in the second sub-configuration is determined based on at least one of:
an indicated number of ports of one first sub-configuration in the second sub-configuration;
a number of ports corresponding to the CSI reporting configuration; and
at least one of CRI, RI, PMI, and CQI in the CSI parameter corresponding to one first sub-configuration in the second sub-configuration.

15. The method of claim 14, wherein the number of zero-padding bits corresponding to one first sub-configuration in the second sub-configuration is determined based on at least one of the following corresponding to the corresponding first sub-configuration:
an indicated rank that is allowed to be reported;
the RI in the CSI parameter corresponding to one first sub-configuration in the second sub-configuration;
a bitwidth corresponding to the PMI in the CSI parameter corresponding to one first sub-configuration in the second sub-configuration;
a bitwidth corresponding to the CQI in the CSI parameter corresponding to one first sub-configuration in the second sub-configuration;
a bitwidth corresponding to the LI in the CSI parameter corresponding to one first sub-configuration in the second sub-configuration;
a maximum bitwidth corresponding to the PMI;
a maximum bitwidth corresponding to the CQI; and
a maximum bitwidth corresponding to the LI.

16. The method of claim 1, wherein the number of zero-padding bits corresponding to the N first sub-configurations in the second sub-configuration is determined based on at least one of the following corresponding to each first sub-configuration in the second sub-configuration:
an indicated rank that is allowed to be reported;
a reported rank indicator (RI);
a bitwidth corresponding to a reported precoding matrix indicator (PMI);
a bitwidth corresponding to a reported channel quality indicator (CQI);
a bitwidth corresponding to a reported layer 1 (LI);
a maximum bitwidth corresponding to the PMI;
a maximum bitwidth corresponding to the CQI;
a maximum bitwidth corresponding to the LI.

17. The method of claim 1, wherein the second sub-configuration is indicated by signaling which triggers a CSI reporting corresponding to the CSI reporting configuration.

18. A method performed by a base station in a wireless communication system, the method comprising:
transmitting a channel state information (CSI) reporting configuration comprising a plurality of first sub-configurations; and
receiving CSI, the CSI being determined based on a second sub-configuration, the second sub-configuration comprising N out of the plurality of first sub-configurations, where N is greater than or equal to 1;
wherein the CSI comprises one or two CSI parts,
wherein the number of the CSI parts included in the CSI is determined based on N,
wherein at least one of the one or two CSI parts included in the CSI is determined based on a first order, and
wherein the first order comprises at least one of the order of the N first sub-configurations in the second sub-configuration, the order of CSI parameters in the CSI, and the order between zero-padding bits and the CSI parameters in the CSI.

19. A user equipment, comprising:
a transceiver; and
a controller coupled to the transceiver and configured to:
receive a channel state information (CSI) reporting configuration comprising a plurality of first sub-configurations, and
determine and report CSI based on a second sub-configuration, the second sub-configuration comprising N out of the plurality of first sub-configurations, where N is greater than or equal to 1,
wherein the CSI comprises one or two CSI parts,
wherein a number of the CSI parts included in the CSI is determined based on N,
wherein at least one of the one or two CSI parts included in the CSI is determined based on a first order, and
wherein the first order comprises at least one of
an order of the N first sub-configurations in the second sub-configuration,
an order of CSI parameters in the CSI, and
an order between zero-padding bits and the CSI parameters in the CSI.

20. Abase station, comprising:
a transceiver; and
a controller coupled to the transceiver and configured to:
transmit a channel state information (CSI) reporting configuration comprising a plurality of first sub-configurations, and
receive CSI, the CSI being determined based on a second sub-configuration, the second sub-configuration comprising N out of the plurality of first sub-configurations, where N is greater than or equal to 1,
wherein the CSI comprises one or two CSI parts,
wherein the number of the CSI parts included in the CSI is determined based on N,
wherein at least one of the one or two CSI parts included in the CSI is determined based on a first order, and
wherein the first order comprises at least one of
the order of the N first sub-configurations in the second sub-configuration,
the order of CSI parameters in the CSI, and
the order between zero-padding bits and the CSI parameters in the CSI.
